(19) United States
(12) Patent Application Publication
(10) Pub. No.: US 2022/0392316 A1
(43) Pub. Date: Dec. 8, 2022

(54) GAMING MACHINE

(71) Applicant: Sammy Corporation, Shinagawa-ku (JP)

(72) Inventors: Takaya YONEDA, Shinagawa-ku (JP); Shinya OHTANI, Shinagawa-ku (JP); Yusuke HASHIMOTO, Shinagawa-ku (JP); Teppei HIGASHI, Shinagawa-ku (JP); Taiji SUGAI, Shinagawa-ku (JP); Jun NISHIOKA, Shinagawa-ku (JP); Kazuaki UTSUNOMIYA, Shinagawa-ku (JP); Hiroyuki ITO, Shinagawa-ku (JP); Masaaki KOJIMA, Osaka-shi (JP); Shota TAKAHASHI, Osaka-shi (JP)

(73) Assignee: Sammy Corporation, Shinagawa-ku (JP)

(21) Appl. No.: 17/770,144

(22) PCT Filed: Oct. 25, 2019
(86) PCT No.: PCT/JP2019/041902

§ 371 Date: Apr. 19, 2022

(51) Int. Cl. G07F 17/34; G07F 17/32

(52) U.S. Cl. CPC G07F 17/34; G07F 17/3211; G07F 17/3267

(57) ABSTRACT

The present invention provides a gaming machine that can maintain expectation in a game in which a prize is selectively granted to a player and continue the game. The gaming machine includes a display that displays a video reel having a plurality of symbols including a predetermined symbol and a plurality of cells, to each of which a prize is allocated and a controller that executes a base game in which a bet is necessary and the plurality of symbols are rearranged after scrolling of the video reel, when the predetermined symbol is rearranged in the base game, displays content of a prize of a cell in which the content of the prize is not displayed, when contents of prizes of all of the plurality of cells are displayed, selects one cell from the plurality of cells by lottery, and, when content of a prize allocated to the one cell is a transition to a bonus game more advantageous than the base game, transitions the base game to the bonus game.

### TECHNICAL FIELD

The present invention relates to a gaming machine including a base game having a video slot game or the like and a bonus game more advantageous than the base game.

### BACKGROUND ART

A gaming machine in which, besides a slot game, a roulette game is executed as a feature game is known (see, for example, Patent Literature 1).

### CITATION LIST

### Patent Literature

Patent Literature 1: US2016/0093145 A

### SUMMARY OF INVENTION

### Technical Problem

In a roulette game played in a conventional gaming machine, all prizes are displayed in cells in advance on a board surface of the roulette game. For this reason, it is possible to visually recognize all prizes likely to be granted to players. Expectations of the players for the roulette game are sometimes lowered.

The present invention has been made in view of the above points and an object of the present invention is to provide a gaming machine that can maintain expectation in a game in which a prize is selectively granted to a player such as a roulette game and continuously advance the game.

### Solution to Problem

A feature of a gaming machine according to the present invention is that the gaming machine includes:

a display that displays a video reel having a plurality of symbols including a predetermined symbol and a plurality of cells, to each of which a prize is allocated; and

a controller that

executes a base game in which a bet is necessary and the plurality of symbols are rearranged after scrolling of the video reel,

when the predetermined symbol is rearranged in the base game, displays content of a prize of a cell in which the content of the prize is not displayed,

when contents of prizes of all of the plurality of cells are displayed, selects one cell from the plurality of cells by lottery, and,

when content of a prize allocated to the one cell is a transition to a bonus game more advantageous than the base game, transitions the base game to the bonus game.

### Advantageous Effects of Invention

It is possible to maintain expectation in a game in which a prize is selectively granted to a player and continuously advance the game.

### BRIEF DESCRIPTION OF DRAWINGS

FIG. 1 is a front view illustrating an exterior of a gaming machine 10 according to an embodiment.

FIG. 2 is a block diagram illustrating a main hardware configuration of the gaming machine 10.

FIG. 3 is a table illustrating an example of a symbol table.

FIG. 4 is a payout table illustrating a correspondence relation between a winning combination and a payout (hereinafter referred to as a slot game payout).

FIG. 5 is a diagram illustrating a transition of a game of the gaming machine 10.

FIG. 6 is a flowchart illustrating base game processing.

FIG. 7 is a flowchart illustrating BET processing and SPIN button processing.

FIG. 8 is a table illustrating an example of a base game symbol table.

FIG. 9 is a table illustrating an example of a base game symbol table.

FIG. 10 is a table illustrating an example of a base game symbol table.

FIG. 11 is a table illustrating an example of a base game symbol table.

FIG. 12 is a table illustrating an example of a base game symbol table.

FIG. 13 is a table illustrating an example of a base game symbol table.

FIG. 14 is a table illustrating an example of a base game symbol table.

FIG. 15 is a flowchart illustrating lottery processing.

FIG. 16 is a flowchart illustrating scroll display control processing.

FIG. 17 is a flowchart illustrating dispensing number determination processing.

FIG. 18 is a flowchart illustrating JACKPOT accumulation processing.

FIG. 19 is a flowchart illustrating transition roulette game processing.

FIG. 20 is a flowchart illustrating transition roulette board determination processing.

FIG. 21 is a numeric table for determining a prize pattern for determining one prize pattern from eighty-nine prize patterns with lottery processing.

FIG. 22 is a table illustrating a prize storage region including a first storage region and a second storage region for each of five BET numbers.

FIG. 23 is a prize pattern table that stores twelve prizes decided for each of eighty-nine prize patterns.

FIG. 24 is a numeric table for a PAYOUT ratio determination in which a ratio for determining PAYOUT is determined for each of BET selection numbers.

FIG. 25 is a numeric table for prize determination for determining one cell among twelve cells with lottery processing.

FIGS. 26A to 26C are diagrams illustrating an example of symbols stop-displayed in a symbol display region 400 in a base game.

FIGS. 27A to 27D are diagrams illustrating a process in which cells on a board surface of a transition roulette game are displayed according to CLOCK stop-displayed in the base game.

FIG. 28A is a diagram illustrating a state in which the board surface of the transition roulette game rotates and FIG. 28B is a diagram illustrating a state in which the board surface of the transition roulette game is stopped.

FIGS. 29A to 29C are diagrams illustrating an example of a board surface of a transition roulette game in which display is switched for each of numbers of BETs.

FIG. 30 is a table illustrating a prize storage region in which a prize of an un-displayed cell is set to 0 when the base game is stopped halfway.

FIG. 31 is a table illustrating a prize storage region indicating a state in which a prize is stored in a second storage region when the number of “CLOCK” is carried over.

FIG. 32 is a flowchart illustrating bonus game processing.

FIG. 33 is a flowchart illustrating FLYING BONUS processing.

FIG. 34 is a flowchart illustrating FLYING BONUS processing.

FIG. 35 is a flowchart illustrating symbol table determination processing.

FIG. 36A is a diagram illustrating a configuration of a basic video reel, FIG. 36B is a diagram illustrating a state in which scrolling is performed in each of stop positions in 3 rows and 5 columns, FIG. 36C is a diagram illustrating a state in which seven RINGs are stop-displayed, and FIG. 36D is a diagram illustrating a state in which scrolling is performed at each of stop positions in 4 rows and 5 columns.

FIGS. 37A to 37G are tables illustrating allocation rules of video reels to be allocated at the time of re-spinning.

FIG. 38 is a table illustrating symbols constituting each of REEL A, REEL B, REEL C, REEL D, REEL E, and REEL F.

FIG. 39 is a table illustrating a numeric table for a FLYING BONUS roulette game.

FIGS. 40A to 40D are diagrams illustrating a board surface of a FLYING BONUS roulette game.

FIG. 41A is a diagram illustrating a state in which a board surface of a FLYING BONUS roulette game rotates and FIG. 41B is a diagram illustrating a state in which the board surface is stop-displayed to indicate that a green region is selected.

FIG. 42 is a flowchart illustrating SKILL BONUS processing.

FIG. 43 is a flowchart illustrating symbol table determination processing.

FIGS. 44A to 44C are tables illustrating a method of determining a value of a prize.

FIGS. 45A and 45B are a table for skill game unexecuted determination and a table for skill game executed determination used for determining a symbol table.

FIGS. 46A and 46B are diagrams illustrating an array of symbols in each of reels of Reels 1 (FIG. 46A) and Reels 2 (FIG. 46B).

FIGS. 47A to 47C are diagrams illustrating a video slot game in SKILL BONUS.

FIG. 48 is a flowchart illustrating skill game processing.

FIGS. 49A and 49B are ratio determination tables in which a ratio of each of gold, silver, and bronze are determined in order to determine payouts of gold, silver, and bronze.

FIGS. 50A to 50D are image diagrams at the time when regions of gold, silver, and bronze are scrolled.

FIG. 51 is a flowchart illustrating Freespin BONUS processing.

FIG. 52 is a WILD symbol array table illustrating an array of WILD symbols in Freespin BONUS.

FIG. 53 is a numeric table of a WILD symbol array table.

FIG. 54 is a part of a symbol array table illustrating an array of symbols in Freespin BONUS.

FIGS. 55A and 55B are diagrams illustrating screen display at the time when a player is caused to expect to have a high payout displayed on a lower display 210.

FIGS. 56A and 56B are diagrams illustrating screen display at the time when a player is caused to expect that WILD symbols are stopped in a block shape.

FIGS. 57A and 57B are diagrams illustrating an example of normal help information displayed separately from a game.

### DESCRIPTION OF EMBODIMENTS

### Overview of Embodiments

### <<<Aspect A and Aspect B>>>

There is a gaming machine provided with a free game more advantageous than a base game. By transitioning to such a free game, a player can play a game in a more advantageous state than the base game.

Since the free game is a game that can be played without consuming credits, a possibility of excessively giving a player a profit occurs depending on, for example, conditions for transitioning to the free game.

### <<<Aspect A-1>>>

According to Aspect A-1,

there is provided a gaming machine including:

a display that displays a video reel having a plurality of symbols including a predetermined symbol and a plurality of cells, to each of which a prize is allocated; and

a controller that

executes a base game in which a bet is necessary and the plurality of symbols are rearranged after scrolling of the video reel,

when the predetermined symbol is rearranged in the base game, displays content of a prize of a cell in which the content of the prize is not displayed,

when contents of prizes of all of the plurality of cells are displayed, selects one cell from the plurality of cells by lottery, and,

when content of a prize allocated to the one cell is a transition to a bonus game more advantageous than the base game, transitions the base game to the bonus game.

The gaming machine includes the display and the controller.

The display displays the video reel and the plurality of cells. The video reel has the plurality of symbols including the predetermined symbol. The video reel is displayed in a video slot game. The prize is allocated to each of the plurality of cells. The plurality of cells are displayed in a game for selectively determining cells. For example, the plurality of cells are displayed in a roulette game. The selection of the cell may be performed by lottery or may be instructed by a player. The prize can be allocated by lottery. The prize can be determined according to progress of a game such as a BET ratio.

The controller executes the following processing (A-1-1) to (A-1-4).

### (A-1-1) Execute the Base Game

The base game is a game that requires a bet. The controller rearranges the plurality of symbols after scrolling the video reel.

### (A-1-2) Display of Content of the Prize of the Cell

When rearranging the predetermined symbol in the base game, the controller displays content of the prize of the cell in which the content of the prize is not displayed. When the base game is being played, content of the prize of at least one cell is not displayed (un-displayed). When the predetermined symbol is rearranged in the base game, the controller switches the un-displayed cell to display (already displayed).

### (A-1-3) Selection of a Cell

When contents of all the prizes of the plurality of cells are displayed, the controller selects one cell from the plurality of cells by lottery. That is, every time the predetermined symbol is rearranged in the base game, an un-displayed cell is switched to display (already displayed). When the base game is repeated and the contents of all the prizes of the plurality of cells are displayed, one cell is selected.

### (A-1-4) Selection of a Cell

When the content of the prize of the selected one cell is a transition to the bonus game, the controller causes the transition from the base game to the bonus game.

In the base game, the player cannot visually recognize the contents of the prizes of the plurality of cells and is interested in the contents of the plurality of cells. Every time the predetermined symbol is rearranged, the un-displayed cell is gradually switched to the display (already displayed), and the player expects a cell to be selected. In this way, it is possible to continue the base game without boring the player and increase an operating ratio of the gaming machine.

### <<<Aspect A-2>>>

According to Aspect A-2, in Aspect A-1,

the controller allocates the content of the prize to each of the plurality of cells by lottery according to the symbol rearranged in the base game.

The content of the prize allocated to each of the plurality of cells is not fixed. That is, the same prize is not always allocated to each of the plurality of cells. The content of the prize is allocated to each of the plurality of cells by lottery according to the symbol rearranged in the base game.

For example, the content of the prize is allocated according to timing when the symbol is rearranged in the base game, the number of symbols rearranged in the base game, and the like.

### <<<Aspect A-3>>>

According to Aspect A-3, in Aspect A-1,

the gaming machine further includes a memory in which the contents of the plurality of prizes are readably stored in advance, and

the controller reads out the contents of the plurality of prizes from the memory, selects one prize from the plurality of prizes by lottery, and allocates the prize to each of the plurality of cells.

The contents of the plurality of prizes are stored in advance in the memory. One prize is selected by lottery and allocated to each of the plurality of cells. The contents of the plurality of prizes stored in advance in the memory are fixed. However, since a prize to be allocated is determined by lottery and allocated to the cell, the arrangement of the prize can be differentiated.

For example, when contents of first to N-th prizes are allocated to first to n-th cells, at a certain time, for example, the content of the third prize is allocated to the first cell, the content of the seventh prize is allocated to the second cell, and the content of the N-th prize is allocated to the third cell, and at the next time, for example, the content of the N-th prize is allocated to the first cell, the content of the first prize is allocated to the second cell, and the content of the N-3-th prize is allocated to the third cell.

Since the arrangement of the prizes allocated to the plurality of cells can be differentiated, it is possible to increase expectation in the prizes and cause the player to continue the base game without causing the player to feel bored.

### <<<Aspect A-4>>>

According to Aspect A-4, in Aspect A-1,

when a cell in which content of a prizes is not displayed is present among the plurality of cells, the controller allocates, according to operation by the player, contents different from the contents of the plurality of prizes to all un-displayed cells and

selects one cell from the plurality of cells by lottery.

For example, even when the player stops the base game halfway because of convenience of the player, the player can stop the base game without wasting prizes of cells displayed to that point in time.

### <<<Aspect A-5>>>

According to Aspect A-5, in Aspect A-1,

when the number of rearranged predetermined symbols is larger than the number of un-displayed cells,

the controller displays the contents of the prizes of all of the plurality of cells, selects one cell from the plurality of cells by lottery, and,

according to the difference between the number of rearranged predetermined symbols and the number of un-displayed cells, displays content of a prize of un-displayed cells in the subsequent base game.

When the number of rearranged predetermined symbols is larger than the number of un-displayed cells, the surplus number can be temporarily held until the next base game and carried over to the next base game.

### <<<Aspect A-6>>>

According to Aspect A-6, in Aspect A-1,

the gaming machine further includes:

a bet receiving device that receives a bet for starting the base game, the bet receiving device selecting one number of BETs among a plurality of numbers of BETs; and

a memory that stores, for each of the plurality of bets, content of a prize allocated to each of the plurality of cells, and

when an un-displayed cell present in the plurality of cells, when the predetermined symbol is rearranged in the base game, the controller displays content of a prize corresponding to the number of BETs at the start of the base game in the un-displayed cell.

In some case, in the beginning, a game is advanced with a low number of BETs and, when a possibility of transitioning to the bonus game occurs, the low number of BETs is switched to a high number of BETs to obtain a large profit. Since the content of the prize allocated to each of the plurality of cells is stored for each of the plurality of bets, the plurality of cells corresponding to the high number of BETs cannot be allocated by prizes unless the game is played with the high number of BETs. Therefore, it is possible to prevent excessive profit from being granted.

Conversely, in the beginning, the game is advanced with a high number of BETs and, when the high number of BETs is switched to a low number of BETs halfway, it is possible to prevent an excessively small profit from being granted.

### <<<Aspect A-7>>>

According to Aspect A-7, in Aspect A-6,

when a first number of BETs is changed to a second number of BETs in the bet receiving device, the content is switched to content of a prize corresponding to the second number of BETs and displayed in the un-displayed cell.

Since the number of BETs is changed, it is possible to prevent an excessive profit or an excessively small profit.

### <<<Aspect B-1>>>

According to Aspect B-1,

there is provided a gaming machine including:

a display that displays a video reel having a plurality of symbols including a predetermined symbol and a display panel having at least one first region and at least one second region different from the first region; and

a controller that

executes a bonus game more advantageous than a base game, the bonus game including a slot game and a selection game for selecting one of the first region and the second region,

the predetermined symbol being rearranged after scrolling of the video reel in the slot game,

every time the predetermined symbol is rearranged in the slot game, changes a ratio of the first region and the second region according to a number of rearranged predetermined symbols and displays the display panel,

executes the selection game after an end of the slot game, and

executes the bonus game again when the first region is selected.

The gaming machine includes the display and the controller.

The display displays the video reel and the display panel. The video reel has the plurality of symbols including the predetermined symbol. The video reel is displayed in the slot game. The display panel has the first region and the second region. The first region and the second region are different from each other. The display panel has at least one first region. The first region may be divided into a plurality of regions and displayed on the display panel. The display panel has at least one second region. The second region may be divided into a plurality of regions and displayed on the display panel.

The controller executes the following processing (B-1-1) to (B-1-4).

### (B-1-1)

The controller executes the base game and the bonus game. The bonus game is a game more advantageous than the base game. The bonus game includes the slot game and the selection game. The controller executes the slot game and the selection game in the bonus game. The selection game is a game for selecting one of the first region and the second region. The selection may be determined based on arithmetic processing of the controller such as lottery processing or may be determined based on operation of the player.

### (B-1-2) Rearrangement of the Predetermined Symbol

The controller rearranges the predetermined symbol after scrolling the video reel in the slot game.

### (B-1-3) Increase or Decrease of the First Region and the Second Region

In the slot game, every time the predetermined symbol is rearranged, the controller changes a ratio of the first region and the second region according to the number of rearranged predetermined symbols and displays the first region and the second region on the display panel. For example, the first region is increased and the second region is decreased according to the number of rearranged predetermined symbols. The increase or decrease of the first region and the second region only has to be able to be visually recognized on the display panel according to the number of rearranged predetermined symbols.

### (B-1-4) Execution of the Selection Game

The controller executes the selection game after the end of the slot game. An end condition for the slot game can be appropriately decided. For example, execution of a predetermined number of games can be set as the end condition. Rearrangement of a specific symbol can be set as the end condition.

### (B-1-5) Re-Execution of the Bonus Game (Continuation of the Bonus Game)

The controller executes the bonus game again when the first region is selected.

Every time the predetermined symbol is rearranged, the ratio of the first region and the second region is changed. Accordingly, as the slot game progresses, the display panel changes. It is possible to notify a possibility that the bonus game is continued. It is possible to increase the player's expectation.

### <<<Aspect B-2>>>

According to Aspect B-2, in Aspect B-1,

the controller

determines a prize to be allocated to the predetermined symbol rearranged in the bonus game, and

after an end of the bonus game, displays a prize of the predetermined symbol rearranged during the bonus game on the display.

Since not only the bonus game is re-executed but also the prize is granted, the player's interest can be increased. The prize allocated to the predetermined symbol is preferably changed by lottery processing or the like. Since not only the ratio of the first region and the second region but also the prize changes, the player's expectation can be increased as the slot game progresses.

### <<<Aspect B-3>>>

According to Aspect B-3, in Aspect B-1,

the video reel includes:

a first video reel in which a plurality of the predetermined symbols are arranged and an interval between the predetermined symbols adjacent to each other is a first interval;

a second video reel in which a plurality of the predetermined symbols is arranged and an interval between the predetermined symbols adjacent to each other is a second interval smaller than the first interval; and

a third video reel including a specific symbol different from the predetermined symbol, and

the controller selects and re-spins the second video reel when the particular symbol is rearranged after scrolling the first video reel and the third video reel.

After the re-spinning of the second video reel, the predetermined symbol can be easily rearranged and the first region can be set larger than before the re-spinning.

### <<<Aspect B-4>>>

According to Aspect B-4, in Aspect B-2,

when a cumulative total of the rearranged predetermined symbols is larger than a predetermined number,

after the bonus game ends, the controller determines a payout different from a payout of the predetermined symbol and executes the bonus game again.

When the cumulative total of predetermined symbols is larger than the predetermined number, not only the bonus game is re-executed or the prize is granted but also another payout is granted. Therefore, it is possible to give motivation to advancing the slot game.

### <<<Aspect B-5>>>

According to Aspect B-5, in Aspect B-1,

when the first region is larger than a predetermined size, the controller executes the bonus game again.

Since the bonus game is executed again, further expectation can be given.

### <<Aspect B-6>>

According to Aspect B-6, in Aspect B-1,

the controller sequentially displays help information for the bonus game during execution of the bonus game.

Even in the bonus game having a rule different from that of the slot game, since the help information is displayed during the execution of the bonus game, it is possible to quickly obtain necessary information without transitioning to the player or a help screen.

### Details of the Present Embodiment

### <<<Explanation of Terms>>>

### <Scrolling (Spinning)>

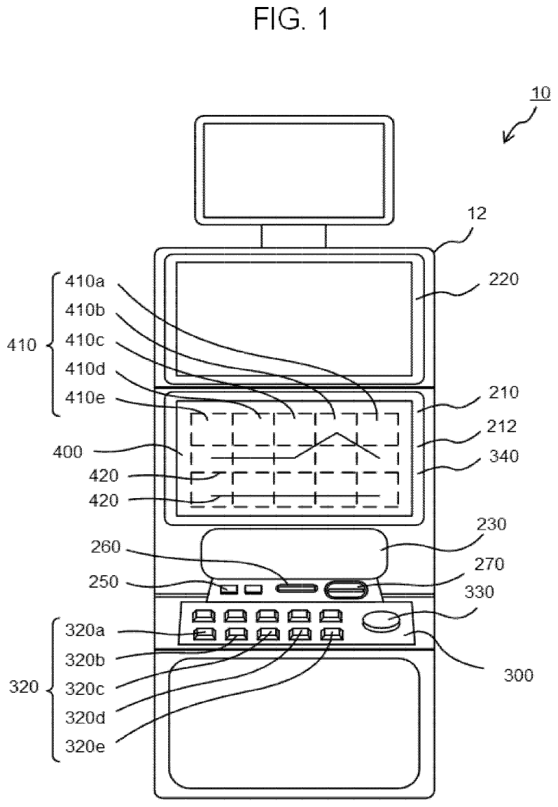

Scrolling means display by moving video reels 410a to 410e (see FIG. 1) in a symbol display region 400. By scrolling a video reel 410, a symbol allocated to the video reel 410 is also displayed to move in the symbol display region 400. In general, the scrolling is performed up to down in principle. However, the scrolling may be performed down to up, the right to the left, or the left to the right according to a type of a game, rendering, or the like. Note that spinning is synonymous with the scrolling.

### <Re-Scrolling (Re-Spinning)>

Re-scrolling is processing for once stopping the scrolled video reels 410a to 410e in the symbol display region 400 and thereafter scrolling the video reels 410a to 410e again in one unit game. Note that it is unnecessary to re-scroll all the video reels 410a to 410e. Any one video reel 410 can be selectively re-scrolled according to a result of symbol lottery processing or the like. Note that re-spinning is synonymous with the re-scrolling.

### <Stop-Display>

Stop-display means processing for displaying a symbol, in a stopped state, in each of stop positions in the symbol display region 400 when the video reels 410a to 410e are stopped.

### <Rearrangement>

Rearrangement means stopping the video reels 410a to 410e and stop-displaying a symbol in the symbol display region 400. The rearrangement is a state in which arrangement of the symbols is once released by scrolling the video reels 410a to 410e and thereafter the symbol is arranged again.

### <Unit Game>

In the video slot game, a period from when subtraction processing for the number of owned credits is executed until when the video reels 410a to 410e are stopped and dispensing processing is ended is referred to as unit game. The subtraction processing for the number of owned credits is internal processing and is different from BET operation by the player. When a BET button 320 is operated (BET operation), the number of BETs (a BET ratio) is stored in a RAM 130. In a state in which the number of BETs (the BET ratio) is stored in the RAM 130, the video slot game can be started only by operation of a SPIN button 330. Note that the unit game may be set not from the subtraction processing for the number of owned credits but from the scrolling of the video reels 410a to 410e is started until the video reels 410a to 410e are stopped and the dispensing processing is ended.

### <<<Winning Combination>>>

The winning combination means a sequence in which the sequence of symbols stop-displayed along a pay line 420 in the symbol display region 400 is a target of profit granting. Note that, in the case of a scatter symbol explained below, the winning combination is a combination in which the number of stop-displayed scatter symbols is a predetermined number and is the target of profit granting. Here, the profit granting is not only provision (dispensing) of a payout and only has to be anything that is advantageous to the player such as transitioning to an advantageous game.

### <Scatter Symbol>

The scatter symbol is a symbol for which establishment of the winning combination is determined according to the number of stop-displayed symbols. The scatter symbol is determined according to the number of stop-displayed symbols irrespective of whether the symbols are arranged along the valid pay line 420.

### <WILD Symbol>

A WILD symbol is a symbol that can be substituted for another symbol stop-displayed in the symbol display region 400. When establishment of the winning combination is determined, the establishment of the winning combination is determined by replacing the WILD symbol with another symbol. The WILD symbol is replaced with another symbol such that an advantageous winning combination is established.

Note that, when the WILD symbol is stop-displayed in a stop position overlapping a plurality of valid pay lines 420, establishment of the winning combination is determined by replacing the WILD symbol for each of the pay lines 420.

### <Skill Game>

A skill game is a game for reflecting an operation skill of a player on a result of the game. In particular, in the skill game of the present embodiment, the player determines timing of stop operation and performs the stop operation (target object stop operation) aiming at stop-display of an object such as a symbol set as a target. The operation skill of the player is reflected on the determination of the timing of the stop operation.

For example, the game may be a game for scrolling a video reel for a skill game used in a skill game and stopping a desired portion (regions of gold, silver, bronze, and the like) on the video reel for the skill game in a predetermined position. In a video slot game or the like, the scrolling video reel 410 can be shared and stopped by stop operation of a player to stop the target symbol in a predetermined position. The skill game only has to be a game for not only stopping the video reel but also stopping a moving object moving on the lower display 210 or the upper display 220 in a designated position.

### <Prize>

A prize includes granting of a slot game payout, transitioning to BONUS, granting of a JACKPOT payout, and granting of a bonus game payout. The slot game payout is granting of a predetermined number of credits associated with a winning combination when the winning combination of a predetermined symbol is established in the video slot game. JACKPOT payout is granting of MINI, MINOR, MAJOR, GRAND, and the like. Besides, the prize may be, for example, a transition to a bonus.

The slot game is sometimes played in a bonus game besides the base game. The slot game payout is included in a base game payout or a bonus game payout.

### <Payout>

A payout is a type of a prize and is granting of a credit. The payout is granting of a credit, a specific numerical value of which is decided, and a predetermined number of credits are granted to the player. The payout includes a slot game payout, a bonus payout, and a JACKPOT payout.

### Present Embodiment

The present embodiment will be explained below with reference to the drawings.

### <<<Configuration of a Gaming Machine 10>>>

FIG. 1 is a front view illustrating an exterior of a gaming machine 10 according to the present embodiment. The gaming machine 10 is a video slot machine. In the gaming machine 10, as in a mechanical slot machine in which a physical reel is driven by a motor or the like, establishment of a winning combination is determined by a symbol stop-displayed in the symbol display region 400. The gaming machine 10 only has to be a device that can transition a base game serving as a reference to another game (a game more advantageous for a player than the base game is preferable). The gaming machine 10 provides not only a video slot game but also various games different from video slot game such as a roulette game, a pick game, a backgammon game, and a battle game.

As illustrated in FIG. 1, the gaming machine 10 mainly includes the lower display 210, the upper display 220, a control panel 300, and a controller 100.

### <<Lower Display 210>>

The gaming machine 10 includes the lower display 210 in substantially the center of a housing 12. The lower display 210 includes, for example, a liquid crystal display panel 212 and a touch panel 340. The touch panel 340 is provided to be superimposed on the liquid crystal display panel 212. When the player touches the touch panel 340, an instruction corresponding to an image displayed on the liquid crystal display panel 212 can be inputted from the touch panel 340.

The lower display 210 further includes a number of credits display region and a payout number display region (not illustrated). In the number of credits display region, the number of credits owned by the player is displayed. In the payout number display region, the number of credits to be dispensed when a predetermined winning combination is established is displayed.

### <<Upper Display 220>>

The gaming machine 10 includes the upper display 220 above the lower display 210. The upper display 220 includes a liquid crystal display panel. Various images such as a rendering image are displayed on the upper display 220.

### <<Control Panel 300>>

The gaming machine 10 includes the control panel 300 below the lower display 210. The control panel 300 mainly includes the BET button 320, the SPIN button 330, a card reading device 250, a bill depositing device 260, and a ticket dispensing device 270.

<BET Button 320 (320a, 320b, 320c, 320d, and 320e)>

The control panel 300 includes a BET button 320a, a BET button 320b, a BET button 320c, a BET button 320d, and a BET button 320e. In the following explanation, each of the five BET buttons 320a to 320e is simply referred to as the BET button 320 when it is not particularly necessary to distinguish the BET buttons 320a to 320e or when the BET buttons 320a to 320e cannot be distinguished. The BET means deposit of a credit for executing (starting) a game. The number of BETs means a deposit number, a deposit volume, a deposit amount, and the like. The BET ratio means a ratio for determining the deposit number, the deposit volume, the deposit amount, and the like.

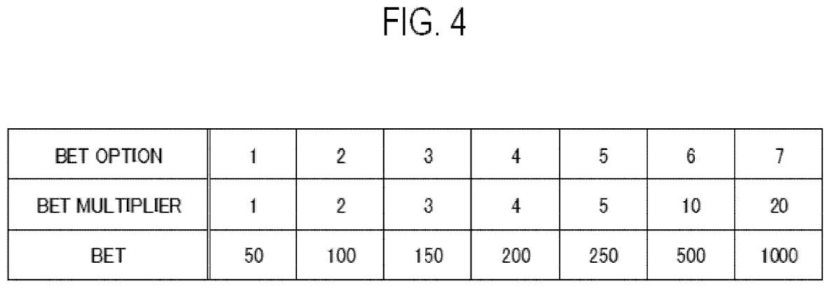

FIG. 4 is a table illustrating a relation among the BET selection number, the BET ratio, and the number of credits. A minimum number of BETs of the gaming machine 10 is, for example, 50 credits. As illustrated in FIG. 4, the gaming machine 10 has seven BET select numbers. The BET selection number corresponds to the BET ratio. The BET ratio is allocated to each of the BET select numbers in advance.

### <BET Selection Number, BET Ratio, Number of Credits>

ABET ratio corresponding to a BET selection number 1 is 1 and the number of credits is 50 (=50×1). A BET ratio corresponding to a BET selection number 2 is 2 and the number of credits is 100 (=50×2). A BET ratio corresponding to a BET selection number 3 is 3 and the number of credits is 150 (=50×3). A BET ratio corresponding to a BET selection number 4 is 4 and the number of credits is 200 (=50×4). ABET ratio corresponding to a BET selection number 5 is 5 and the number of credits is 250 (=50×5). A BET ratio corresponding to a BET selection number 6 is 10 and the number of credits is 500 (=50×10). A BET ratio corresponding to a BET selection number 7 is 20 and the number of credits is 1000 (=50×20).

In this way, the gaming machine 10 has the seven BET selection numbers. Five BET selection numbers selected out of the BET selection numbers are allocated to the five BET buttons 320a, 320b, 320c, 320d, and 320e.

The gaming machine 10 has a manager mode. In the manager mode, the BET selection number (the BET ratio) allocated to each of the five BET buttons 320a to 320e can be changed by operation of a store clerk or the like. For example, any one of the following BET patterns A to C can be selected to change a set of BET ratios. The BET selection number allocated to each of the BET buttons 320a to 320e is stored in the RANI 130 according to the selected BET pattern.

### <BET Pattern A>

When the BET pattern A is selected, a BET ratio of 1 (a BET selection number 1) is allocated to the BET button 320a, a BET ratio of 2 (a BET selection number 2) is allocated to the BET button 320b, a BET ratio of 3 (a BET selection number 3) is allocated to the BET button 320c, a BET ratio of 4 (a BET selection number 4) is allocated to the BET button 320d, and a BET ratio of 5 (a BET selection number 5) is allocated to the BET button 320e.

When the BET pattern A is selected, the BET ratio is set to 1 when the player operates the BET button 320a, the BET ratio is set to 2 when the player operates the BET button 320b, the BET ratio is set to 3 when the player operates the BET button 320c, the BET ratio is set to 4 when the player operates the BET button 320d, and the BET ratio is set to 5 when the player operates the BET button 320e.

### <BET Pattern B>

When the BET pattern B is selected, a BET ratio of 1 (the BET selection number 1) is allocated to the BET button 320a, a BET ratio of 2 (the BET selection number 2) is allocated to the BET button 320b, a BET ratio of 3 (the BET selection number 3) is allocated to the BET button 320c, a BET ratio of 5 (the BET selection number 5) is allocated to the BET button 320d, and a BET ratio of 10 (the BET selection number 6) is allocated to the BET button 320e.

When the BET pattern B is selected, the BET ratio is set to 1 when the player operates the BET button 320a, the BET ratio is set to 2 when the player operates the BET button 320b, the BET ratio is set to 3 when the player operates the BET button 320c, the BET ratio is set to 5 when the player operates the BET button 320d, and the BET ratio is set to 10 when the player operates the BET button 320e.

### <BET Pattern C>

When the BET pattern C is selected, a BET ratio of 1 (the BET selection number 1) is allocated to the BET button 320a, a BET ratio of 3 (the BET selection number 3) is allocated to the BET button 320b, a BET ratio of 5 (the BET selection number 5) is allocated to the BET button 320c, a BET ratio of 10 (the BET selection number 6) is allocated to the BET button 320d, and a BET ratio of 20 (the BET selection number 7) is allocated to the BET button 320e.

When the BET pattern C is selected, the BET ratio is set to 1 when the player operates the BET button 320a, the BET ratio is set to 3 when the player operates the BET button 320b, the BET ratio is set to 5 when the player operates the BET button 320c, the BET ratio is set to 10 when the player operates the BET button 320d, and the BET ratio is set to 20 when the player operates the BET button 320e.

### <BET Number>

The BET button 320a corresponds to a BET number 1. In the BET number 1, a BET selection number allocated to the BET button 320a is stored. The BET button 320b corresponds to a BET number 2. In the BET number 2, a BET selection number allocated to the BET button 320b is stored. The BET button 320c corresponds to a BET number 3. In the BET number 3, a BET selection number allocated to the BET button 320c is stored. The BET button 320d corresponds to a BET number 4. In the BET number 4, a BET selection number allocated to the BET button 320d is stored. The BET button 320e corresponds to a BET number 5. In the BET number 5, a BET selection number allocated to the BET button 320e is stored.

### <SPIN Button 330>

Scrolling of the video reels 410a to 410e can be started by the player operating the SPIN button 330. As explained below, in the gaming machine 10 in the present embodiment, a skill game is executed. In the skill game, when a reel such as the video reel 410 is scrolled, the scrolling reel can be stopped by operating the SPIN button 330. Note that, as explained above, the skill game only has to be a game in which not only a symbol of the video reel 410 but also a moving object is stopped in a designated position and only has to be a game in which the moving object is stopped by operation of the SPIN button 330.

### <<<Hardware Configuration of the Gaming Machine 10>>>

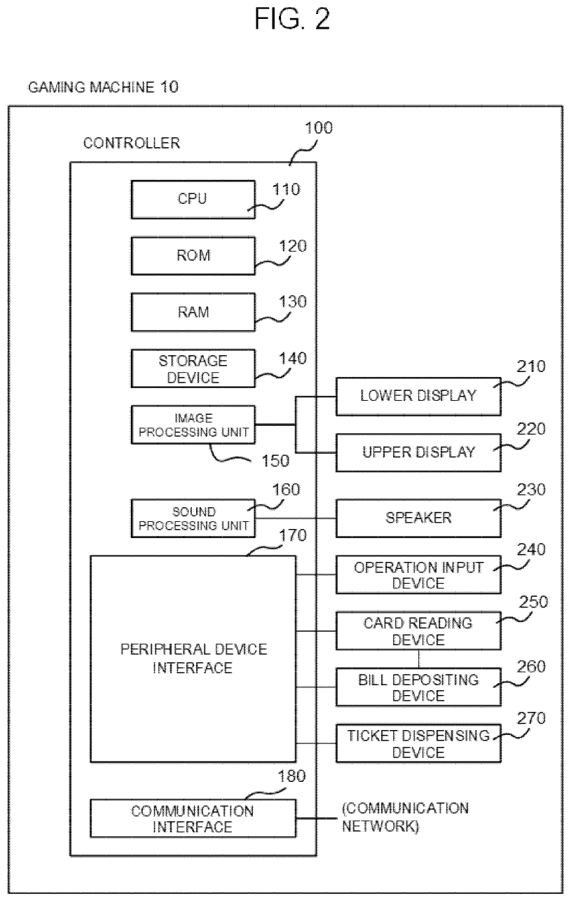

FIG. 2 is a block diagram illustrating a main hardware configuration of the gaming machine 10.

The controller 100 of the gaming machine 10 mainly includes a CPU (central processing unit) 110, a ROM (read only memory) 120, a RAM (random access memory) 130, a storage device 140, an image processing unit 150, a sound processing unit 160, a peripheral device interface 170, and a communication interface 180. These are connected via an input and output bus (not illustrated) to be capable of transmitting and receiving various commands and signals.

### <CPU 110, ROM 120, RAM 130>

The CPU 110 executes various kinds of processing such as an arithmetic operation. For example, the CPU 110 reads out and executes a game program stored in the storage device 140. The ROM 120 stores firmware and the like of the controller 100 and functions as one of main storage devices of the CPU 110. The RAM 130 functions as one of main storage devices of the CPU 110, develops and stores a program to be executed by the CPU 110, and temporarily stores a result of arithmetic processing of the CPU 110.

### <Storage Device 140>

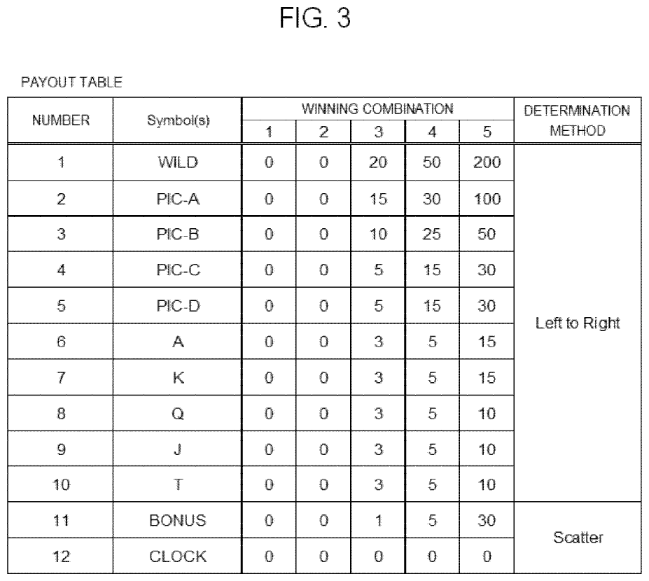

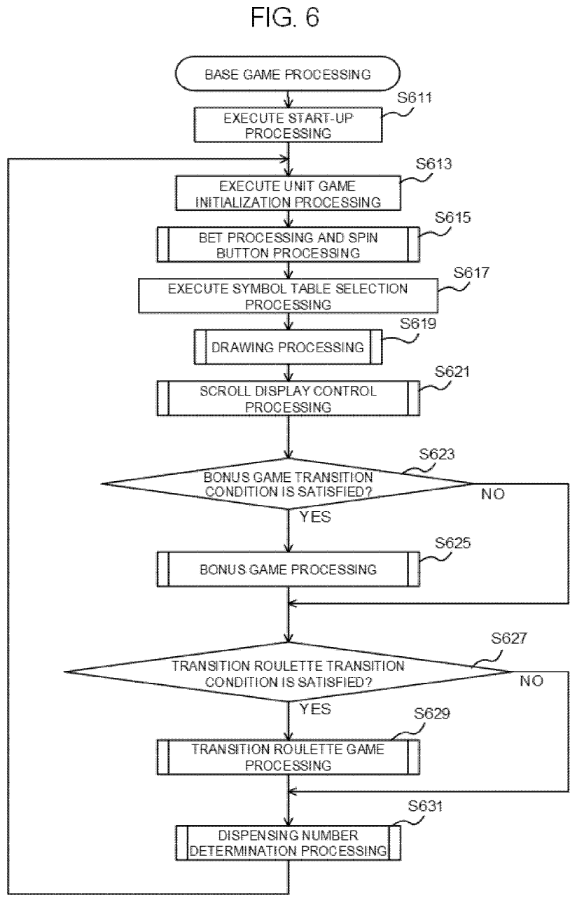

The storage device 140 functions as an auxiliary storage device of the CPU 110 and includes a hard disk drive (HDD), a solid state drive (SSD), and a non-volatile memory. The storage device 140 stores a program (see, for example, FIG. 6 referred to below), various tables (such as a payout table illustrated in FIG. 3), image data of symbols, image data for rendering, and audio data for rendering.

### <Image Processing Unit 150>

The image processing unit 150 is connected to the lower display 210 and the upper display 220. The CPU 110 outputs various commands and signals to the image processing unit 150. The image processing unit 150 displays various images on the lower display 210 and the upper display 220 according to a command or a signal output from the CPU 110. For example, the image processing unit 150 displays images of the video reels 410a to 410e on the lower display 210. The image processing unit 150 displays images such as various rendering images on the upper display 220.

### <Sound Processing Unit 160>

The sound processing unit 160 is connected to a speaker 230. The CPU 110 outputs various commands and signals to the sound processing unit 160. The sound processing unit 160 supplies a sound signal for rendering to the speaker 230 according to a command or a signal output from the CPU 110.

### <Peripheral Device Interface 170>

The peripheral device interface 170 is connected to peripheral devices such as the operation input device 240, the card reading device 250, the bill depositing device 260, and the ticket dispensing device 270.

The operation input device 240 includes the BET buttons 320a to 320e, the SPIN button 330, and the touch panel 340. When the player operates the BET buttons 320a to 320e, a signal indicating a BET ratio is supplied to the CPU 110 via the peripheral device interface 170. When the player operates the SPIN button 330, a signal indicating spin start permission is supplied to the CPU 110 via the peripheral device interface 170. When the player operates the touch panel 340, a command or the like associated with an image displayed on the liquid crystal display panel 212 is supplied to the CPU 110 via the peripheral device interface 170.

The card reading device 250 reads information from a card owned by the player. The card stores play information of the player. For example, the card stores a point or the like acquired according to a gaming state of the player. The bill depositing device 260 reads a deposited bill or ticket. The ticket dispensing device 270 outputs a ticket to be granted to a player. On the ticket, the number of credits owned by the player is printed.

The gaming machine 10 can use bills, tickets, and electronic valuable information equivalent to these as game media. Game media are not limited to these and, for example, a medal, a token, electronic money, or the like can also be used.

### <Communication Interface 180>

The communication interface 180 is communicably connected to a management server via a network (not illustrated). The management server is installed in a casino, an amusement facility, or the like. In the management server, a command or a signal corresponding to operation by a store clerk or the like is supplied to the CPU 110 via the communication interface 180. For example, a progressive jack pot or the like is determined by another gaming machine 10, a server, or the like. Information concerning the progressive jack pot is transmitted and received via the network.

### <<<Types of Symbol>>>

The CPU 110 of the gaming machine 10 displays symbols on the lower display 210. As explained below, the gaming machine 10 includes a base game and a bonus game. The bonus game has three types of games: FLYING BONUS, SKILL BONUS, and Freespin BONUS. The symbols are decided according to these games.

### <Symbol of the Base Game>

There are 12 types of symbols of the base game. Specifically, the symbols are WILD, PIC-A, PIC-B, PIC-C, PIC-D, A, K, Q, J, T, BONUS, and CLOCK.

### <Symbols of the FLYING BONUS>

Symbols of the FLYING BONUS are five types. Specifically, the symbols are RING, DOLPHIN, ROCKET, DRAGON, and BLANK.

### <Symbols of the SKILL BONUS>

Symbols for the SKILL BONUS are two types. Specifically, the symbols are IDEA and BLANK.

### <Symbols of the Freespin BONUS>

Symbols of the Freespin BONUS are twelve types. Specifically, the symbols are WILD, PIC-A, PIC-B, PIC-C, PIC-D, A, K, Q, J, T. Note that, in Freespin BONUS, as explained below, the WILD is sometimes displayed in a block shape.

<<<Symbol Display Region 400 and Video Reels 410a to 410e>>>

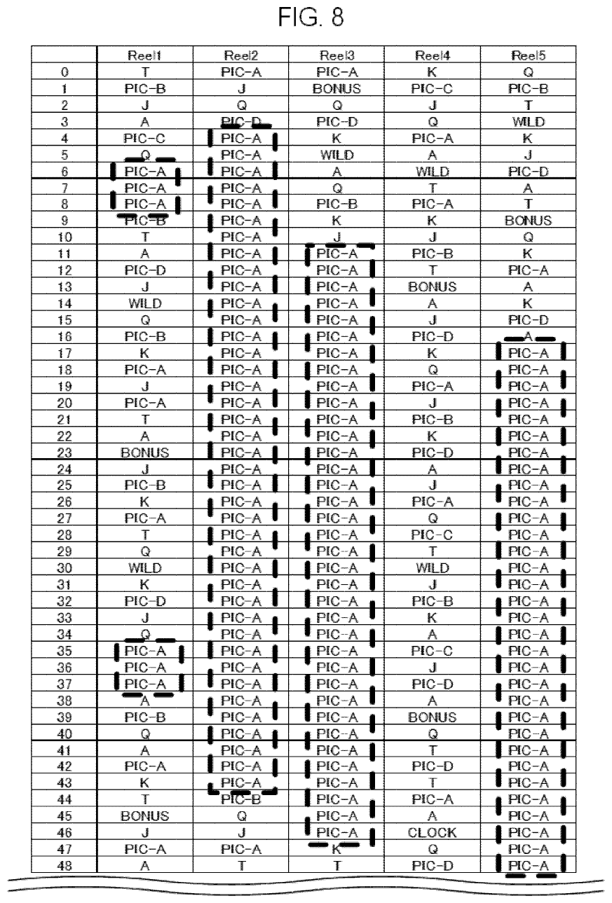

As illustrated in FIG. 1, the lower display 210 includes the symbol display region 400. In the symbol display region 400, the five video reels 410a, 410b, 410c, 410d, and 410e are displayed. Note that, when it is not particularly necessary to distinguish the video reels 410a to 410e or the video reels 410a to 410e cannot be distinguished, the video reels 410a to 410e are simply referred to as video reel 410. A plurality of symbols decided in advance are allocated to each of the video reels 410a to 410e in predetermined order (see FIG. 8 to FIG. 14 and the like). FIG. 8 to FIG. 14 are tables illustrating examples of symbol tables of the base game. The symbols are switched according to a type of a game.

The video reels 410a to 410e are scrolled and stopped in the symbol display region 400. In other words, the symbols are displayed to move or are stop-displayed in the symbol display region 400. Note that, in the following explanation, the video reels 410a to 410e is sometimes referred to as Reel 1, Reel 2, Reel 3, Reel 4, and Reel 5.

In the FLYING BONUS explained below, not the five video reels 410a, 410b, 410c, 410d, and 410e but other video reels are displayed in the symbol display region 400. A video reel is allocated to each of stop positions (cells) of the symbols and scrolled.

### <<<Stop Position and Rearrangement of Symbols>>>

As illustrated in FIG. 1, in the present embodiment, the symbol display region 400 has stop positions (cells) in 3 rows and 5 columns (broken lines in FIG. 1). When the video reels 410a to 410e are stopped, symbols are stop-displayed in each of the stop positions in 3 rows and 5 columns. That is, when the video reels 410a to 410e are stopped, fifteen symbols in total are displayed (rearranged) in a matrix shape of 3 rows and 5 columns. As explained below, every time a unit game is played, a plurality of symbols are rearranged in the symbol display region 400 and a lottery result of the symbols in the unit game is displayed.

### <<<Pay Line 420>>>

The gaming machine 10 has the pay line 420 in the symbol display region 400. In the present embodiment, the number of the pay lines 420 is 243 (=3⁵). In FIG. 1, only representative pay lines 420 are illustrated. In the present embodiment, all of the 243 pay lines 420 are enabled irrespective of operation of the BET button 320.

The pay line 420 is formed by connecting one stop position selected for each of the video reels 410a to 410e. Establishment of a winning combination is determined by a type and the number of symbols continuously arranged along the pay line 420 from a leftmost stop position (the video reel 410a). A target of the determination of the winning combination is arrangement of symbols continuously arranged from the leftmost stop position along the pay line 420.

### <<<Winning Combination and a Payout (a Slot Game Payout)>>>

FIG. 3 is a payout table illustrating a correspondence relation between a winning combination and a payout. The payout table illustrated in FIG. 3 illustrates, as a representative, a payout of a slot game played in the base game. As explained below, in the gaming machine 10, a slot game is also played in the FLYING BONUS, the SKILL BONUS, and the FREESPIN BONUS. For convenience, payout tables of these bonus games are omitted. The number of slot game payouts illustrated in FIG. 3 is a credit value and a value associated with a predetermined amount of money. The correspondence relation of the payout table illustrated in FIG. 3 is stored in advance in the storage device 140.

Slot game payouts are associated with winning combinations of No. 1 to No. 10. When lottery processing for a symbol is executed and a type and the number of symbols continuously arranged from the leftmost stop position (the video reel 410a) along the pay line 420 coincide with one of the winning combinations No. 1 to No. 10, a winning combination is established and a slot game payout corresponding to the winning combination is dispensed (stored in the RAM 130).

For example, a slot game payout at the time when three PIC-As (No. 2) are arranged along the pay line 420 is 15. A slot game payout at the time when 5 Qs (No. 8) are arranged along the pay line 420 is 10.

No. 11 and No. 12 are scatter symbols. BONUS of No. 11 is associated with a slot game payout. Further, the BONUS is used not only as the slot game payout but also as a condition for a transition to a different type of a game. The BONUS is used as a condition for a transition from the base game to the bonus game. No slot game payout is associated with CLOCK of No. 12. The CLOCK is used as a condition for a transition from the base game to the roulette game.

### <Bonus Payout and JACKPOT Payout>

The gaming machine 10 in the present embodiment includes not only a slot game payout but also a transition roulette game payout, a bonus payout, and a JACKPOT payout. Various payouts such as the slot game payout, the transition roulette game payout, the bonus payout, and the JACKPOT payout are added to the number of credits owned by the player. The transition roulette game payout, the bonus payout, the JACKPOT payout, and the like are explained below.

When the player finishes a game of the gaming machine 10, the ticket dispensing device 270 prints the number of credits owned by the player on a ticket. In this way, it is possible to perform settlement in the gaming machine 10.

### <<<Type of a Game and Transition>>>

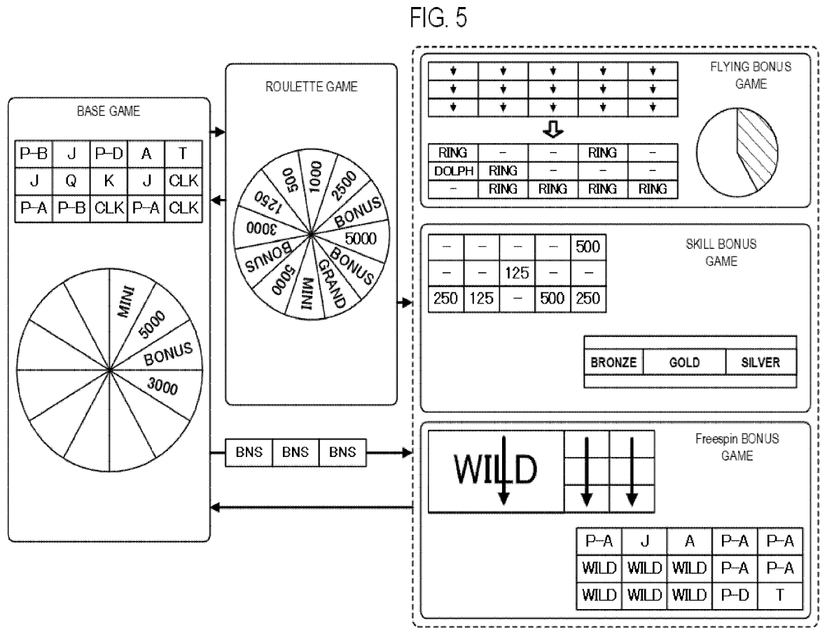

FIG. 5 is a diagram illustrating transition of a game to be executed in the gaming machine 10. In FIG. 5, for simplification, the symbol PIC-A is abbreviated as P-A, the symbol PIC-B is abbreviated as P-B, the symbol PIC-C is abbreviated as P-C, the symbol PIC-D is abbreviated as P-D, the symbol BONUS is abbreviated as BONUS or BNS, the symbol CLOCK is abbreviated as CLK, and the symbol DOLPHIN is abbreviated as DOLPH.

### <<Base Game and Bonus Game>>

The gaming machine 10 has a base game, a transition roulette game, and a bonus game. The base game has a video slot game. The bonus game has three types of games: FLYING BONUS, SKILL BONUS, and Freespin BONUS. When transitioning from the base game to the bonus game, the player can select any game of the FLYING BONUS, the SKILL BONUS, and the Freespin BONUS with operation of the player. The intention of the player can be reflected for a type of the bonus game.

The FLYING BONUS has a video slot game and a roulette game. The SKILL BONUS has a video slot game and a skill game. The Freespin BONUS has a video slot game.

### <Base Game>

The base game has a video slot game. When a winning combination of the symbol BONUS is established in lottery processing of a symbol of the video slot game, the base game transitions to the bonus game. In this case, the base game directly transitions to the bonus game.

When the CLOCK is stop-displayed in the lottery processing of the symbol in the video slot game, a part of the cells constituting a board surface of the transition roulette game explained below is displayed. The board surface of the transition roulette game has twelve cells of a first cell to a twelfth cell. A prize is allocated to each of the twelve cells. The prize includes granting of a payout, a transition of BONUS transition, and granting a JACKPOT payout. Various numbers of credits are allocated to the payout. The JACKPOT includes MINI, MINOR, MAJOR, and GRAND. One cell is selected by the transition roulette game and a prize allocated to the selected cell is determined.

On the board surface of the transition roulette game, at the start time of the base game (including the resumption time when the transition roulette game or the bonus game returns to the base game), except when the number of CLOCKs is carried over (explained below), only a prize of the first cell among the 12 cells are displayed in advance (already displayed) and the prizes of the remaining eleventh second to twelfth cells are not displayed (not displayed). The prize of the first cell displayed in advance in the cell is preferably a prize more advantageous than slot game payouts such as a transition of BONUS and granting of a JACKPOT payout. The advantageous prize can increase the player's interest in the transition roulette game.

According to the number of CLOCKs stop-displayed in the video slot game of the base game, a cell in which a prize is not displayed yet (an un-displayed cell) is switched to a cell in which a prize is displayed (an already-displayed cell). Specifically, the same number of un-displayed cells as the number of stop-displayed CLOCKs are switched to the already-displayed cells. The player can visually recognize prizes of the displayed cells. When the base game is executed, the un-displayed cell and the already-displayed cell are mixed. During the execution of the base game, the player can visually recognize only a part of the prizes and cannot visually recognize all of the prizes. Note that not only continuous cells but also discontinuous cells may be switched to already displayed.

Every time the CLOCK is stop-displayed, the same number of un-displayed cells as the number of stop-displayed CLOCKs are gradually displayed. When prizes of all of the twelve cells are displayed, the base game transitions to the transition roulette game.

When the number of stop-displayed CLOCKs is larger than the number of un-displayed cells, the prizes of all of twelve cells are displayed and a surplus number of the number of stop-displayed CLOCKs and the number of un-displayed cells is carried over. At a point in time when the subsequent base game starts, prizes of the carried-over surplus umber of un-displayed cells are displayed and switched to already displayed. When the surplus number is carried over as well, a prize of the first cell is displayed. The carried-over prizes are displayed as prizes of the second and subsequence cells.

### <Transition Roulette Game>

When the prizes of all of the twelve cells on the board surface of the transition roulette game are displayed in the base game, the base game transitions to the transition roulette game. In the transition roulette game, one of the twelve cells is determined by lottery processing. A prize allocated to the determined one cell is granted.

When the BONUS is selected in the transition roulette game, the transition roulette game transitions to the bonus game. The base game can transition to the bonus game via the transition roulette game. The base game can not only directly transition to the bonus game but also transition to the bonus game via the transition roulette game. In the transition roulette game, when a payout is selected or when a JACKPOT payout is selected, the transition roulette game returns to the base game. The video slot game of the base game begins again.

### <Bonus Game>

When the base game transitions to the bonus game, the player may select one of the bonus games of the FLYING BONUS, the SKILL BONUS, and the Freespin BONUS with selection operation.

### <FLYING BONUS>

The FLYING BONUS has a video slot game (hereinafter referred to as FLYING BONUS slot game) and a roulette game (hereinafter referred to as FLYING BONUS roulette game).

### <FLYING BONUS Slot Game>

The FLYING BONUS slot game is played the maximum seven times. That is, the unit game is played seven times. When the video slot game is played seven times except when the FLYING BONUS is continued, the video slot game transitions to the FLYING BONUS roulette game. The FLYING BONUS slot game is a free game.

In the FLYING BONUS slot game, the symbol display region 400 has stop positions of symbols in 3 rows and 5 columns or 4 rows and 5 columns. When the stop position is 3 rows by 5 columns, fifteen symbols in total are stop-displayed in the symbol display region 400. When the stop position is 4 rows by 5 columns, twenty symbols in total are stop-displayed in the symbol display region 400. The FLYING BONUS slot game usually has stop positions in 3 rows and 5 columns.

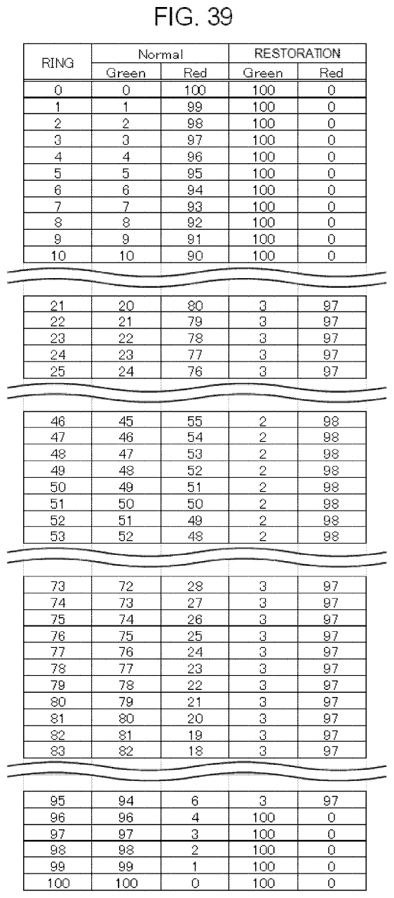

In the FLYING BONUS slot game, six types of video reels (REEL A to REEL F in FIG. 39 explained below) are allocated to each of the stop positions (3 rows and 5 columns or 4 rows and 5 columns) and scroll at each of the stop positions. The video reels to be allocated are determined according to the types of the symbols stop-displayed in the FLYING BONUS slot game.

In the FLYING BONUS slot game, RING, DOLPHIN, DRAGON, ROCKET, and BLANK are stop-displayed.

When the RING is stop-displayed, a bonus payout is granted. The bonus payout can be increased as the number of RINGs to be stop-displayed increases.

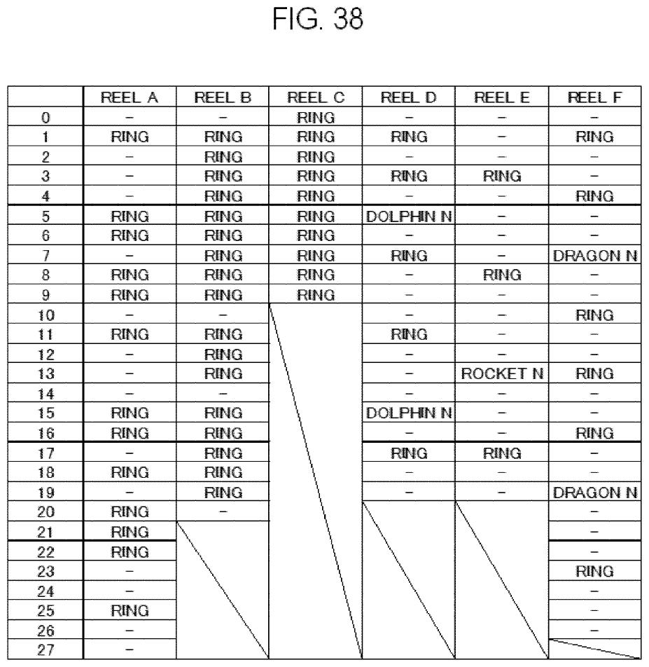

When the DOLPHIN, the DRAGON, and the ROCKET (hereinafter referred to as persona symbols) are stop-displayed, the video reel allocated to each of the stop positions (3 rows and 5 columns or 4 rows and 5 columns) is changed and re-spun. Specifically, the RING is switched to a video reel (REEL B, REEL C, or the like in FIG. 38 explained below) that is easily stop-displayed.

When DOLPHIN is stop-displayed, the stop positions of the symbols are 4 rows and 5 columns. The video reel allocated to each of 4 rows and 5 columns is changed and re-spun. By increasing the stop positions, the possibility of increasing the RINGs to be stop-displayed increases. A BONUS payout can be sometimes increased.

When the DRAGON is stop-displayed, the stop-display of the stop-displayed RING is maintained in the stop position. The video reels allocated to the other stop positions are changed and re-spun. Since the stop-displayed RING is maintained, it is possible to increase the RINGs stop-displayed by the re-spinning.

When the DRAGON is stop-displayed, a ratio multiplied with a bonus payout by the stop display of the RING is determined. The bonus payouts can be increased.

A roulette board surface of the FLYING BONUS roulette game has a green region and a red region. The roulette board surface of the FLYING BONUS roulette game is displayed on the upper display 220 when the FLYING BONUS slot game is played and is displayed on the lower display 210 when the FLYING BONUS roulette game is played.

The RING stop-displayed in the FLYING BONUS slot game increases the green region of the roulette board surface. The size of the green region is determined by the number of stop-displayed RINGs. When the number of RINGs stop-displayed in the FLYING BONUS slot game increases, there is a high possibility that the roulette board surface has only the green region.

### <FLYING BONUS Roulette Game>

When the green region is won by the lottery processing in the FLYING BONUS roulette game, the FLYING BONUS continues. When the FLYING BONUS continues, the FLYING BONUS slot game is executed again without returning to the base game.

The roulette board surface of the FLYING BONUS roulette game includes 100 cells. At the start time (including at the continuation time) of the FLYING BONUS slot game, the entire region of the roulette board surface is configured by the red region except when green region is carried over (explained below). One RING stop-displayed in the FLYING BONUS slot game corresponds to one cell. The number of stop-displayed RINGS is the number of cells that turn green. The green region is displayed on the roulette board surface.

When the number of RINGs stop-displayed in the FLYING BONUS slot game is larger than 100, the entire region of the roulette board surface turns green. A surplus number larger than 100 is carried over. When the subsequent FLYING BONUS slot game starts thereafter, the surplus number of cells turn green and the green region is displayed.

When the number of RINGs stopped displayed in the FLYING BONUS slot game is larger than 100, a roulette board surface different from the roulette board surface of the FLYING BONUS roulette game is displayed and another roulette game is executed to grant a further bonus payout. The other roulette game includes a plurality of cells. A prize is allocated to each of the plurality of cells in advance. One cell is selected by lottery processing and a prize is determined.

### <SKILL BONUS>

The SKILL BONUS has a video slot game and a skill game.

### <Video Slot Game of the SKILL BONUS>

A video slot game of the SKILL BONUS is played the maximum five times. The video slot game of the SKILL BONUS is a free game. That is, the unit game is played five times. When the video slot game is played five times, the SKILL BONUS returns to the base game. In the video slot game of the SKILL BONUS, IDEA and BLANK are stop-displayed.

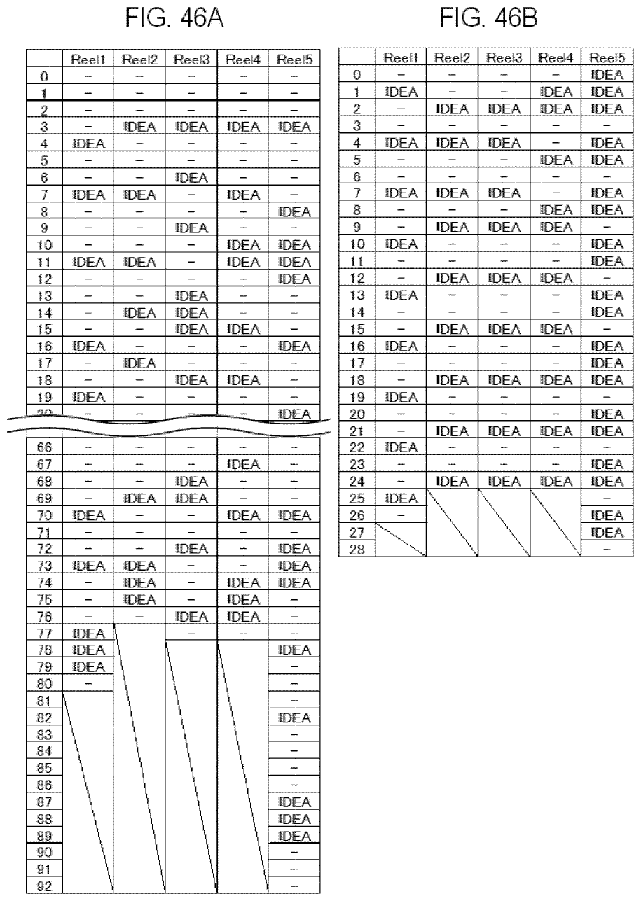

When the IDEA is stop-displayed, a bonus payout is granted. When six IDEAs are stop-displayed, the video slot game transitions to a skill game. In the video slot game of the SKILL BONUS, video reels (REEL 1 and REEL 2 illustrated in FIGS. 46A and 46B explained below) are configured such that a transition to the video slot game can always transition to the skill game at least once.

### <Skill Game of the SKILL BONUS>

In the skill game of the SKILL BONUS, a skill game video reel scrolled in the lateral direction is displayed. The skill game video reel has three types of regions: a “gold” region, a “silver” region, and a “bronze” region. The widths and scroll speeds of the “gold” region, the “silver” region, and the “bronze” region are determined according to a bonus payout or the like in the video slot game of the SKILL BONUS. After scrolling of the skill game video reel, the player can stop the skill game video reel by operating the SPIN button 330. The bonus payout is determined according to a type of a region stopped in a fixed position, for example, the front.

### <Freespin BONUS>

The Freespin BONUS has a video slot game. The video slot game is a free game. The video slot game of the Freespin BONUS is played the maximum eight times. That is, the unit game is played eight times. When the video slot game is played eight times, the Freespin BONUS returns to the base game.

In the Freespin BONUS, the WILD is displayed to be superimposed on the same video reel as the base game. The WILD includes not only one symbol but also a plurality of block-like WILDs. For example, WILDs configured in 2 rows and 2 columns, 3 rows and 3 columns, 4 rows and 4 columns, and 5 rows and 5 columns are displayed to be superimposed on a normal video reel. Establishment of a winning combination is determined. Note that the plurality of block-like WILDs only has to be block-like. The number of rows and the number of columns do not need to be the same. The number of rows and the number of columns may be different.

### <<<<Processing of the Gaming Machine 10>>>>

Processing of the gaming machine 10 is explained with reference to FIGS. 6 to 57. It is assumed that the gaming machine 10 has completed start-up processing such as initialization and is steadily operating. It is assumed that the reading device 250, the bill depositing device 260, and the like are operated by the player and a necessary credit is deposited.

### <<<Base Game Processing>>>

FIG. 6 is a flowchart illustrating base game processing invoked and executed in the base game.

First, when the gaming machine 10 is powered on, the CPU 110 of the controller 100 reads out a BIOS from the ROM 120 and executes the BIOS and, thereafter, reads out a game program from the storage device 140 and develops and stores the game program in the RAM 130 to be executable (step S611).

Subsequently, the CPU 110 of the controller 100 executes initialization processing at a unit game end time (step S613). For example, the number of BETs, symbols determined by the lottery processing, and the like are initialized. In the processing in step S613, the CPU 110 subtracts the number of games.

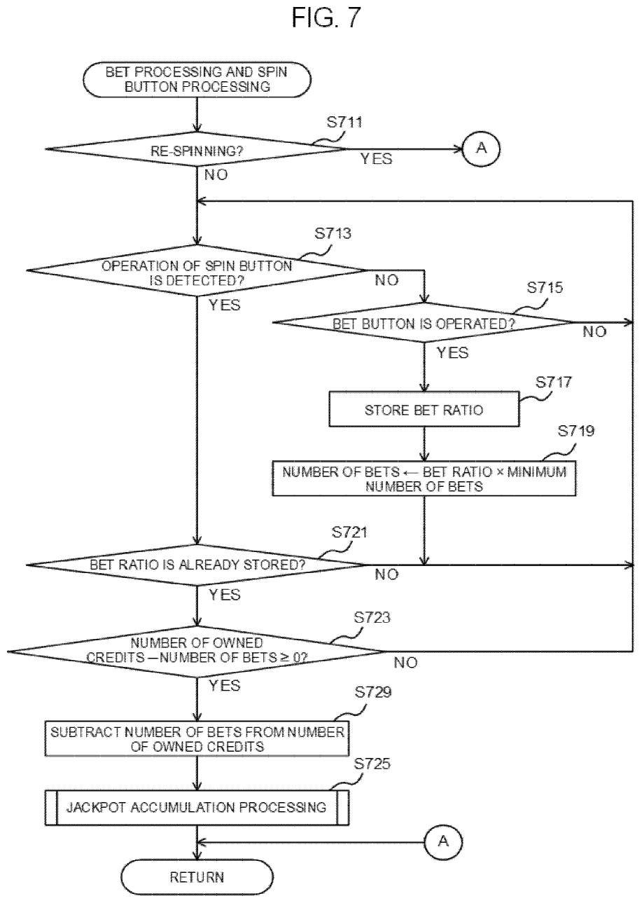

Subsequently, the CPU 110 of the controller 100 reads out and executes BET processing and SPIN button processing illustrated in FIG. 7 (step S615). In this processing, it is determined whether the BET button 320 and the SPIN button 330 are operated by the player. Processing of the number of credits owned by the player is executed.

Subsequently, the CPU 110 of the controller 100 selects a symbol table (step S617). The base game has eleven base game symbol tables. In the process in step S617, one base game symbol table among the eleven base game symbol tables is selected by lottery processing. The base game includes a numeric table (not illustrated). The base game symbol table is selected according to a numeric of the numeric table. FIG. 8 to FIG. 14 are tables illustrating examples of base game symbol tables.

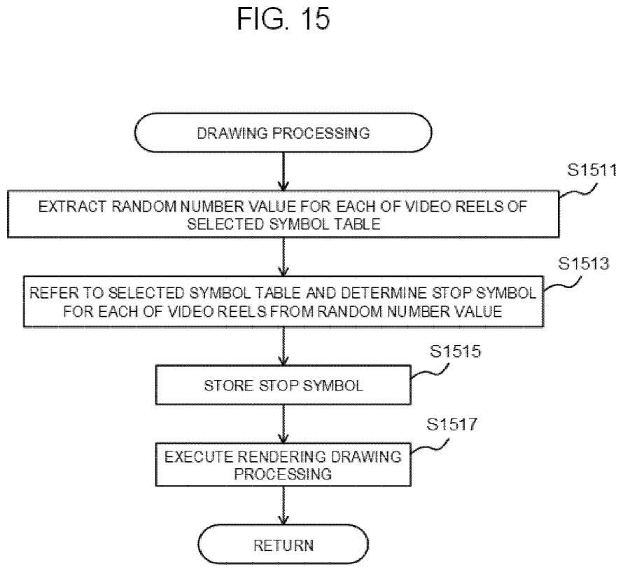

Subsequently, the CPU 110 of the controller 100 invokes and executes lottery processing illustrated in FIG. 15 (step S619). The lottery processing includes stop symbol lottery processing and rendering lottery processing. The stop symbol lottery processing determines a symbol to be stop-displayed in a predetermined position, for example, at the bottom of the symbol display region 400. Details of the lottery processing are explained in detail below.

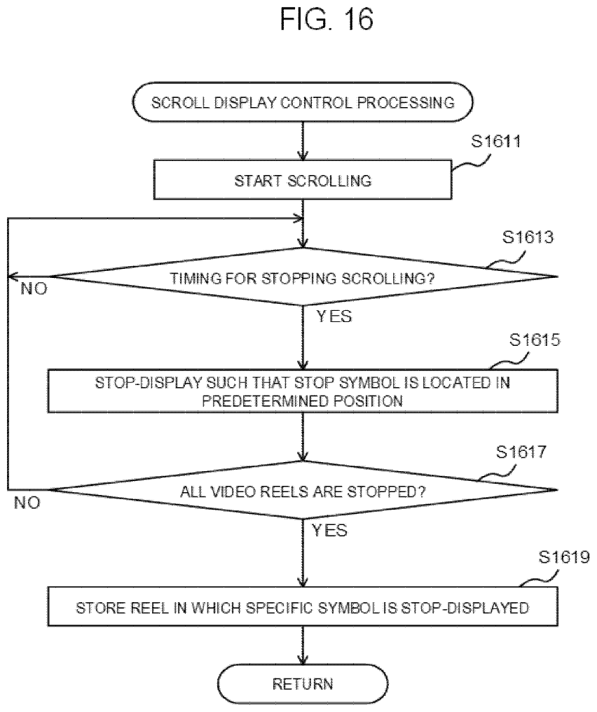

Subsequently, the CPU 110 of the controller 100 invokes and executes scroll display control processing illustrated in FIG. 16 (step S621). With this processing, the five video reels 410a to 410e are scrolled and thereafter stopped in the symbol display region 400 of the lower display 210. In this way, fifteen symbols in total are rearranged in a matrix shape of 3 rows and 5 columns. Details of the scroll display control processing are explained in detail below.

Subsequently, the CPU 110 of the controller 100 determines whether a bonus game transition condition is satisfied (step S623). The bonus game transition condition means that a winning combination of the symbol BONUS is established. Specifically, when three symbols BONUSes are stop-displayed in the symbol display region 400, the bonus game transition condition is satisfied.

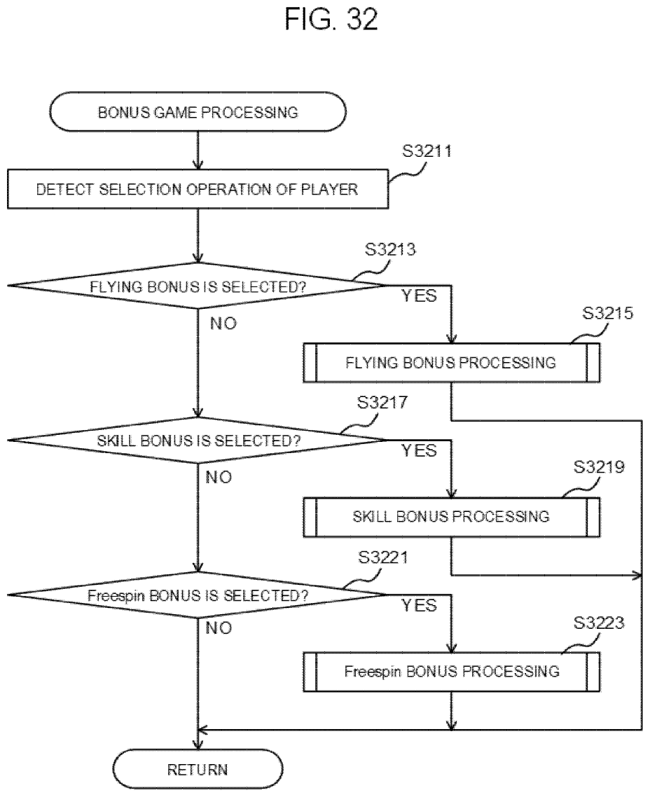

When determining in the determination processing in step S623 that the bonus game transition condition is satisfied (YES), the CPU 110 of the controller 100 executes bonus game processing of FIG. 32 explained below (step S625). In this way, it is possible to directly transition from the base game to the bonus game.

When determining in the determination processing in step S623 that the bonus game transition condition is not satisfied (NO) or when executing the bonus game processing in step S625, the CPU 110 of the controller 100 determines whether a transition roulette game transition condition is satisfied (step S627). The roulette game transition condition is that a symbol CLOCK is stop-displayed in the symbol display region 400.

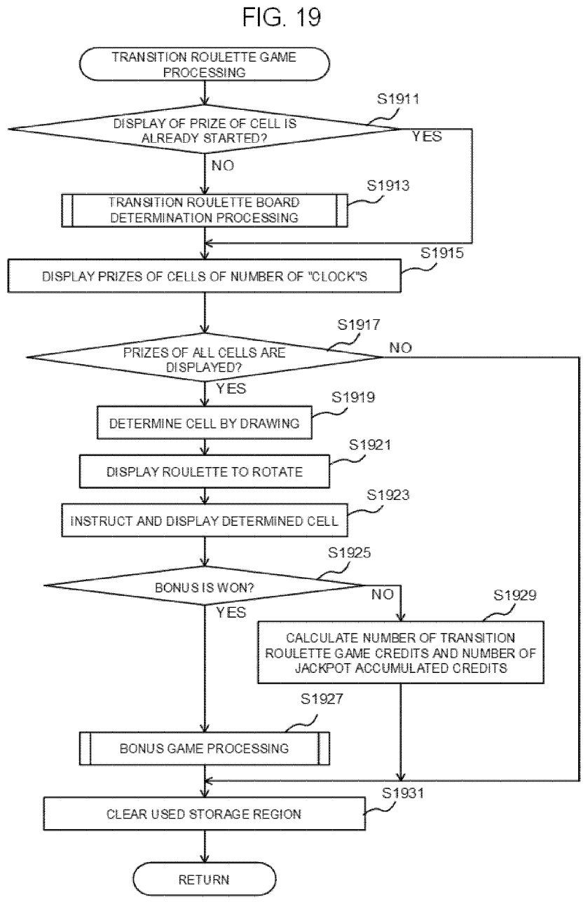

When determining in the determination processing in step S623 that the roulette game transition condition is satisfied (YES), the CPU 110 of the controller 100 executes a transition roulette game processing of FIG. 19 explained below (step S629).

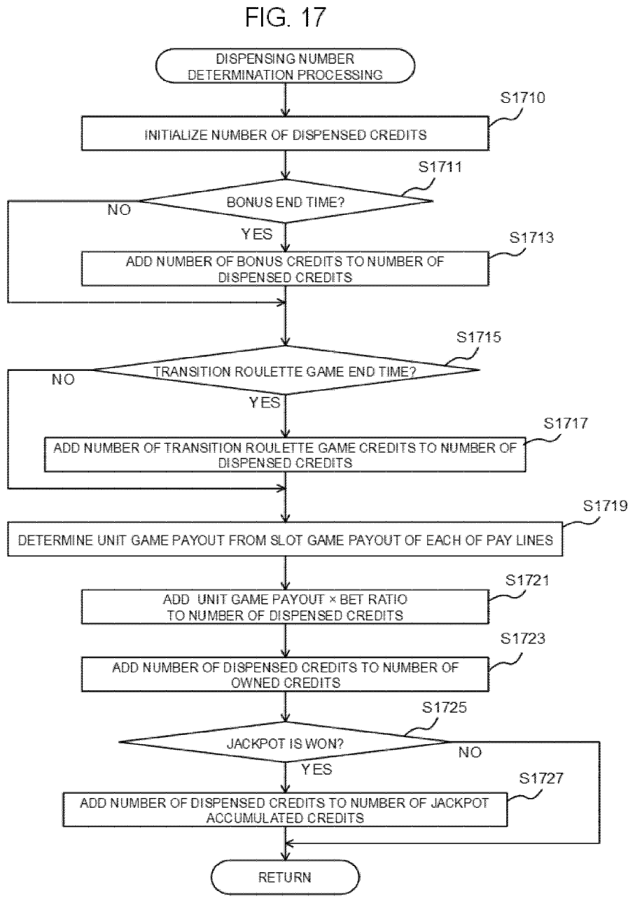

When determining in the determination processing in step S627 that the roulette game transition condition is not satisfied (NO) or executing the transition roulette game processing in step S629, the CPU 110 of the controller 100 invokes and executes dispensing number determination processing illustrated in FIG. 17 (step S631).

The CPU 110 determines a total payout for calculating and dispensing a sum of a base game payout (a slot game payout), a bonus payout, a JACKPOT payout, and the like. Details of the dispensing number determination processing are explained in detail below.

Subsequently, the CPU 110 of the controller 100 returns the processing to step S613. Accordingly, a new unit game of the base game is started.

### <<<Base Game Symbol Table>>>

FIG. 8 to FIG. 14 are tables illustrating examples of base game symbol tables. As explained above, the base game has the eleven base game symbol tables. FIG. 8 to FIG. 14 are a part of the eleven base game symbol tables. In FIG. 8 to FIG. 14, the video reel 410a is illustrated as “Reel 1”, the video reel 410b is illustrated as “Reel 2”, the video reel 410c is illustrated as “Reel 3”, the video reel 410d is illustrated as “Reel 4”, and the video reel 410e is illustrated as “Reel 5”.

As explained above, “WILD”, “PIC-A”, “PIC-B”, “PIC-C”, “PIC-D”, “A”, “K”, “Q”, “J”, “T”, “BONUS”, and “CLOCK” are arranged in the base game symbol tables.

### <<Continuous Arrangement of a Plurality of Symbols of the Same Type>>

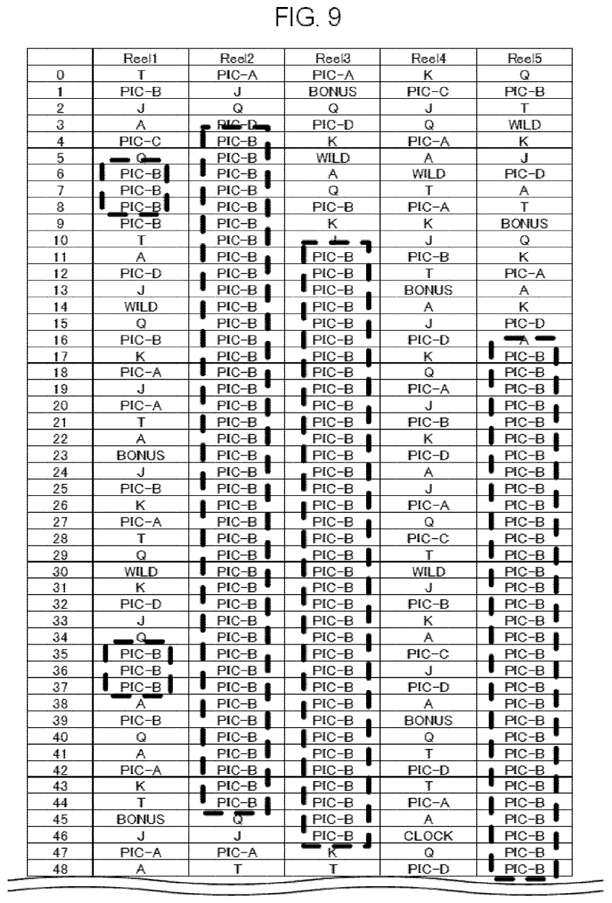

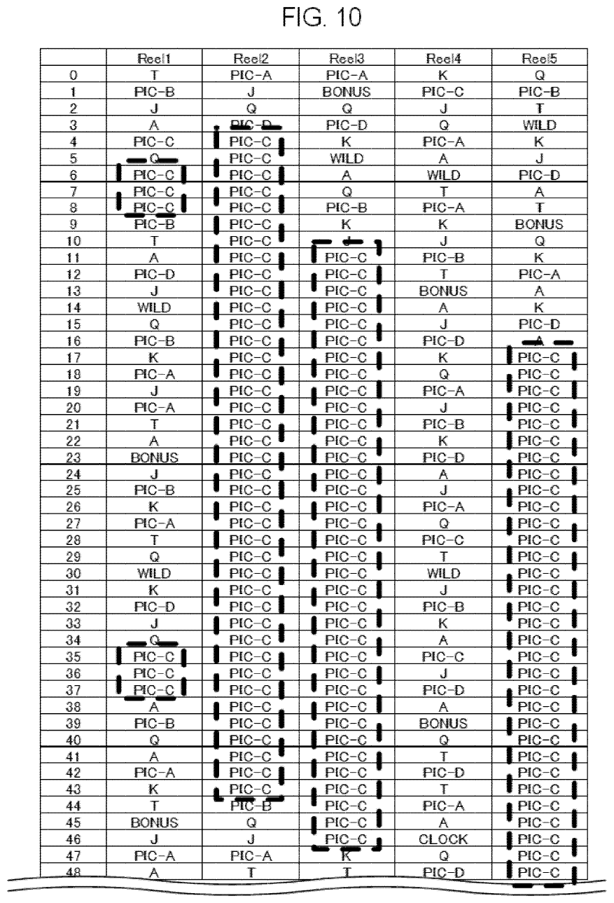

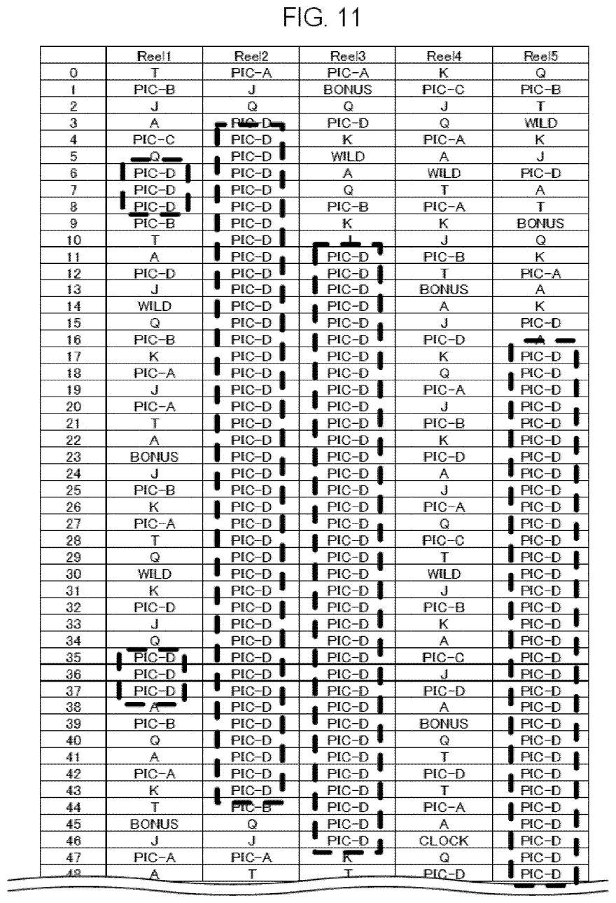

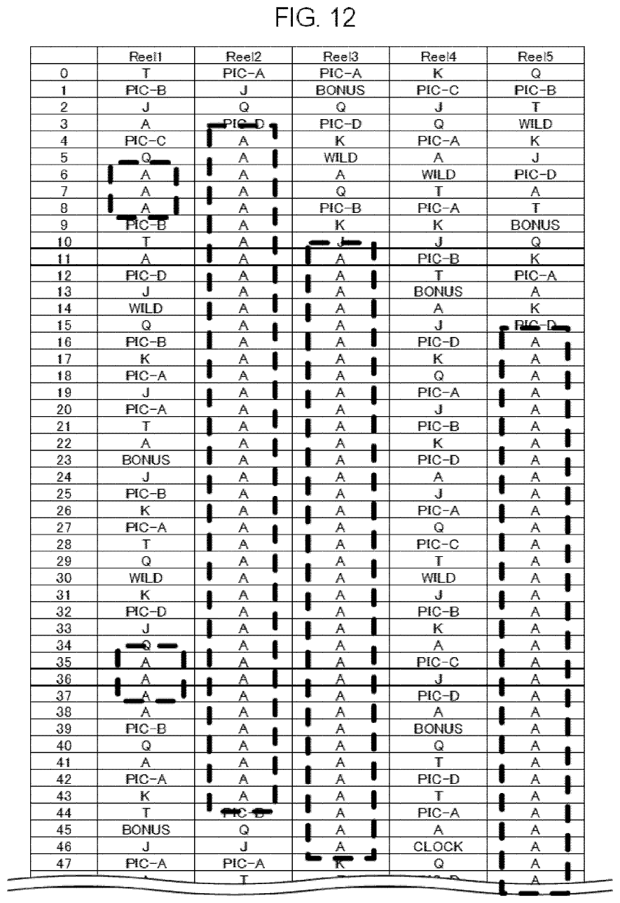

In the base game symbol table illustrated in FIG. 8, a plurality of “PIC-A”s are continuously arranged. In the base game symbol table illustrated in FIG. 9, a plurality of “PIC-B”s are continuously arranged. In the base game symbol table illustrated in FIG. 10, a plurality of “PIC-C”s are continuously arranged. In the base game symbol table illustrated in FIG. 11, a plurality of “PIC-D”s are continuously arranged. In the base game symbol table illustrated in FIG. 12, a plurality of “A”s are continuously arranged.

As illustrated in region surrounded by broken lines in FIG. 8 to FIG. 12, the symbols “PIC-A”, “PIC-B”, “PIC-D”, “A” different from one another are arranged in the same number in the same position of the same video reel. The symbols in regions not surrounded by the broken lines are arranged in common in different base game symbol tables.

For example, when the “PIC-A” is selected by the symbol lottery processing when the base game symbol table illustrated in FIG. 8 is selected, scrolling can be started by replacing, with the “PIC-A”, the head part where a plurality of “PIC-A”s are continuously arranged. By performing such processing, with the continuous display of the plurality of “PIC-A” s, it is possible to allow the “PIC-A” to be easily visually recognized by the player and inform the player that the “PIC-A” is selected by the symbol lottery processing. It is possible to increase the player's expectation that a winning combination of the “PIC-A” is established.

Similarly, when the base game symbol table illustrated in FIG. 9 is selected, it is possible to allow the “PIC-B” to be easily visually recognized. When the base game symbol table illustrated in FIG. 10 is selected, it is possible to allow the “PIC-C” to be easily visually recognized. When the base game symbol table illustrated in FIG. 11 is selected, it is possible to allow the “PIC-D” to be easily visually recognized. When the base game symbol table illustrated in FIG. 12 is selected, it is possible to allow the “A” to be easily visually recognized.

### <<Selection of Base Game Symbol Table and Symbol Replacement Processing>>

In the base game symbol tables illustrated in FIG. 8 to FIG. 12, symbols different from one another are replaced and arranged and stored in advance as base game symbol tables different from one another. That is, the symbols different from one another are replaced and arranged and stored as the base game symbol tables different from one another.

The selection of the base game symbol tables illustrated in FIG. 8 to FIG. 12 is the same as selecting and displaying any symbol of the continuously arranged “PIC-A”, the “PIC-B”, the “PIC-C”, the “PIC-D”, and the “A”. That is, when one base game symbol table is switched to another base game symbol table, a symbol can be displayed as if the symbol is switched from one symbol to another symbol and displayed.

As alternative processing, one base game symbol table may be prepared and a symbol in a predetermined region of a predetermined video reel may be replaced from one symbol with another symbol and stored and scrolled. In this case, since rewriting processing is required, the symbol cannot be immediately scrolled.

As described above, in the case of the configuration in which the plurality of base game symbol tables are prepared in advance, scrolling can be immediately executed only by switching the base game symbol tables.

### <<Continuous Arrangement of Symbols “CLOCK”>>

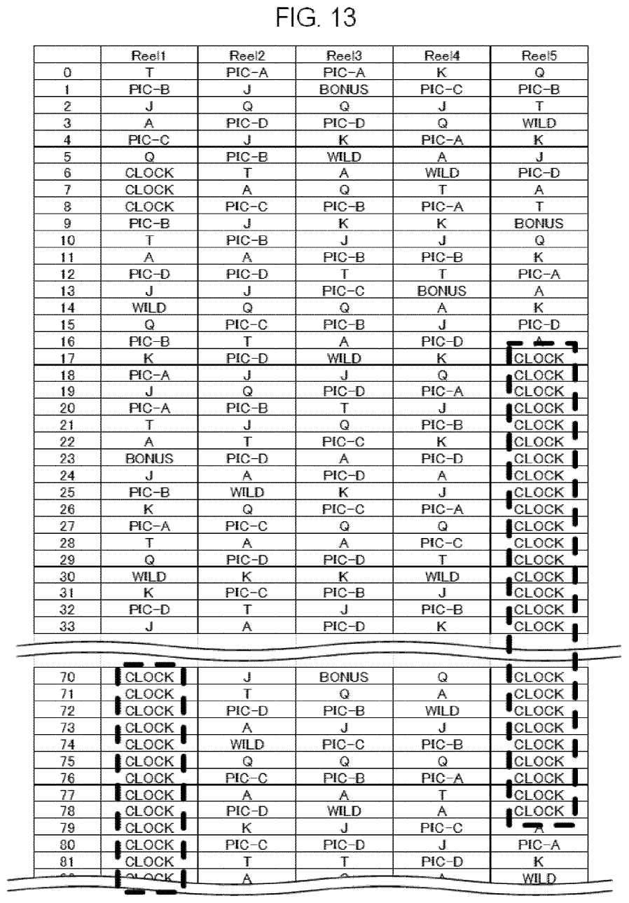

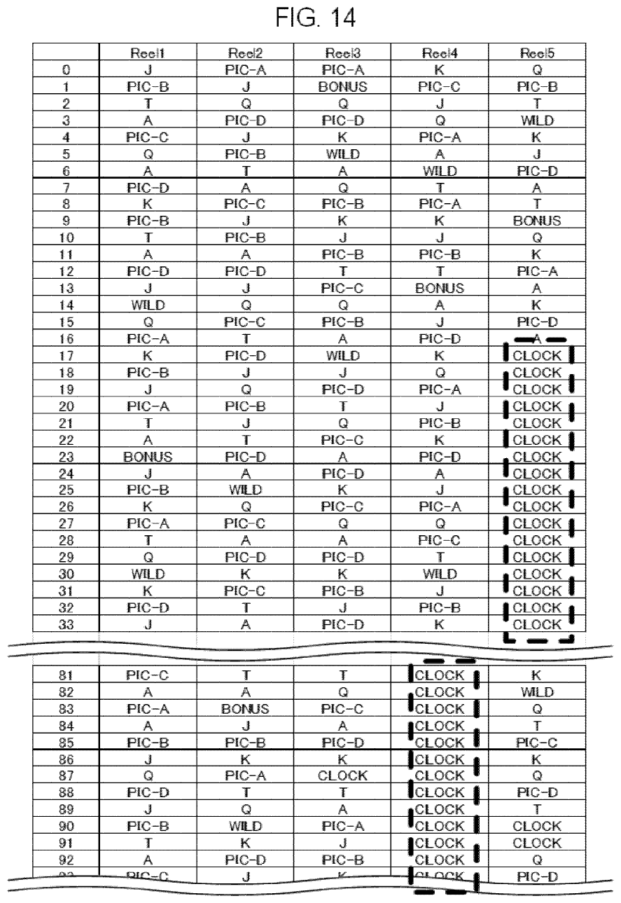

As illustrated in regions surrounded by broken lines in FIG. 13 to FIG. 14, a plurality of “CLOCK”s are continuously arranged in the base game symbol tables. In this case as well, when the “CLOCK” is selected by the symbol lottery processing, scrolling can be started by replacing the “CLOCK” with the head part where the plurality of “CLOCK”s are continuously arranged. By performing the processing in this way, by the continuous display of the plurality of “CLOCK”s, it is possible to allow the “CLOCK” to be easily visually recognized by the player and to inform the player that the “CLOCK” is selected by the symbol lottery processing. It is possible to increase the player's expectation that the “CLOCK” is stop-displayed. Further, in this case, it is also possible to increase the expectation that a prize of a cell of a roulette game can be known.

### <<<BET Processing and SPIN Button Processing>>>

FIG. 7 is a flowchart illustrating the BET processing and the SPIN button processing. This processing is invoked and executed in step S615 in FIG. 6.

The BET processing and the SPIN button processing are processing common not only to the base game but also to the FLYING BONUS and the SKILL BONUS.

First, the CPU 110 of the controller 100 determines whether to perform re-spinning (step S711). In the present embodiment, for example, re-spinning is sometimes performed by the FLYING BONUS.

When determining in the determination processing in step S711 that the re-spinning is performed (YES), the CPU 110 of the controller 100 immediately ends this subroutine. When performing the re-spinning, it is not necessary to operate the BET button 320 or the SPIN button 330. The CPU 110 immediately ends the subroutine.

When determining in the determination processing in step S711 that the re-spinning is not performed (NO), the CPU 110 of the controller 100 determines whether the SPIN button 330 is operated (step S713).

When determining in the determination processing in step S713 that the SPIN button 330 is not operated (NO), the CPU 110 of the controller 100 determines whether the BET button 320 is operated (step S715).

When determining in the determination processing in step S715 that the BET button 320 is not operate (NO), the CPU 110 of the controller 100 returns the processing to step S713.

When determining in the determination processing in step S715 that the BET button 320 is operated (YES), the CPU 110 of the controller 100 stores a BET ratio corresponding to the operated BET button 320 (step S717), multiplies a minimum number of BETs by the BET ratio to determine the number of BETs (step S719), and returns the processing to step S713.

The minimum number of BETs can be set a desired number such as 50 credits or 100 credits. When the minimum number of BETs is 50 credits and the BET pattern A explained above is selected, for example, the BET ratio is 2 when the player operates the BET button 320b. In this case, the number of BETs is 100 by multiplying the minimum number of BETs of 50 by the BET ratio of 2.

When determining in the determination processing in step S713 that the SPIN button 330 is operated (YES), the CPU 110 of the controller 100 determines whether the BET ratio is stored (step S721).

When determining in the determination processing in step S721 that the BET ratio is not stored (NO), the CPU 110 of the controller 100 shifts the processing to step S713.

When determining in the determination processing in step S721 that the BET ratio is stored (YES), the CPU 110 of the controller 100 determines whether a value obtained by subtracting the number of BETs from the number of credits owned by the player is 0 or more (step S723).

When determining in the determination processing in step S723 that the value obtained by subtracting the number of BETs from the number of credits owned by the player is less than 0 (NO), the CPU 110 of the controller 100 returns the processing to step S713.

When determining in the determination processing in step S723 that the value obtained by subtracting the number of BETs from the number of credits owned by the player is 0 or more (YES), the CPU 110 of the controller 100 subtracts the number of BETs from the number of credits owned by the player (step S725).

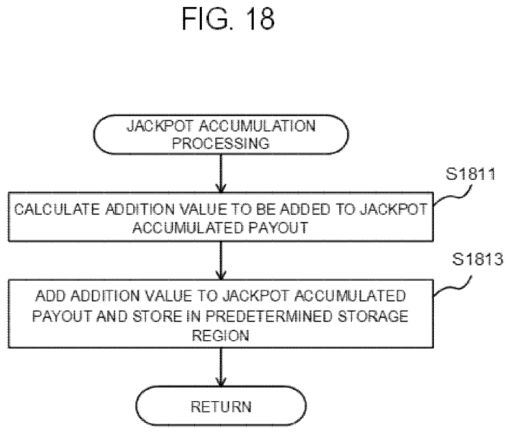

Subsequently, the CPU 110 of the controller 100 invokes and executes jack pot accumulation processing illustrated in FIG. 18 (step S727) and ends this subroutine.

By executing this subroutine, the unit game of the video slot game of the base game or the bonus game can be started.

### <<<Lottery Processing>>>

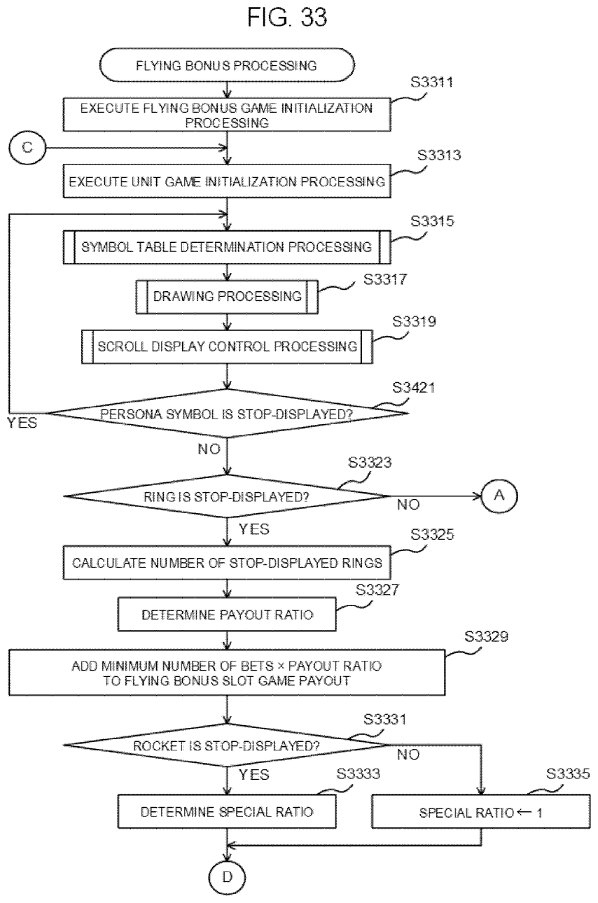

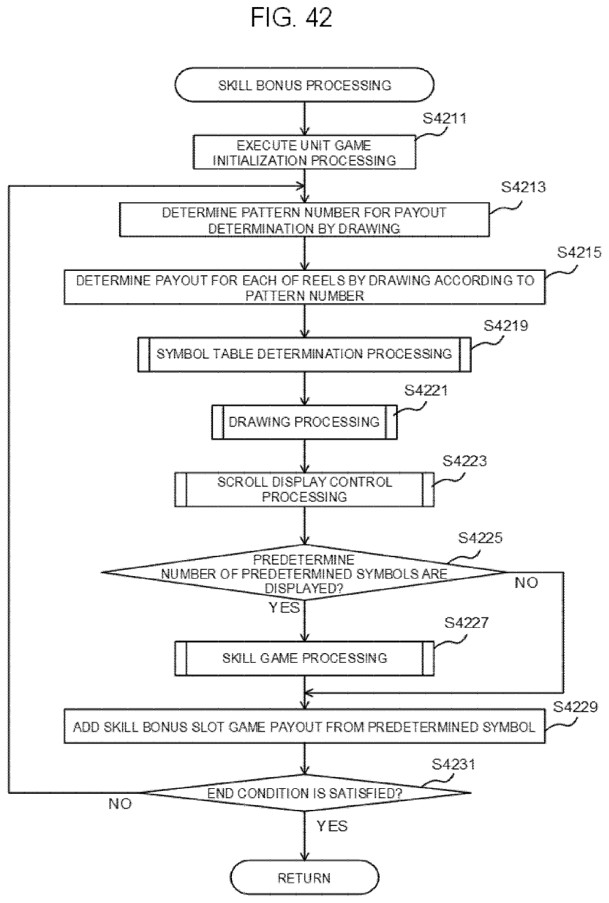

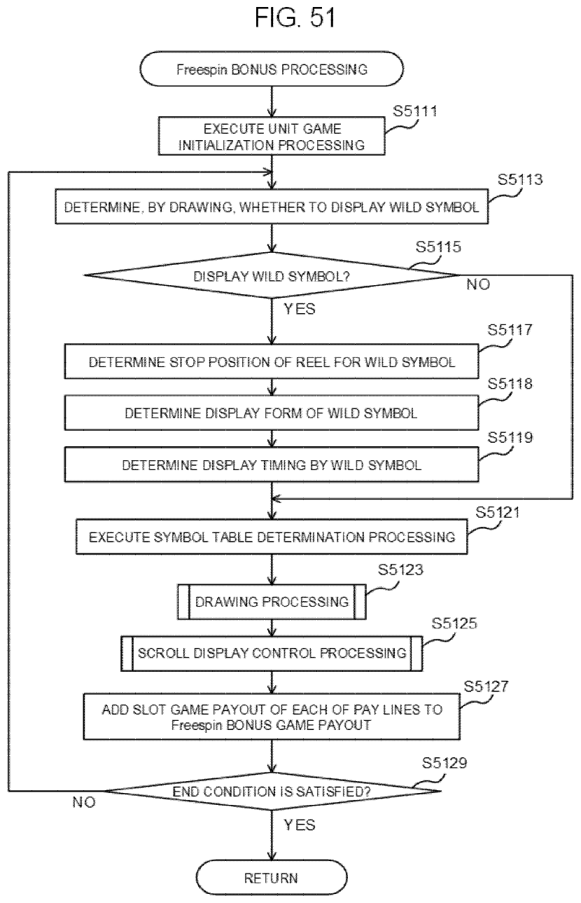

FIG. 15 is a flowchart illustrating the lottery processing. This processing is invoked and executed in step S619 in FIG. 6, step S3317 in FIG. 33, step S4221 in FIG. 42, and step S5123 in FIG. 51.

First, the CPU 110 of the controller 100 extracts a random number value for each of video reels according to the symbol table selected in the symbol table selection processing in step S617 in FIG. 6, step S3315 in FIG. 33, step S4219 in FIG. 42, or step S5121 in FIG. 51 (step S1511). The random number value is extracted from a range corresponding to the number of symbols defined in the symbol table. When re-spinning is performed, the lottery processing is executed for a reel to be re-spun.

Subsequently, the CPU 110 of the controller 100 refers to the symbol table selected in the symbol table selection processing in step S617 in FIG. 6 and determines a stop symbol for each of the video reels from the random number value (step S1513). The scrolling of the video reel is stopped such that the symbol determined in this processing is stop-displayed in a predetermined position, for example, the bottom of the symbol display region 400. By determining the symbol to be stop-displayed in the bottom, it is possible to determine a symbol to be stop-displayed (a symbol to be rearranged) in each of stop positions in 3 rows and 5 columns in the symbol display region 400.

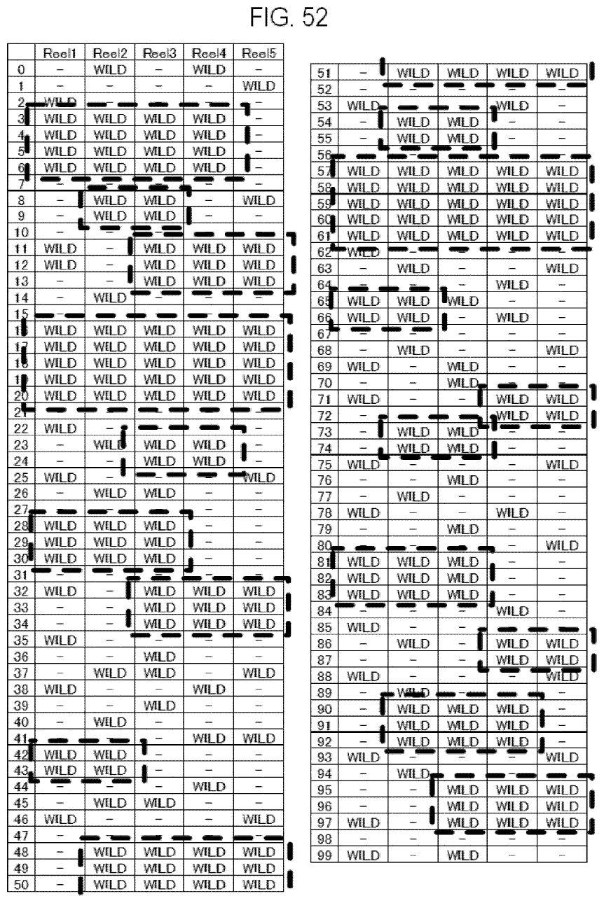

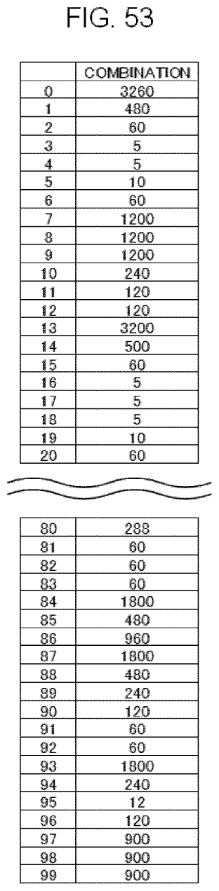

In the case of the Freespin BONUS slot game, in step S1511, the CPU 110 of the controller 100 executes lottery of a normal symbol and lottery of the WILD. The lottery of the WILD is processing for determining one of numbers illustrated on the left column in FIG. 52. Lottery processing for the WILD is determined according to a numeric of a numeric table for WILD lottery illustrated in FIG. 53.

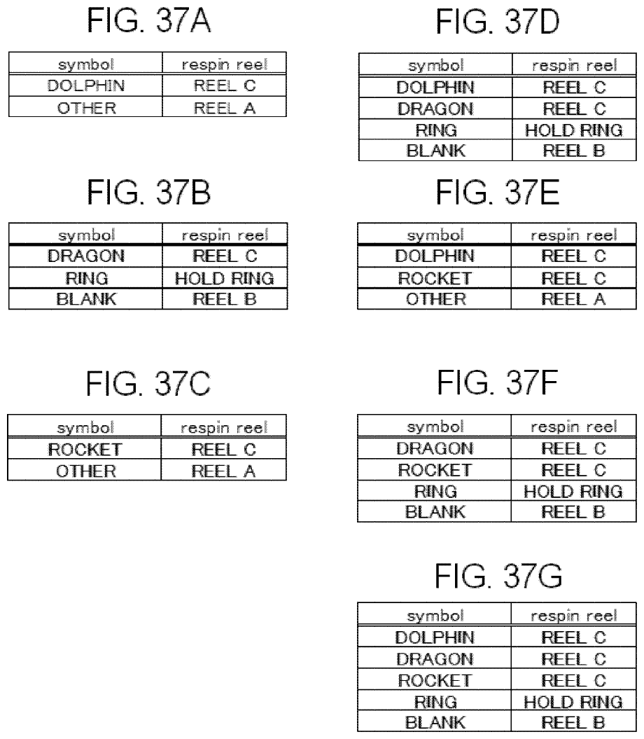

In the case of the FLYING BONUS slot game, the CPU 110 of the controller 100 determines a stop symbol by lottery a random number value for each of stop positions of 3 rows and 5 columns or 4 rows and 5 columns using the video reels (REEL A to REEL F illustrated in FIG. 38) allocated to the stop positions (cells) of 3 rows and 5 columns or 4 rows and 5 columns according to allocation rules 1 to 7 (see FIGS. 37A to 37G) or the like.

In the case of the SKILL BONUS slot game, the CPU 110 of the controller 100 determines a stop symbol using the video reel illustrated in FIGS. 46A and 46B.

Subsequently, the CPU 110 of the controller 100 stores the symbol determined in the processing in step S1513 in the RANI 130 of the controller 100 (step S1515). By storing the symbol determined in the processing in step S1513 in the RAM 130, the symbol can be used for control of stop display of the symbol and calculation of a payout.

Note that, when re-spinning is performed, the symbol lottery processing is executed for only a video reel to be re-spun among the video reels with reference to the re-spinning symbol table.

Subsequently, the CPU 110 of the controller 100 executes the rendering lottery processing (step S1517) and ends this subroutine. The rendering lottery processing is determined according to a result of the stop symbol lottery processing in step S1513. According to a lottery result, rendering for enhancing and uplifting expectation can be executed by the lower display 210, the upper display 220, the speaker 230, or the like.

### <<<Scroll Display Control Processing>>>

FIG. 16 is a flowchart illustrating the scroll display control processing. This process is invoked and executed in step S621 in FIG. 6, step S3319 in FIG. 33, step S4223 in FIG. 42, and step S5125 in FIG. 51. The scroll display control processing illustrated in FIG. 16 is executed in common in both the video slot games of the base game and the bonus game.

First, the CPU 110 of the controller 100 starts scrolling a video reel in the symbol display region 400 (step S1611).

In the processing of step S1611, the CPU 110 of the controller 100 determines a position where scrolling of the video reel 410 is started and starts the scrolling.

In normal scrolling, the scrolling of the video reel 410 is started from, for example, a symbol in a position with a symbol number “0” or a symbol stop-displayed in the symbol display region 400 according to arrangement of symbols decided in a symbol table. As opposed to such normal scrolling, for example, when the “PIC-A” is selected by the symbol lottery processing when the base game symbol table illustrated in FIG. 8 is selected, scrolling is started from the head portion where a plurality of “PIC-A”s are continuously arranged. The plurality of “PIC-A”s are continuously displayed. It is possible to allow the “PIC-A” to be easily visually recognized by the player and to inform the player that the “PIC-A” is selected by the symbol lottery processing. Note that, at that time, it is also conceivable to inform the player by outputting special sound or displaying an image.

Subsequently, the CPU 110 of the controller 100 determines whether it is timing to stop scrolling of any of the video reels (step S1613).

When determining in the determination processing in step S1613 that it is not the timing to stop the scrolling (NO), the CPU 110 of the controller 100 returns the processing to step S1613.

When determining in the determination processing in step S1613 that it is the timing to stop the scrolling (YES), the CPU 110 of the controller 100 stops the video reel such that the symbol determined by the stop symbol lottery processing of FIG. 15 is displayed at the predetermined stop position of the symbol display region 400 (step S1615).

In scrolling of the base game, the SKILL BONUS slot game, and the Freespin BONUS slot game, the predetermined stop position is at the bottom. In the scrolling of the FLYING BONUS slot game, the predetermined stop position is each of stop positions in 3 rows and 5 columns or 4 rows and 5 columns.

In the case of a Freespin BONUS slot game, a normal symbol and a WILD are superimposed and stop-displayed.

Subsequently, the CPU 110 of controller 100 determines whether all the video reels are stopped (step S1617).

When determining that not all the video reels are stopped (NO), the CPU 110 of the controller 100 returns the processing to step S1613.

When determining that all the video reels are stopped (YES) and a specific symbol is stop-displayed, the CPU 110 of the controller 100 stores a video reel of the specific symbol (step S1619) and ends this subroutine.

By the processing in steps S1611 to S1619 explained above, the arrangement of fifteen symbols is temporarily released and thereafter rearranged in the symbol display region 400. By the rearrangement, the fifteen symbols are stop-displayed in a matrix shape of 3 rows and 5 columns.

In the case of the FLYING BONUS slot game, twenty symbols are sometimes stop-displayed in a matrix shape of 4 rows and 5 columns.

Note that, when the SPIN button 330 or the like is operated during the scrolling, the processing can be skipped to immediately stop all the video reels and stop-display all stop symbols.

### <<<Dispensing Number Determination Processing>>>

FIG. 17 is a flowchart illustrating dispensing number determination processing. This processing is invoked and executed in step S631 of the lottery processing in FIG. 6.

First, the CPU 110 of the controller 100 initializes the number of dispensed credits (step S1710)

Subsequently, the CPU 110 of the controller 100 determines whether it is a bonus end time (step S1711). Bonuses are FLYING BONUS, SKILL BONUS, and Freespin BONUS. The processing in step S1711 is processing for determining whether it is an end time of these bonuses.

When determining in the determination processing in step S1711 that it is the bonus end time (YES), the CPU 110 of the controller 100 adds the number of bonus credits to the number of dispensed credits (step S1713). The number of bonus credits is calculated from bonus payouts granted during execution of the FLYING BONUS, the SKILL BONUS, the Freespin BONUS.

When determining in the determination processing in step S1711 that it is not the bonus end time (NO) or executing the processing in step S1713, the CPU 110 of the controller 100 determines whether it is a transition roulette game end time (step S1715).

When determining in the determination step in step S1715 that it is the transition roulette game end time, the CPU 110 of the controller 100 adds the number of transition roulette game credits to the number of dispensed credits (step S1717). The number of transition roulette game credits is calculated from a transition roulette game payout granted during the transition roulette game.

When determining in the determination processing in step S1715 that it is not the transition roulette game end time (NO) or executing the processing in step S1717, the CPU 110 of the controller 100 determines a unit game payout from a slot game payout of each of pay lines (step S1719).

Subsequently, the CPU 110 of the controller 100 adds a value obtained by multiplying the unit game payout by a BET ratio to the number of dispensed credits (step S1721).

Subsequently, the CPU 110 of the controller 100 adds the number of dispensed credits to the number of owned credits (step S1723). The number of owned credits is the number of credits owned by the player at that point in time and is the number of credits stored in the RAM 130.

Subsequently, the CPU 110 of the controller 100 determines whether JACKPOT is won (step S1725)

When determining in the determination processing in step S1725 that JACKPOT is won (YES), the CPU 110 of the controller 100 dispenses the number of JACKPOT accumulated credits (step S1727) and ends this subroutine. The number of JACKPOT accumulated credits is a number obtained by multiplying a JACKPOT accumulation payout explained below by a BET ratio of the base game.

When determining in the determination processing in step S1725 that the JACKPOT is not won (NO), the CPU 110 of the controller 100 immediately ends this subroutine.

### <<<JACKPOT Accumulation Processing>>>

FIG. 18 is a flowchart illustrating the JACKPOT accumulation processing. This processing is invoked and executed in step S725 of the BET process and the SPIN button processing illustrated in FIG. 7. In the gaming machine 10 in the present embodiment, JACKPOT is won in the transition roulette game.

First, the CPU 110 of the controller 100 calculates an addition value to be added to the JACKPOT accumulation payout (step S1811).

Subsequently, the CPU 110 of the controller 100 adds the addition value to the JACKPOT accumulation payout and stores in a predetermined storage region (step S1813) and ends this subroutine. The number of JACKPOT accumulated credits explained above is a number obtained by multiplying the JACKPOT accumulation payout stored in step S1813 by the BET ratio of the base game.

### <<<Transition Roulette Game Processing>>>

The transition roulette game is a game for determining a transition to BONUS, a transition roulette game payout, and a JACKPOT payout.

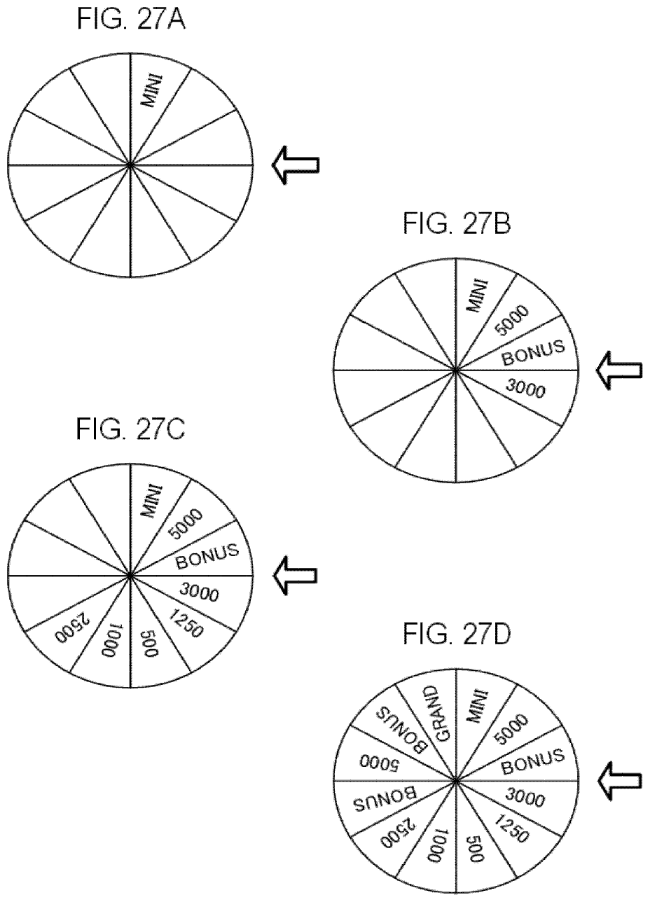

The transition roulette game uses the board surface of the transition roulette game. The board surface of the transition roulette game includes twelve cells (see FIG. 27A to FIG. 29C).

First, the CPU 110 of the controller 100 determines whether display of content of a prize of a cell is already started (step S1911). The prize of the cell is a prize allocated to the cell.

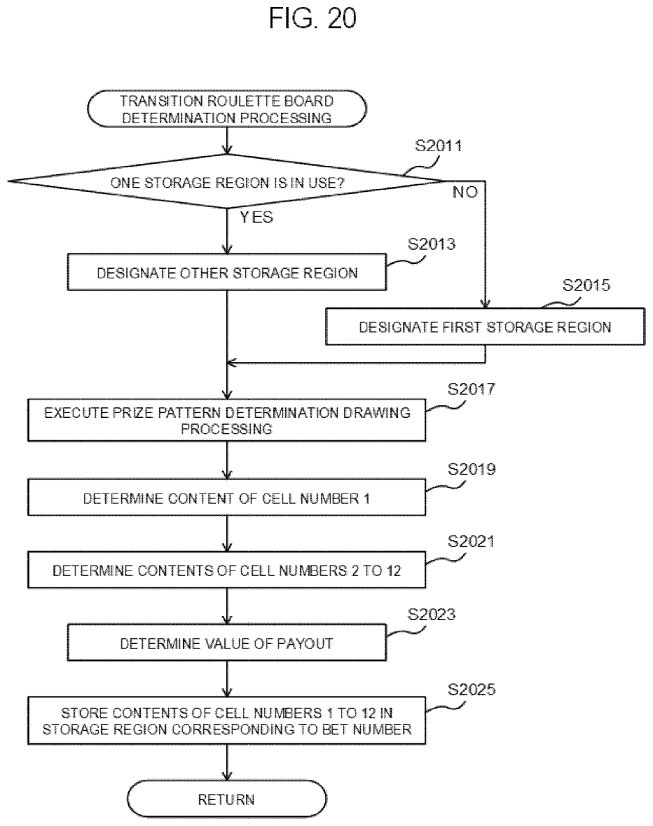

When determining in the determination processing in step S1911 that the display of the content of the prize of the cell is not started yet (NO), the CPU 110 of the controller 100 executes transition roulette board determination processing illustrated in FIG. 20 explained below (step S1913).

When determining in the determination processing in step S1911 that the display of the content of the prize of the cell is already started (YES) or executing the processing in step S1913, the CPU 110 of the controller 100 changes prizes of cells as many as the number of “CLOCK”s stop-displayed in the base game from un-displayed to displayed (step S1915).

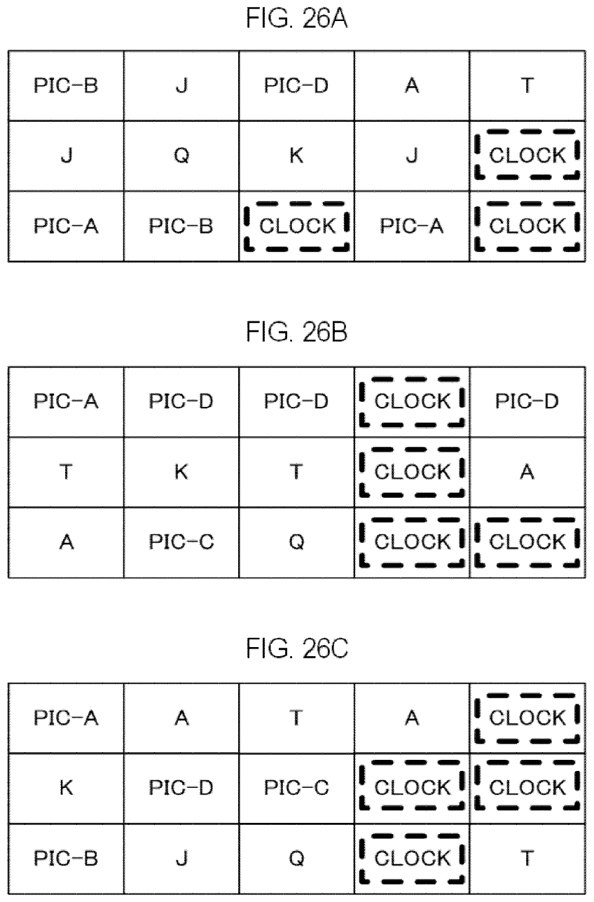

For example, when the number of stop-displayed “CLOCK”s is three, the CPU 110 of the controller 100 displays prizes of three cells among the un-displayed cells on the board surface of the transition roulette game (see FIG. 26A, FIG. 27A, and FIG. 27B).

Subsequently, the CPU 110 of the controller 100 determines whether the prizes of all of the twelve cells on the board surface of the transition roulette game are displayed (step S1917).

Subsequently, the CPU 110 of the controller 100 determines one cell among the twelve cells with lottery processing (step S1919).

### <Numeric Table for Prize Determination>

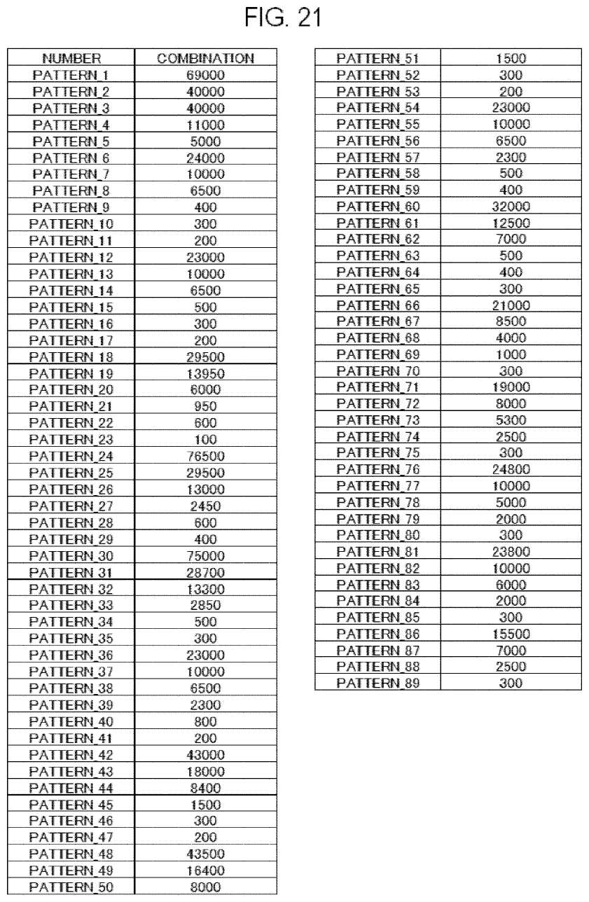

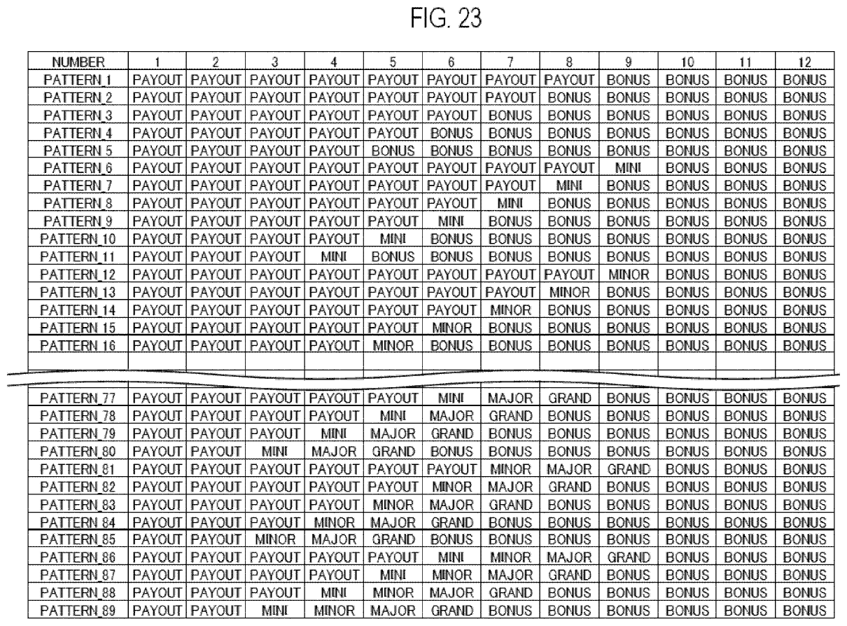

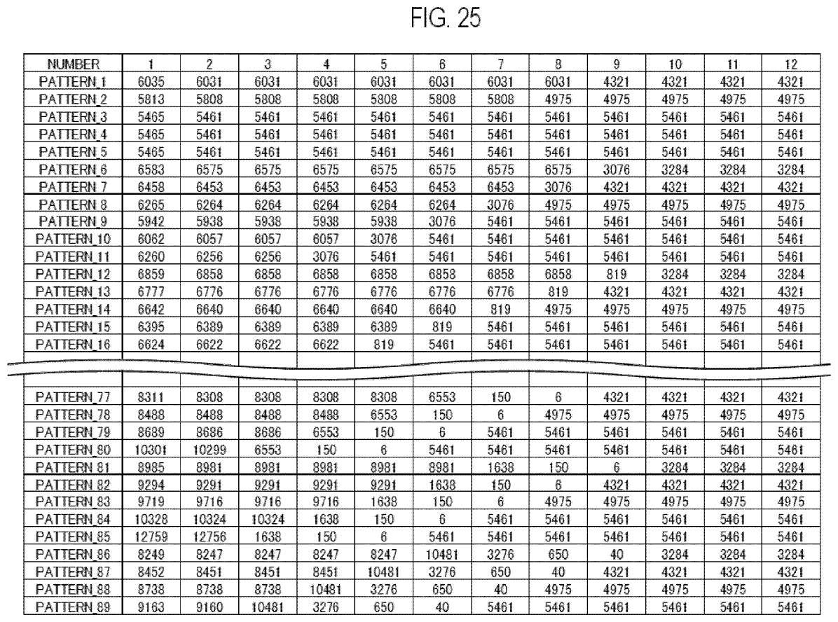

FIG. 25 is a numeric table for prize determination for determining one cell among the twelve cells with the lottery processing in the processing in step S1919. A numeric is decided for each of eighty-nine prize patterns. Through transition roulette board determination processing illustrated in FIG. 20 explained below, one of the eighty-nine prize patterns is selected (FIG. 21) and a combination of twelve prizes is determined from the selected one prize pattern (FIG. 23).

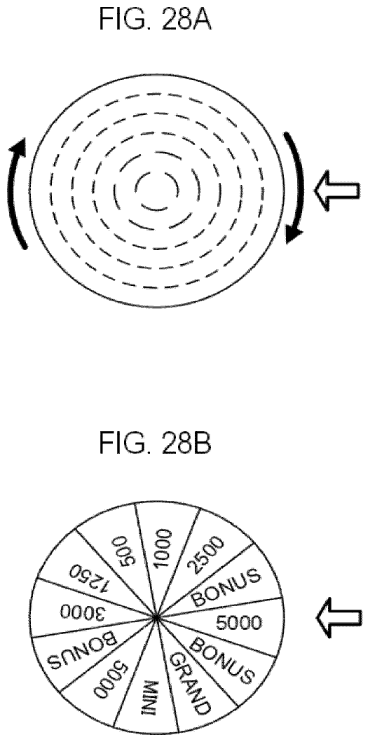

Subsequently, the CPU 110 of the controller 100 displays the board surface of the transition roulette game to rotate (step S1921) (see FIG. 28A).

Subsequently, the CPU 110 of the controller 100 stop-displays the board surface of the transition roulette game and displays to show one cell determined in step S1919 (step S1923) (see FIG. 28B).

Subsequently, the CPU 110 of the controller 100 determines whether the prize allocated to the one cell determined in step S1919 is a transition of a bonus (step S1925).

Subsequently, when determining that the prize allocated to the one cell determined in step S1919 is the transition of the bonus (YES), the CPU 110 of the controller 100 executes bonus game processing illustrated in FIG. 32 explained below (step S1927). In this way, the base game can be transitioned to the bonus game via the transition roulette game.

Subsequently, when determining that the prize allocated to the one cell determined in step S1919 is not the transition of the bonus (NO), the CPU 110 of the controller 100 determines the number of transition roulette game credits by multiplying the transition roulette game payout by the BET ratio of the base game and determines the number of JACKPOT accumulated credits by multiplying the JACKPOT payout by the BET ratio of the base game (step S1929)

Subsequently, the CPU 110 of the controller 100 executes the processing in step S1927 and step S1929, thereafter, clears the storage region used to store the content of the cell (step S1931), and ends this subroutine.

### <<Transition Roulette Board Determination Processing>>

FIG. 20 is a flowchart illustrating the transition roulette board determination processing invoked in step S1913.

First, the CPU 110 of the controller 100 determines whether one storage region for storing twelve prizes is in use (step S2011). As explained below, the storage region for storing twelve prizes includes a first storage region and a second storage region.

### <Prize Storage Region>

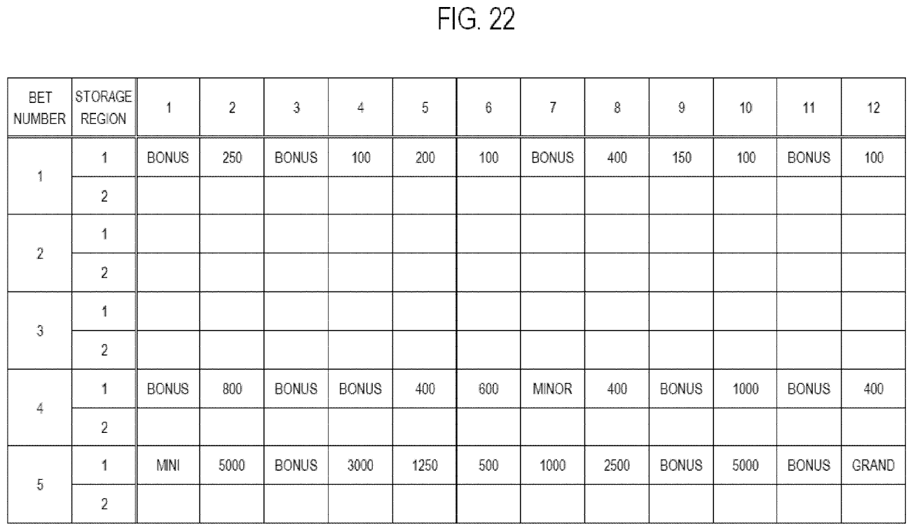

The prize storage region stores a prize allocated to each of the twelve cells configuring the board surface of the transition roulette game. The prize storage region includes a first storage region and a second storage region for each of five BET numbers (see FIG. 22).

As explained above, the BET selection number allocated to the BET button 320a is stored in the BET number 1. In the BET number 2, a BET selection number allocated to the BET button 320b is stored. In the BET number 3, a BET selection number allocated to the BET button 320c is stored. In the BET number 4, a BET selection number allocated to the BET button 320d is stored. In the BET number 5, a BET selection number allocated to the BET button 320e is stored.

A prize storage region to be used is determined by the BET button operated when the base game is started. For example, when the BET button 320c is operated to start the base game, the twelve prizes stored in the first storage region or the second storage region of the BET number 3 corresponding to the BET button 320c are displayed on the board surface of the transition roulette game.

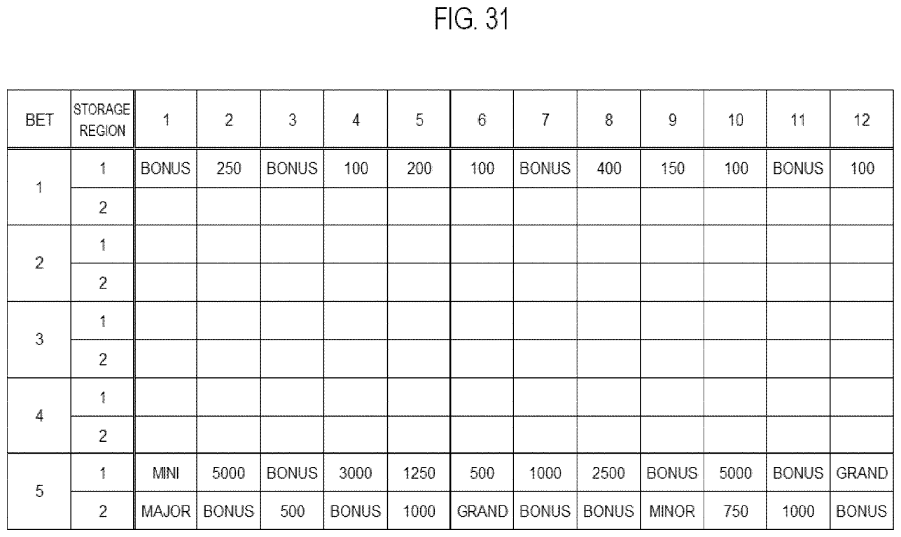

The first storage region of the prize storage region is a main storage region and the second storage region is a sub-storage region. When the number of “CLOCK”s is not carried over, a prize is stored in the first storage region and displayed in a cell. When the number of “CLOCK”s is carried over, a prize is stored in the second storage region and displayed in a cell (FIG. 31). The one storage region in step S2011 is one of the first storage region and the second storage region.

When determining in the determination processing in step S2011 that one storage region is in use (YES), the CPU 110 of the controller 100 designates the other storage region (step S2013). When determining that one storage region is not in use (NO), the CPU 110 of the controller 100 designates the first storage region (step S2015).

Subsequently, the CPU 110 of the controller 100 determines one prize pattern from the eighty-nine prize patterns with the lottery processing (step S2017).

### <Numeric Table for Prize Pattern Determination>

FIG. 21 is a numeric table for prize pattern determination for determining one prize pattern from the eighty-nine prize patterns with the lottery processing. One prize pattern is determined by the processing in step S2017.

### <Prize Pattern Table>

FIG. 23 is a prize pattern table that stores twelve prizes decided for each of the eighty-nine prize patterns. For example, in PATTERN_2, seven payouts and five BONUSes are decided. In PATTERN_9, five payouts, one MINI (jackpot), and six BONUSes are decided. These twelve prizes are allocated to each of the twelve cells configuring the board surface of the transition roulette game. Note that a specific value of a payout is determined in later processing.

Subsequently, the CPU 110 of the controller 100 determines, as a prize allocated to a cell number 1, with the lottery processing, any one of the jack pot excluding the payout or the BONUS from the prizes decided in the determined prize pattern (step S2019).

The prize of the cell number 1 is always displayed on the board surface of the transition roulette game from the execution time of the base game (FIG. 27A). By displaying the jackpot or the BONUS on the board surface of the transition roulette game in advance, it is possible to increase the expectation in the transition roulette game.

Subsequently, the CPU 110 of the controller 100 determines, with the lottery processing, prizes to be allocated to the remaining eleven cells with the cell numbers 2 to 12 from the prize decided in the determined prize pattern (step S2021). Positions of the cell numbers 1 to 12 are determined in order clockwise from the cell number 1 (see FIGS. 27A to 27D).

Next, the CPU 110 of the controller 100 determines a specific value of PAYOUT decided in the determined prize pattern (step S2023).

### <Numeric Table for PAYOUT Ratio Determination>

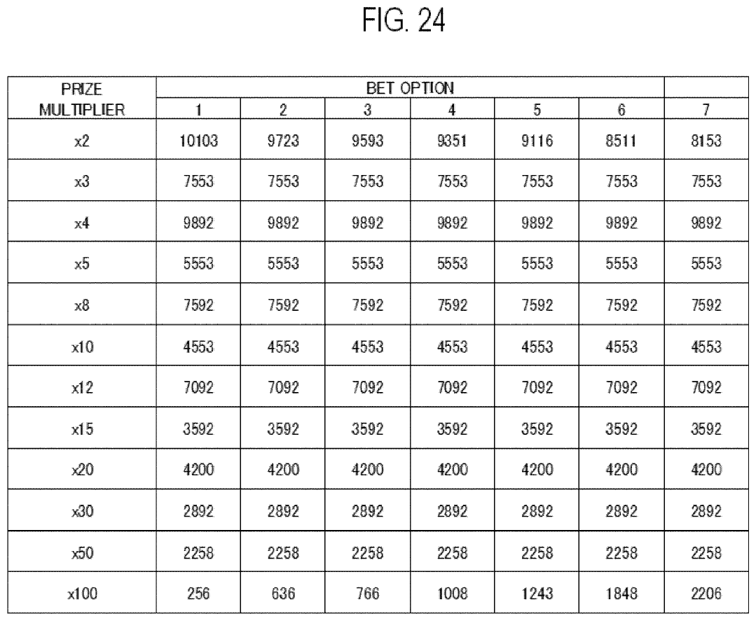

FIG. 24 is a numeric table for PAYOUT ratio determination in which a determination rate for a ratio for determining PAYOUT is decided for each of BET selection numbers. The PAYOUT can be determined by multiplying the number of BETs at the start of the base game by a PAYOUT ratio. Since the determination rate for the ratio is decided for each of the BET selection numbers, PAYOUT corresponding to the number of BETs of the base game can be determined. Accordingly, it is possible to prevent an excessive profit or an excessively small profit.

Subsequently, the CPU 110 of the controller 100 stores contents of the prizes allocated to the cell numbers 1 to 12 in a storage region corresponding to the BET number (step S2025), and ends this subroutine. The CPU 110 of the controller 100 stores contents of prizes allocated to all the cell numbers 1 to 12 in a storage region of a BET number corresponding to a BET button at the start of the base game.

For example, as illustrated in FIG. 22, BONUS, 250, BONUS, 100, 200, 100, BONUS, 400, 150, 100, BONUS, and 100 are stored in a storage region 1 with the BET number 1. In the storage region 1 with the BET number 4, BONUS, 800, BONUS, BONUS, 400, 600, MINOR, 400, BONUS, 1000, BONUS, and 400 are stored. In the storage region 1 with the BET number 5, MINI, 5000, BONUS, 3000, 1250, 500, 1000, 2500, BONUS, 5000, BONUS, and GRAND are stored.

Specifically, MINI of a jack pot is allocated to a cell number 1 of the storage region 1 with the BET number 5, 5000 is allocated to a cell number 2, BONUS is allocated to a cell number 3, 3000 is allocated to a cell number 4, 1250 is allocated to a cell number 5, 500 is allocated to a cell number 6, 1000 is allocated to a cell number 7, 2500 is allocated to a cell number 8, BONUS is allocated to a cell number 9, 5000 is allocated to a cell number 10, BONUS is allocated to a cell number 11, and GRAND is allocated to a cell number 12.

As explained above, the prize storage region to be used is determined by the BET button operated when the base game is started. In an example illustrated in FIG. 22, a prize is determined and stored in each of the storage region 1 with the BET number 1, the storage region 1 with the BET number 4, and the storage region 1 with the BET number 5. That is, in the base game in the past, the BET button 320a (the BET number 1), the BET button 320d (the BET number 4), and the BET button 320e (the BET number 5) are operated to start the base game. The BET button 320b (the BET number 2) and the BET button 320c (the BET number 3) are not operated in the base game. Prizes are not stored in the BET number 2 and the BET number 3.

All of the twelve prizes are allocated to and stored in the prize storage region according to the operated BET button. In contrast, on the board surface of the transition roulette game, prizes are gradually displayed on the cells of the board surface according to the number of CLOCKs stop-displayed in the base game.

In the present embodiment, prizes allocated to the twelve cells are determined in advance before the cells are displayed. The prizes allocated to the cells to be displayed may be determined at timing when the prizes are displayed on the cells on the board surface.

### <<<Board Surfaces of the Base Game and the Transition Roulette Game>>>

FIGS. 26A to 26C are diagrams illustrating an example of symbols stop-displayed in the symbol display region 400 in the base game. FIGS. 27A to 27D are diagrams illustrating a process in which the cells on the board surface of the transition roulette game are displayed according to CLOCK stop-displayed in the base game.

First, as illustrated in FIG. 27A, in the beginning of the base game, only a prize “MINI” allocated to the cell number 1 is displayed on the board surface of the transition roulette game.

Subsequently, as illustrated in FIG. 26A, when three “CLOCK”s are stop-displayed in the symbol display region 400 in the base game, as illustrated in FIG. 27B, prizes of three cells, that is, a prize “5000” allocated to the cell number 2, a prize “BONUS” allocated to the cell number 3, and a prize “3000” allocated to the cell number 4 are displayed.

Subsequently, as illustrated in FIG. 26B, when four “CLOCK”s are stop-displayed in the symbol display region 400 in the base game, as illustrated in FIG. 27C, prizes of four cells, that is, a prize “1250” allocated to the cell number 5, a prize “500” allocated to the cell number 6, a prize “1000” allocated to the cell number 7, and a prize “2500” allocated to the cell number 8 are displayed.

Subsequently, as illustrated in FIG. 26C, when four “CLOCK”s are stop-displayed in the symbol display region 400 in the base game, as illustrated in FIG. 27D, prizes of four cells, that is, a prize “BONUS” allocated to the cell number 9, a prize “5000” allocated to the cell number 10, a prize “BONUS” allocated to the cell number 11, and a prize “GRAND” allocated to the cell number 12 are displayed.

In this way, cells as many as the “CLOCK”s stop-displayed in the base game are displayed.

When all of the twelve cells configuring the board surface of the transition roulette game are displayed, the board surface of the transition roulette game rotates (FIG. 28A) and, thereafter, the prize “5000” is selected by the lottery processing. The board surface of the transition roulette game is stop-displayed to show the selected prize “5000” (FIG. 28B).

### <<Cell Display for Each of the Numbers of BETs>>

As illustrated in FIG. 22, the prizes allocated to the cells configuring the board surface of the transition roulette game are determined for each of BET numbers at the start of the base game.

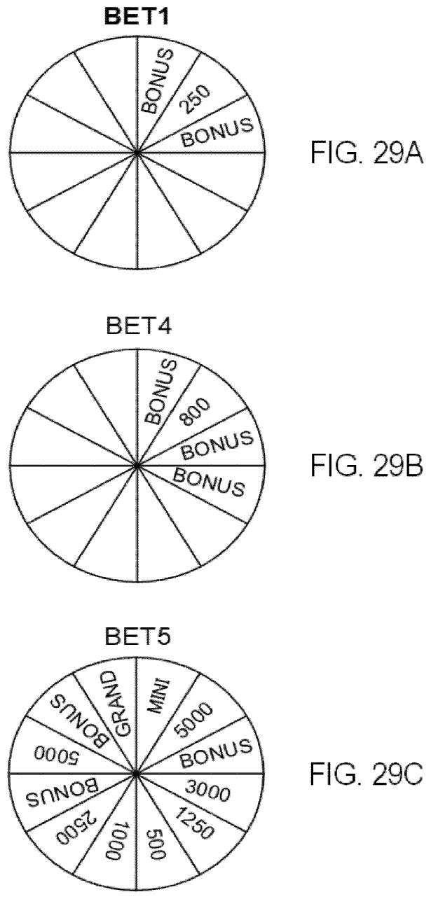

FIGS. 29A to 29C are diagrams illustrating an example of the board surface of the transition roulette game in which display is switched for each of the numbers of BETs. For example, when the base game is advanced by the BET button 320a, the board surface of the transition roulette game illustrated in FIG. 29A is displayed. When the base game is advanced by the BET button 320d, the board surface of the transition roulette game illustrated in FIG. 29B is displayed. When the base game is advanced by the BET button 320e, the board surface of the transition roulette game illustrated in FIG. 29C is displayed.

When the player switches the BET ratio and executes the base game, the board surface of the transition roulette game is also switched and displayed. For example, when the BET button 320d is operated to start the base game while the BET button 320a is operated to advance the base game, the board surface of the transition roulette game illustrated in FIG. 29A is switched to the board surface of the transition roulette game illustrated in FIG. 29B and the board surface of the transition roulette game illustrated in FIG. 29B is displayed. When the BET button 320a is operated to start the base game while the BET button 320e is operated to advance the base game, the board surface of the transition roulette game illustrated in FIG. 29C is switched to the board surface of the transition roulette game illustrated in FIG. 29A and the board surface of the transition roulette game illustrated in FIG. 29A is displayed.

Even if the base game is not started, a BET button may be operated to switch and display the board surface of the transition roulette game corresponding to a BET ratio of the operated BET button. Accordingly, the player can easily grasp which BET button is operated to perform the base game to easily complete the board surface of the transition roulette game.

By switching the BET ratio, it is possible to prevent an excessive profit or an excessively small profit.

### <<When the Base Game is Stopped Halfway>>

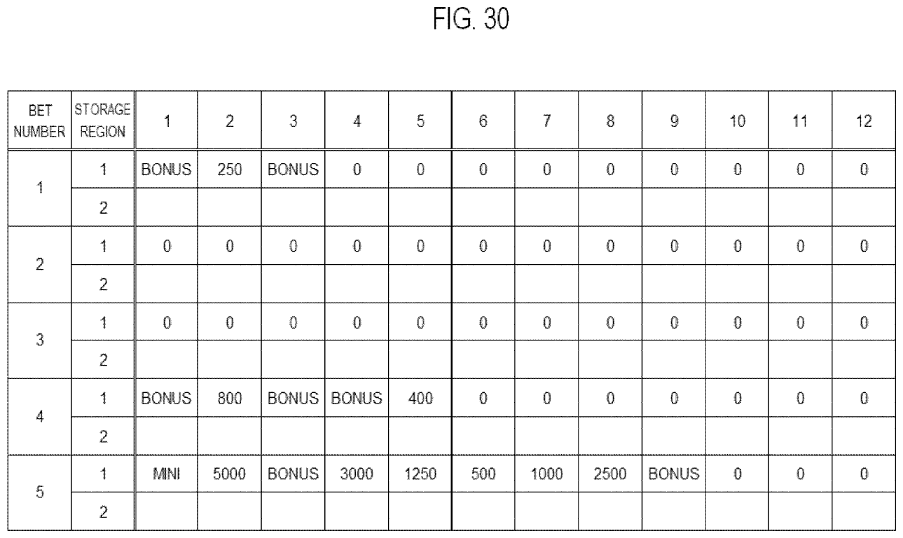

As explained above, as the base game progresses, the prizes of the cells configuring the board surface of the transition roulette game are gradually displayed. When the user stops the base game halfway because of convenience of the player or the like, only the transition roulette game can be executed and ended. According to operation of the player, the lottery processing is executed with a prize of an un-displayed cell set to a miss. For example, as illustrated in FIG. 30, the lottery processing can be executed with the prize of the un-displayed cell set to 0.

### <<<Bonus Game Processing>>>

FIG. 32 is a flowchart illustrating bonus game processing. The bonus game processing is invoked in step S625 of the base game processing illustrated in FIG. 6 and step S1927 of the transition roulette game processing illustrated in FIG. 19.

First, the CPU 110 of the controller 100 detects selection operation of the player (step S3211). For the selection operation of the player, the BET button 320, the SPIN button 330, the touch panel 340, or the like can be used. This operation is for selecting a bonus game of any of the FLYING BONUS, the SKILL BONUS, and the Freespin BONUS.

The CPU 110 of the controller 100 determines whether the FLYING BONUS is selected (step S3213). When determining that the FLYING BONUS is selected (YES), the CPU 110 of the controller 100 executes FLYING BONUS processing illustrated in FIG. 33 explained below (step S3215) and ends this subroutine.

When determining that the FLYING BONUS is not selected (NO), the CPU 110 of the controller 100 determines whether the SKILL BONUS is selected (step S3217). When determining that the SKILL BONUS is selected (YES), the CPU 110 of the controller 100 executes SKILL BONUS processing illustrated in FIG. 42 explained below (step S3219) and ends this subroutine.

When determining that the SKILL BONUS is not selected (NO), the CPU 110 of the controller 100 determines whether the Freespin BONUS is selected (step S3221). When determining that the Freespin BONUS is selected (YES), the CPU 110 of the controller 100 executes Freespin BONUS processing illustrated in FIG. 51 explained below (step S3223) and ends this subroutine.

When determining that the Freespin BONUS is not selected (NO), the CPU 110 of the controller 100 immediately ends this subroutine.

### <<<FLYING BONUS Processing>>>

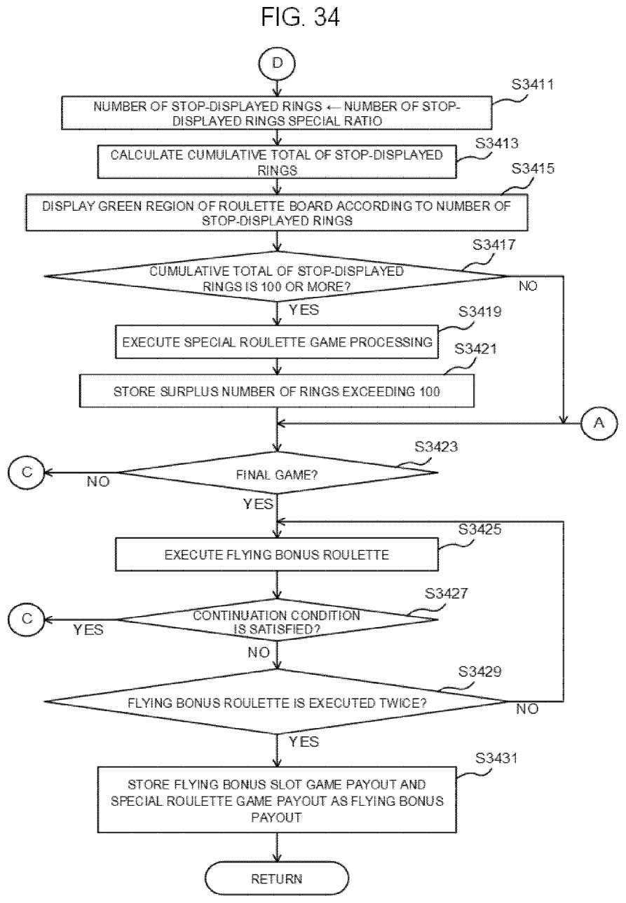

FIG. 33 and FIG. 34 are flowcharts illustrating FLYING BONUS processing. As explained above, the FLYING BONUS has a FLYING BONUS slot game and a FLYING BONUS roulette game.

First, the FLYING BONUS slot game is executed. When a predetermined condition is satisfied in the FLYING BONUS slot game, the FLYING BONUS roulette game is executed. The FLYING BONUS roulette game determines whether to continue the FLYING BONUS. When it is determined to continue the FLYING BONUS, the FLYING BONUS slot game is executed again.

First, the CPU 110 of the controller 100 executes initialization of the FLYING BONUS game (step S3311). For example, the CPU 110 of the controller 100 initializes a cumulative total of RING. The cumulative total of RING is a sum of RING stop-displayed in the symbol display region 400 during seven games (seven times of unit games) of the FLYING BONUS slot game. The CPU 110 of the controller 100 initializes payouts such as a FLYING BONUS slot game payout and a special roulette game payout as well.

Subsequently, the CPU 110 of the controller 100 executes initialization processing at a unit game end time (step S3313). For example, the number of BETs, symbols determined by the lottery processing, and the like are initialized. In addition, the number of games is subtracted. When re-spinning explained below is performed, the number of games is not subtracted.

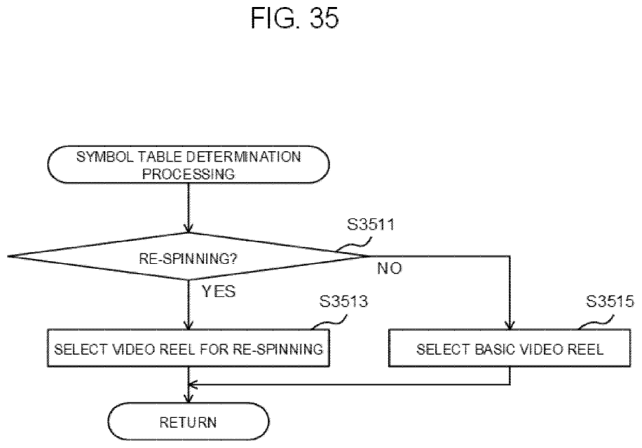

Subsequently, the CPU 110 of the controller 100 executes symbol table determination processing illustrated in FIG. 35 (step S3315). REEL A to REEL F illustrated in FIG. 38 explained blow are selected by the symbol table determination processing.

Subsequently, the CPU 110 of the controller 100 invokes and executes the lottery processing illustrated in FIG. 15 (step S3317). The lottery processing includes stop symbol lottery processing and rendering lottery processing.

Subsequently, the CPU 110 of the controller 100 invokes and executes the scroll display control processing illustrated in FIG. 16 (step S3319). According to this processing, a video reel is displayed in each of stop positions in 3 rows and 5 columns or 4 rows and 5 columns in the symbol display region 400 of the lower display 210. A video reel used in the FLYING BONUS game is explained below.

Subsequently, the CPU 110 of the controller 100 determines whether a persona symbol (DOLPHIN, DRAGON, or ROCKET) is stop-displayed (step S3321).

When determining that the persona symbol (DOLPHIN, DRAGON, or ROCKET) is stop-displayed (YES), the CPU 110 of the controller 100 returns the processing to step S3315. Accordingly, re-spinning is started.

When determining that the persona symbol (DOLPHIN, DRAGON, or ROCKET) is not stop-displayed (NO), the CPU 110 of the controller 100 determines whether RING is stop-displayed (step S3323).

When determining that the RING is stop-displayed (YES), the CPU 110 of the controller 100 calculates the number of stop-displayed RINGS (step S3325).

When determining that the RING is not stop-displayed (NO), the CPU 110 of the controller 100 shifts the processing to step S3423.

Subsequently, the CPU 110 of the controller 100 determines a payout ratio with lottery processing (step S3327).

Subsequently, the CPU 110 of the controller 100 adds a value obtained by multiplying the minimum number of BETs by the payout ratio to the FLYING BONUS slot game payout (step S3329).

Subsequently, the CPU 110 of the controller 100 determines whether ROCKET is stop-displayed (step S3331).

When determining that the ROCKET is stop-displayed (YES), the CPU 110 of the controller 100 determines a special payout with lottery processing (step S3333).

When determining that the ROCKET is not stop-displayed (NO), the CPU 110 of the controller 100 determines the special payout as 1 (step S3335).

Subsequently, the CPU 110 of the controller 100 sets a number desired to multiply the number of stop-displayed RINGs by the special ratio as the number of RINGs stop-displayed anew (step S3411).

Subsequently, the CPU 110 of the controller 100 calculates a cumulative total of the stop-displayed RINGs (step S3413).

Subsequently, the CPU 110 of the controller 100 displays a green region of the board surface of the FLYING BONUS roulette game according to the number of stop-displayed RINGs (step S3415). Note that the number of stop-displayed RINGs is a number multiplied by the special payout.

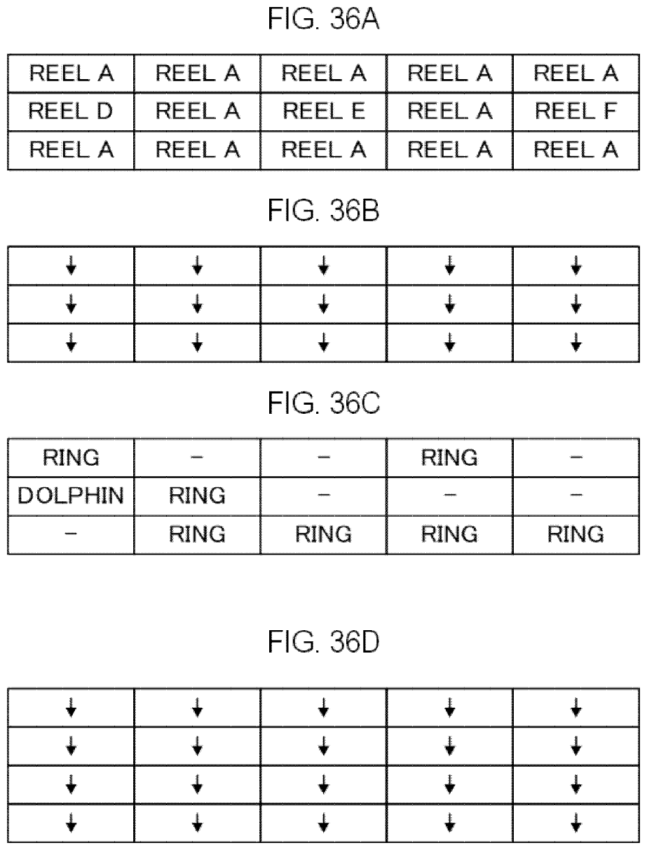

For example, in an example illustrated in FIG. 36C, seven RINGs are stop-displayed. When the special payout is 1, the green region increases in size by seven cells with the seven stop-displayed RINGs.

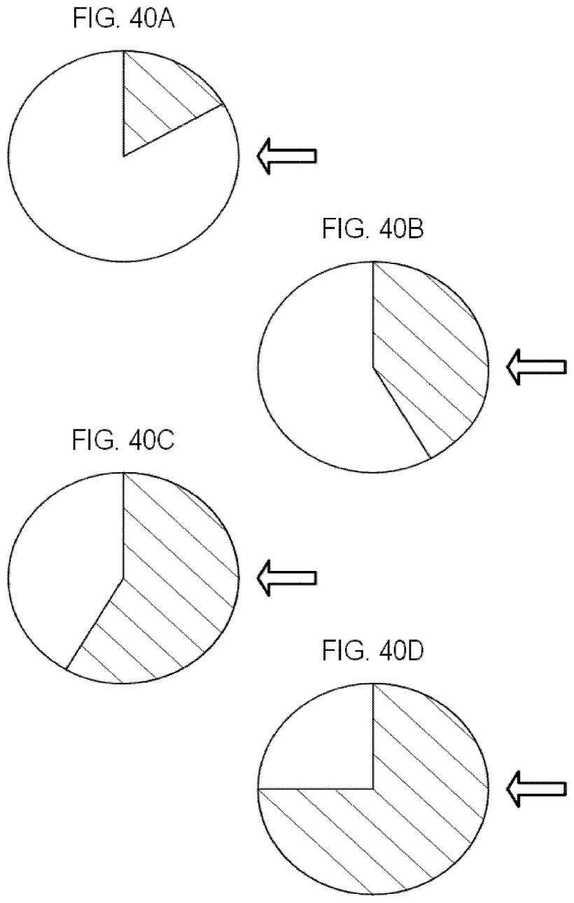

As the FLYING BONUS roulette game is executed (the unit game is repeated), every time the RING is stop-displayed, the green region of the board surface of the FLYING BONUS roulette game gradually increases in size according to the number of RINGs. In FIGS. 40A to 40D, the green region is indicated by a shaded fan shape and a red region is indicated by a white fan shape.

The board surface of the FLYING BONUS roulette game has two types of regions, that is, the green region and the red region (see FIGS. 40A to 40D). Both of the green region and the red region have a fan shape. The size of the green region (the central angle of the fan shape) is determined by the number of stop-displayed RINGs. The red region is the remaining region other than the green region. The board surface of the FLYING BONUS roulette game includes one hundred cells. The green region is configured by a first number of cells among the one hundred cells. The red region is configured by the remaining second number of cells. One RING corresponds to one of the cells configuring the green region. That is, when the number of stop-displayed RINGs is twelve, the green region is increased in size by twelve cells and the red region is reduced in size by the twelve cells.

Subsequently, the CPU 110 of the controller 100 determines whether a cumulative total of the stop-displayed RINGs is 100 or more (step S3417).

When determining that the cumulative total of the stop-displayed RINGs is 100 or more (YES), the CPU 110 of the controller 100 executes a special roulette game (step S3419).

The special roulette game is a game different from the FLYING BONUS roulette game. The size and the number of cells configuring a board surface (not illustrated) are fixed and contents of prizes allocated to the cells are also fixed. A special roulette game payout is determined by the execution of the special roulette game.

When determining that the cumulative total of stop-displayed RINGs is less than 100 (NO), the CPU 110 of the controller 100 shifts the processing to step S3423.

Subsequently, the CPU 110 of the controller 100 stores a surplus number exceeding 100 from the cumulative total of RINGs (step S3421).

Subsequently, the CPU 110 of the controller 100 determines whether the game has reached a final game (step S3423).

When determining that the game has not reached the final game (NO), the CPU 110 of the controller 100 returns the processing to step S3313. Accordingly, the next FLYING BONUS slot game (the unit game) is started.

When determining that the game has reached the final game (YES), the CPU 110 of the controller 100 executes a FLYING BONUS roulette game (step S3425).

The FLYING BONUS roulette game is a game for determining whether to continue the FLYING BONUS game.

The CPU 110 of the controller 100 determines whether a result of the BONUS roulette game satisfies a continuation condition (step S3427).

When determining in the determination processing in step S3427 that the result of the BONUS roulette game satisfies the continuation condition (YES), the CPU 110 of the controller 100 returns the processing to step S3313. Accordingly, the FLYING BONUS slot game is started anew.

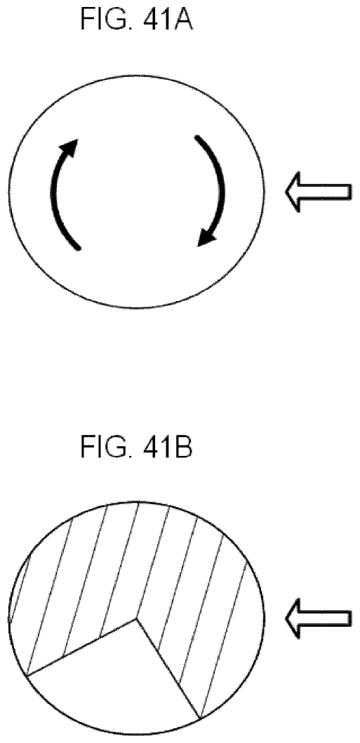

For example, as illustrated in FIGS. 41A and 41B, the CPU 110 of the controller 100 displays the board surface of the FLYING BONUS roulette game to rotate (FIG. 41A) and stop-displays the board surface to indicate that the green region is selected (FIG. 41B).

When determining that the result of the BONUS roulette game does not satisfy the continuation condition (NO), the CPU 110 of the controller 100 determines whether FLYING BONUS roulette is executed twice (step S3429).

When determining that the FLYING BONUS roulette is not executed twice (NO), the CPU 110 of the controller 100 returns the processing to step S3425.

When determining that the FLYING BONUS roulette is executed twice (YES), the CPU 110 of the controller 100 multiplies a FLYING BONUS slot game payout and a special roulette game payout by the minimum number of BETs to calculate the number of bonus credits and stores the number of bonus credits (step S3431) and ends the FLYING BONUS game.

Specifically, the FLYING BONUS roulette game is executed according to a numeric table for FLYING BONUS roulette game illustrated in FIG. 39. The numeric table for FLYING BONUS roulette game includes a numeric at normal time (hereinafter, normal table (“Normal” in FIG. 39)) and a numeric at restoration time (hereinafter, restoration table (“restoration” in FIG. 39)).

First, in a first FLYING BONUS roulette game, in step S3427, according to the numeric of the normal table, the green region or the red region is selected according to the number of RINGs. When the green region is selected, the continuation condition is satisfied and the FLYING BONUS slot game is started anew.

When the red region is selected in the first FLYING BONUS roulette game, as a second FLYING BONUS roulette game, in the processing in step S3429, according to the numeric of the restoration table, the green region or the red region is selected according to the number of RINGS. When the green region is selected, it is determined that the restoration condition is satisfied. The FLYING BONUS slot game is started anew. On the other hand, when the red region is selected, the restoration condition cannot be satisfied and the FLYING BONUS game ends.

### <<<Symbol Table Determination Processing>>>

FIG. 35 is a flowchart illustrating symbol table determination processing.

First, the CPU 110 of the controller 100 determines whether to perform re-spinning (step S3511). A condition for re-spinning a video reel is that “DOLPHIN” is included in a stop-displayed symbol.

When determining that to perform re-spinning (YES), the CPU 110 of the controller 100 selects a video reel for re-spinning (step S3513). When determining not to perform re-spinning (NO), the CPU 110 of controller 100 selects a basic video reel (step S3515).

### <<Video Reel of the FLYING BONUS Slot Game>>

In the FLYING BONUS slot game, one video reel is allocated to each of stop positions and the allocated video reel is scrolled in each of the stop positions. The FLYING BONUS slot game usually has stop positions in 3 rows and 5 columns. A video reel is allocated to each of the stop positions in 3 rows and 5 columns. For example, in an example illustrated in FIG. 36A, the REEL A is allocated to all of upper five stop positions. The REEL D, the REEL A, the REEL E, the REEL A, and REEL F are allocated to each of middle five stop positions in order from the left. The REEL A is allocated to all of lower five stop positions.

As illustrated in FIG. 36B, the video reel allocated to each of the stop positions in 3 rows and 5 columns is separately scrolled in each of the stop positions. After the scrolling, the stop symbol determined by the lottery processing is displayed in each of the stop positions. In the FLYING BONUS slot game, only one symbol among a plurality of symbols arranged in the REEL A to the REEL F is displayed.

### <Basic Video Reel>

In the beginning of the start of the FLYING BONUS slot game, a basic video reel is selected in the processing in step S3315. The basic video reel is a combination of 3×5 video reels illustrated in FIG. 36A. In the basic video reel, the video reel illustrated in FIG. 36A is not always allocated to the stop positions in 3 rows and 5 columns.

Each of the REEL D, the REEL E, and the REEL F is allocated to one of the left column, the center column, and the right column by lottery processing. That is, the REEL D may be allocated not only to the left column but also to the center column or the right column. The REEL E may be allocated not only to the center column but also to the left column or the right column. The REEL F may be allocated not only to the right column but also to the left column or the center column. The REEL D, the REEL E, and the REEL F can be allocated to any one of the left column, the center column, and the right column one by one.

Further, in the left column, the center column, and the right column, video reels allocated to an upper stop position, a middle stop position, and a lower stop position can be determined by lottery processing.

By replacing and allocating the video reels in this way, even a basic video reel can be prevented from being monotonously displayed.

### <Video Reel for Re-Spinning>

In an example illustrated in FIG. 36C, one symbol “DOLPHIN” is stop-displayed. When the “DOLPHIN” is stop-displayed, a video reel is re-spun. The REEL C is allocated to a stop position where the RING is stop-displayed. The RING is stop-displayed after the re-spinning. In the other stop positions, allocated video reels are re-spun.

FIGS. 37A to 37G are tables illustrating allocation rules for video reels allocated when being re-spun. According to the allocation rules illustrated in FIGS. 37A to 37G, the video reel for re-spinning in step S3513 is determined.

### <Allocation Rule 1>

FIG. 37A is a table illustrating an allocation rule 1. The REEL C is allocated to and re-spun in a stop position where the “DOLPHIN” is stop-displayed. The REEL A is allocated to and re-spin in a stop position where another symbol is stop-displayed and a stop position added anew.

### <Allocation Rule 2>

FIG. 37B is a table illustrating an allocation rule 2. The REEL C is allocated to and re-spun in a stop position where the “DRAGON” is stop-displayed. When the RING is stop-displayed when the “DRAGON” is stop-displayed, the RING is stop-displayed as it is without being scrolled in a stop position where the RING is stop-displayed. The REEL B is allocated to and re-spun in a stop position where the BLANK is stop-displayed.

### <Allocation Rule 3>

FIG. 37C is a table illustrating an allocation rule 3. The REEL C is allocated to and re-spun in a stop position where the “ROCKET” is stop-displayed. The REEL A is allocated to and re-spun in a stop position where another symbol is stop-displayed.

### <Allocation Rule 4>

FIG. 37D is a table illustrating an allocation rule 4. The REEL C is allocated to and re-spun in a stop position where the “DOLPHIN” is stop-displayed. The REEL C is allocated to and re-spun in a stop position where the “DRAGON” is stop-displayed. When the RING is stop-displayed when the “DRAGON” is stop-displayed, the RING is stop-displayed as it is without being scrolled in a stop position where the RING is stop-displayed. The REEL B is allocated to and re-spin in a stop position where the “BLANK” is stop-displayed and a stop position added anew.

### <Allocation Rule 5>

FIG. 37E is a table illustrating an allocation rule 5. The REEL C is allocated to and re-spun in a stop position where the “DOLPHIN” is stop-displayed. The REEL C is allocated to and re-spun in a stop position where the “ROCKET” is stop-displayed. The REEL A is allocated to and re-spin in a stop position where another symbol is stop-displayed and a stop position added anew.

### <Allocation Rule 6>

FIG. 37F is a table illustrating an allocation rule 6. The REEL C is allocated to and re-spun in a stop position where the DRAGON is stop-displayed. The REEL C is allocated to and re-spun in a stop position where the ROCKET is stop-displayed. When the RING is stop-displayed when the “DRAGON” is stop-displayed, the RING is stop-displayed as it is without being scrolled in a stop position where the RING is stop-displayed. The REEL B is allocated to and re-spun in a stop position where the “BLANK” is stop-displayed.

### <Allocation Rule 7>

FIG. 37G is a table illustrating an allocation rule 7. The REEL C is allocated to and re-spun in a stop position where the “DOLPHIN” is stop-displayed. The REEL C is allocated to and re-spun in a stop position where the “DRAGON” is stop-displayed. The REEL C is allocated to and re-spun in a stop position where the “ROCKET” is stop-displayed. When the RING is stop-displayed when the “DRAGON” is stop-displayed, the RING is stop-displayed as it is without being scrolled in a stop position where the RING is stop-displayed. The REEL B is allocated to and re-spin in a stop position where the “BLANK” is stop-displayed and a stop position added anew.

### <<Number of Stop Positions>>

The FLYING BONUS slot game usually has stop positions in 3 rows and 5 columns. When a DOLPHIN symbol is stop-displayed, a FLYING BONUS slot game at a re-spinning time has stop positions in 4 rows and 5 columns. A video reel is allocated to each of 4 rows and 5 columns and is re-spun (scrolled) (FIG. 36D). By increasing the stop positions, it is possible to further increase the RINGs to be stop-displayed and it is possible to increase the bonus payout. Note that FIG. 36D illustrates a state in which the scrolling is performed in all the stop positions. However, as explained above, when the RING is stop-displayed when the “DRAGON” is stop-displayed, the RING is stop-displayed as it is in a stop position where the RING is stop-displayed.

### <<Symbols of REEL A to REEL F>>

FIG. 38 is a table illustrating symbols configuring each of the REEL A, the REEL B, the REEL C, the REEL D, the REEL E, and the REEL F. In FIG. 38, “-” indicates BLANK.

The REEL A includes RINGs and BLANKs. Zero to three BLANKs are arranged between the RINGs adjacent to each other. When the number of BLANKs is zero, the RINGs are continuously arranged.

The REEL B includes RINGs and BLANKs. Zero to one BLANK is arranged between the RINGs adjacent to each other. When the number of BLANKs is zero, the RINGs are continuously arranged. Since the number of BLANKs arranged between the RINGs adjacent to each other is zero to one, the number is smaller than the number of BLANKs of the REEL A (zero to three). In particular, a maximum number of BLANKs arranged between the RINGs adjacent to each other is one in the REEL B and is three in the REEL A. The number is smaller in the REEL B.

The REEL C includes only RINGs. All the RINGs are continuously arranged. Therefore, the number of BLANKs arranged between the RINGs adjacent to each other is smaller than the number (zero to one) in the REEL B. In particular, the maximum number of BLANKs arranged between the RINGs adjacent to each other is zero in the REEL C and is one in the REEL B. The number is smaller in the REEL C.

By arranging the RINGs in this way, the RING is always stop-displayed at a stop position where the REEL C is selected. That is, in the REEL C, the RINGs are more easily stop-displayed than in the REEL A and the REEL B. The RING is more easily stop-displayed in a stop position where the REEL B is selected than in a stop position where the REEL A is selected.

The REEL D includes RINGs, “DOLPHIN”s and BLANKs. The “DOLPHIN” is sometimes stop-displayed in a stop position where the REEL D is selected.

The REEL E includes RINGs, “ROCKET”s and BLANKs. The “ROCKET” is sometimes stop-displayed in a stop position where the REEL D is selected.

The REEL F includes RINGs, “DRAGON”s and BLANKs. the “DRAGON” is sometimes stop-displayed in a stop position where the REEL D is selected.

### <<Specific Symbols>>

The “DOLPHIN”, the “ROCKET”, and the “DRAGON” explained above are referred to as specific symbol. The “DOLPHIN”, the “ROCKET”, and the “DRAGON” are sometimes referred to as persona symbol. As illustrated in FIGS. 37A to 37G, the REEL C is allocated to and the RING is always stop-displayed in a stop position where the specific symbol is stop-displayed.

### <<Numeric Table for FLYING BONUS ROULETTE GAME>>

FIG. 39 is a table illustrating a numeric table for FLYING BONUS roulette game. The numeric table for FLYING BONUS roulette game decides a numeric at a normal time and a numeric at a restoration time. A numeric is determined to correspond to each of the green region and the red region. According to this numeric, it is determined whether to continue FLYING BONUS.

The numeric for the restoration time is a numeric for making the green region or the red region consistent or inconsistent with the player's recognition. For example, when most of the board surface is the green region, the player expects that the FLYING BONUS is highly likely to continue. However, when the red region is selected by lottery processing and it is determined that the FLYING BONUS does not continue, a discrepancy from the player's recognition occurs. For this reason, a numeric is decided such that the green region is selected in order to make the green region consistent with the player's recognition.

By performing the processing in this way, not only when the number of RINGs is 100, but also when the number of RINGs is 96 to 99, the FLYING BONUS can be continued substantially at a probability of 100%. Accordingly, it is possible to prevent the player from feeling suspicious as to whether lottery is actually performed according to the number of RINGs.

Conversely, when most of the board surface is the red region, the player expects that the FLYING BONUS is less likely to continue. Accordingly, if the red region is selected by the lottery processing, the region is consistent with the player's recognition. However, if the green region is selected by restoration lottery, this causes the player to feel surprise because the green region is inconsistent with the player's recognition. In order to be inconsistent with the player's recognition, the number is decided such that the green region is selected to be consistent with the player's recognition.

### <<Carryover of the RINGs>>

When the number of RINGs stop-displayed in the FLYING BONUS slot game is larger than 100, the entire region of the roulette board surface turns green. A surplus number larger than 100 is carried over. When the subsequent FLYING BONUS slot game starts thereafter, the surplus number of cells turn green and the green region is displayed.

### <<<SKILL BONUS Processing>>>

FIG. 42 is a flowchart illustrating SKILL BONUS processing. This processing is invoked and executed in step S3219 in FIG. 32.

First, the CPU 110 of the controller 100 executes unit game initialization processing (step S4211). For example, the CPU 110 of the controller 100 initializes a SKILL BONUS slot game payout and a SKILL game payout.

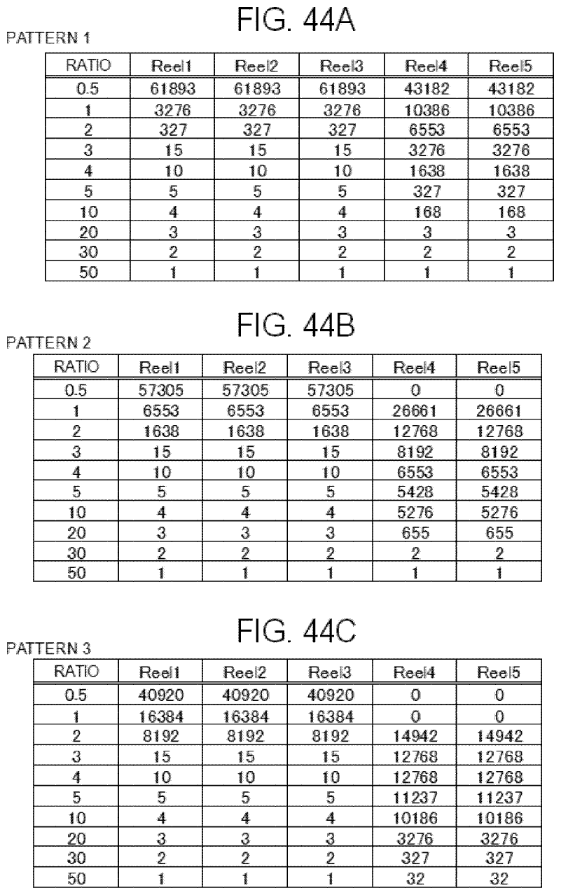

The CPU 110 of the controller 100 determines a pattern number for prize determination with lottery (step S4213). Specifically, patterns 1 to 3 illustrated in FIGS. 44A to 44C are determined. Winning probabilities of the patterns 1 to 3 are set the same.

Subsequently, the CPU 110 of the controller 100 determines, for each of the reels, with lottery, a value (a payout) of a prize according to the determined pattern number (step S4215).

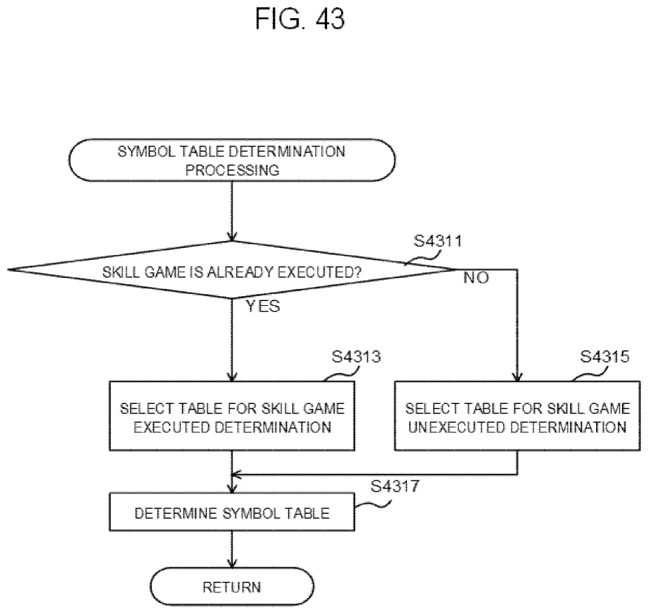

Subsequently, the CPU 110 of the controller 100 executes symbol table determination processing illustrated in FIG. 43 explained (step S4219).

Subsequently, the CPU 110 of the controller 100 executes lottery processing (step S4221). A stop symbol is determined by this processing.

Subsequently, the CPU 110 of the controller 100 executes scroll display control processing (step S4223).

Subsequently, the CPU 110 of the controller 100 determines whether a predetermined number of predetermined symbols are displayed (step S4225).

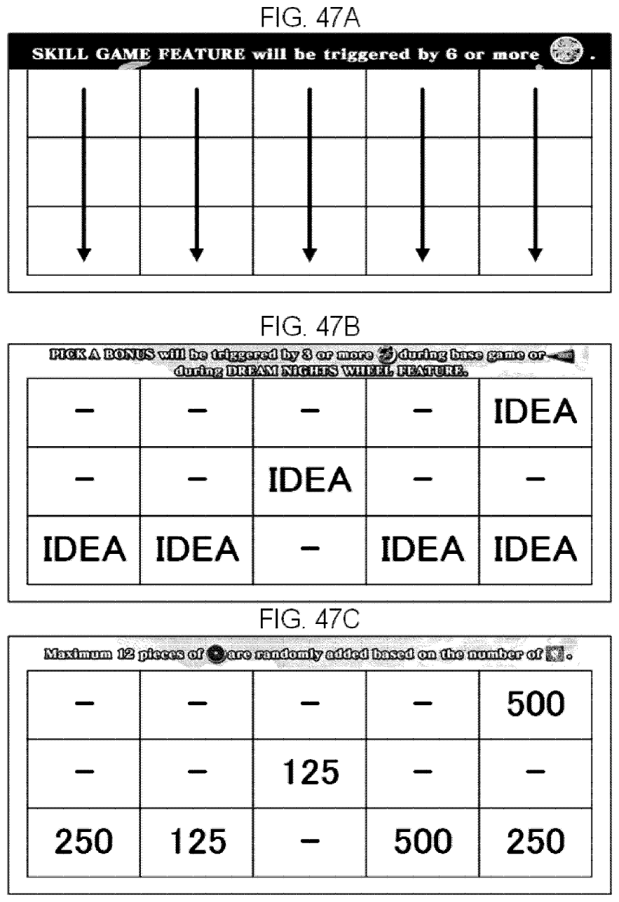

For example, the CPU 110 of the controller 100 determines whether six or more IDEA symbols (=symbols indicating payouts, see FIG. 47B) explained below are displayed.

When determining in the determination processing in step S4225 that the predetermined number of predetermined symbols are displayed (YES), the CPU 110 of the controller 100 executes skill game processing explained below (step S4227).

Subsequently, the CPU 110 of the controller 100 adds a SKILL BONUS slot game payout from the stop-displayed predetermined symbol (step S4229).

After executing the skill game processing in step S4227 or when determining in step S4225 that the predetermined number of predetermined symbols are not displayed (NO), the CPU 110 of the controller 100 determines whether an end condition is satisfied (step S4231).

When determining in step S4231 that the end condition is not satisfied (NO), the CPU 110 of the controller 100 returns the processing to step S4213 and executes the next video slot game.

When determining in the determination processing in step S4231 that the end condition is satisfied (YES), the CPU 110 of the controller 100 ends this subroutine.

In the SKILL BONUS, a number obtained by multiplying the SKILL BONUS slot game payout added in step S4229 and a SKILL game payout explained below by a BET ratio of the base game is the number of bonus credits.

### <Symbol Table Determination Processing>

FIG. 43 is a flowchart illustrating symbol table determination processing. This processing is invoked and executed in step S4219 of the SKILL BONUS processing illustrated in FIG. 42.

First, the CPU 110 of the controller 100 determines whether a skill game is already executed (step S4311).

When determining in step S4311 that the skill game is already executed (YES), the CPU 110 of the controller 100 selects a table for skill game executed determination (step S4313).

When determining in step S4311 that the skill game is not executed yet (NO), the CPU 110 of the controller 100 selects a table for skill game unexecuted determination (step S4315).

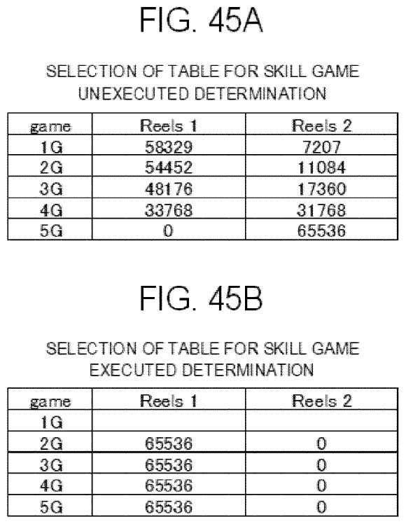

The CPU 110 of the controller 100 determines a symbol table using the table selected in step S4313 or step S4315 (Step S4317, details are explained with reference to FIGS. 45A and 45B) and ends this subroutine.

### <Determination Method for a Value (a Payout) of a Prize>

FIGS. 44A to 44C are tables illustrating a determination method for a value (a payout) of a prize.

As explained above, first, any one of the patterns 1 to 3 is determined by lottery. Winning probabilities of the patterns 1 to 3 are the same.

Tables of the patterns 1 to 3 are used to determine a ratio with respect to a predetermined fixed value. Accordingly, a value (a payout) of a prize is determined. For example, when the player is playing at a minimum number of BETs X a bet ratio=250, the payout is 125 if the ratio is 0.5, the payout is 250 if the ratio is 1, and the payout is 12500 when the ratio is 50.

For example, when the pattern 1 is won, an upper table is used. In the table of the pattern 1 (the upper table), in all of the Reel 1 to the Reel 5, ratios of 0.5˜50 are more easily selected in the order of 0.5>1>2>3>4>5>10>20>30>50.

When an IDEA symbol explained below is displayed in an upper part of the Reel 1 when the pattern 1 is won, a ratio for determining a payout for the IDEA symbol is determined using a numeric of the Reel 1 illustrated in FIG. 44A. Accordingly, the payout of the IDEA symbol in the upper part of the Reel 1 is determined by the minimum number of BETs X the bet ratio X the ratio.

When the IDEA symbol is also displayed in the lower part of the Reel 1, a ratio for the lower IDEA symbol is determined using the numeric of the Reel 1 illustrated in FIG. 44A separately from the ratio for the upper IDEA symbol. Accordingly, the payout of the IDEA symbol in the lower part of the Reel 1 is determined by the minimum number of BETs X the bet ratio X the ratio.

In this manner, the payout is determined by determining the ratio with lottery for each of the IDEA symbols.

When the pattern 2 is won, the middle table is used. In the table of the pattern 2 (the middle table), in the Reel 1 to the Reel 3, the ratios 0.5 to 50 are more easily selected in the order of 0.5>1>2>3>4>5>10>20>30>50. In the Reel 4 and the Reel 5, the ratio of 0.5 is not selected and the ratios of 1 to 50 are more easily selected in the order of 1>2>3>4>5>10>20>30>50.

In the pattern 2, compared with the pattern 1, the ratio of 0.5 is less easily selected and the ratio of 1 and the ratio of 2 are more easily selected.

When the pattern 3 is won, the lower table is used. In the table of the pattern 3 (the lower table), in the Reel 1 to the Reel 3, the ratios of 0.5 to 50 are more easily selected in the order of 0.5>1>2>3>4>5>10>20>30>50. In the Reel 4 and the Reel 5, the ratio of 0.5 and the ratio of 1 are not selected and the ratios of 2 to 50 are more easily selected in the order of 2>3=4>5>10>20>30>50.

In the pattern 3, compared with the pattern 1 and the pattern 2, the ratio of 0.5 is less easily selected, the ratio of 1 and the ratio of 2 are easily selected in the Reel 1 to the Reel 3, and the ratios of 2 to 50 are easily selected in the Reel 4 and the Reel 5.

That is, since the ratio easily increases in the order of the pattern 3>the pattern 2>the pattern 1, the payout easily increases in the order of the pattern 3>the pattern 2>the pattern 1.

### <<Table for Skill Game Unexecuted Determination and Table for Skill Game Executed Determination>>

FIGS. 45A and 45B are a table for skill game unexecuted determination and a table for skill game executed determination used to determine a symbol table.

### <Table for Skill Game Unexecuted Determination>

When it is determined in step S4311 in FIG. 43 that the skill game is not executed yet (NO), the table for skill game unexecuted determination (FIG. 45A) is selected (step S4315).

In other words, in the table for skill game unexecuted determination, when the skill game is not executed yet, it is determined by lottery, at different winning probabilities for each of video slot games, whether to use the Reels 1 (see FIG. 46A, details are explained with reference to FIGS. 46A and 46B), which is a reel table on which it is difficult to execute the skill game, or to use the Reels 2 (see FIG. 46B, details are explained with reference to FIGS. 46A and 46B) that always executes the skill game.

In the table for skill game unexecuted determination, it is easier to select the Reels 2 every time the video slot game advances. Note that, since a fifth game (fifth time) of the video slot game is the final time, the Reels 2 for executing the skill game is always selected.

In this way, the player can play the skill game at least once.

### <Table for Skill Game Executed Determination>

When it is determined in step S4311 in FIG. 43 that the skill game is already executed (YES), the table for skill game executed determination (FIG. 45B) is selected.

Since the first game (first time) of the video slot game is the first time, the skill game is not already executed. Therefore, the table for skill executed determination is not selected in the first game.

In the second to fifth games (second to fifth times) of the video slot game, when the skill game is already executed, the Reels 1 in which the skill game is less easily execute is always selected.

Note that, since the skill game can be executed in the Reel 1, it is supplemented that a plurality of times of skill games can be executed.

### <<Reels 1 and Reels 2>>

FIGS. 46A and 46B are diagrams illustrating an array of symbols in reels of Reels 1 (FIG. 46A) and Reels 2 (FIG. 46B).

### <Reels 1>

Reels 1 (FIG. 46A) is an array in the case in which an IDEA symbol serving as a payout is equal to or more than a predetermined number (In this example, six), which is a condition for executing the skill game, in some cases and is less than the predetermined number in other cases.

For example, when one IDEA symbol is displayed in the Reel 1, one IDEA symbol is displayed in the Reel 2, one IDEA symbol is displayed in the Reel 3, zero IDEA symbol is displayed in the Reel 4, and three IDEA symbols are displayed in the Reel 5, six IDEA symbols (prizes) in total are displayed. Therefore, the skill game is executed.

For example, when zero IDEA symbol is displayed in the Reel 1, one IDEA symbol is displayed in the Reel 2, zero IDEA symbol is displayed in the Reel 3, zero IDEA symbol is displayed in the Reel 4, and zero IDEA symbol is displayed in the Reel 5, one IDEA symbol (prize) in total is displayed. Therefore, the skill game is not executed.

### <Reels 2>

Reels 2 (FIG. 46B) is an array only in the case in which the number of IDEA symbols to be prizes is equal to or larger than a predetermined number (in this example, six), which is a condition for executing the skill game.

In the Reel 1 to the Reel 4, two IDEA symbols are present between the IDEA symbols at most, that is, two blanks are present between the IDEA symbols at most. Therefore, at least one IDEA symbol is displayed on the reels.

In the Reel 5, one IDEA symbol is present between the IDEA symbols at most, that is, one blank is present between the IDEA symbols at most. Therefore, at least two IDEA symbols are displayed in the Reel 5.

Therefore, since at least four IDEA symbols are displayed in the Reel 1 to the Reel 4 and at least two IDEA symbols are displayed in the Reel 5, at least six IDEA symbols in total are displayed. The skill game can be always executed.

### <Display Image Diagram of a Video Slot Game>

FIGS. 47A to 47C are diagrams illustrating a video slot game in the SKILL BONUS.

FIG. 47A is a diagram illustrating scrolling of the video slot game in the SKILL BONUS. At this time, the IDEA symbol is scrolled.

FIG. 47B is a diagram illustrating a state in which the scrolling of the video slot game in the SKILL BONUS is stopped and an IDEA symbol is stop-displayed. At this time, the IDEA symbol is still displayed.

FIG. 47C is a diagram illustrating a case where scrolling of the video slot game in SKILL BONUS is stopped. The stop-displayed IDEA symbol is replaced with a specific payout and displayed. Here, an IDEA symbol is displayed in which a payout of 250 is displayed in the lower part of the Reel 1, a payout of 125 is displayed in the lower part of the Reel 2, a payout of 125 is displayed in the middle part of the Reel 3, a payout of 500 is displayed in the lower part of the Reel 4, a payout of 500 is displayed in the upper part of the Reel 5, and a payout of 250 is displayed in the lower part of Reel 5.

At this time, since the IDEA symbol in which six or more payouts are displayed in total is displayed, the game transitions to a skill game in the video slot game. That is, the skill game is performed for a payout of 250+125+125+500+500+500+250=1750.

### <<Skill Game Processing>>

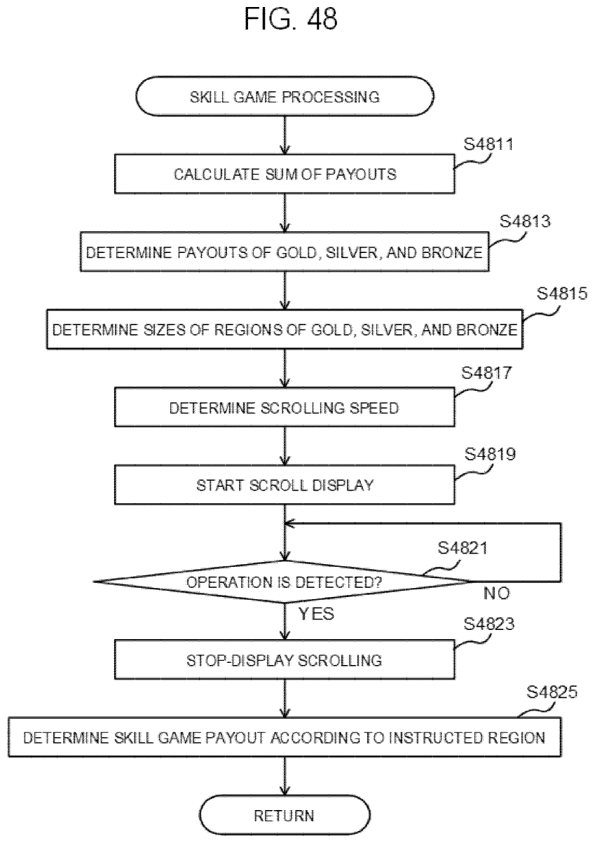

FIG. 48 is a flowchart illustrating skill game processing. This processing is invoked and executed in step S4227 of the SKILL BONUS processing illustrated in FIG. 42.

First, the CPU 110 of the controller 100 calculates a sum of prizes (payouts) displayed in the video slot game (step S4811).

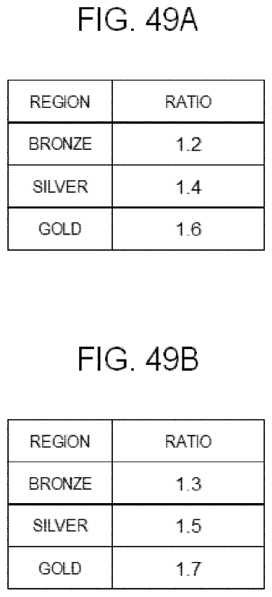

The CPU 110 of the controller 100 selects payouts of gold, silver, and bronze (step S4813). For example, in the processing in step S4813, a ratio illustrated in FIG. 49A is selected or a ratio illustrated in FIG. 49B is selected. The processing in step S4813 is processing selected by lottery processing.

After determining the payouts of gold, silver, and bronze, the CPU 110 of the controller 100 determines sizes of regions of gold, silver, and bronze (step S4815). Here, the sizes of the regions of gold, silver, and bronze may be different according to the number of IDEA symbols in which a payout is displayed in the video slot game. For example, the region of gold or silver may be larger as the number of IDEA symbols in which payouts are displayed increases.

The CPU 110 of the controller 100 determines scrolling speed in scrolling in the region (step S4817). Here, the scrolling speed may be different according to a sum of payouts displayed in the video slot game. For example, the scrolling speed may decrease as the sum of payouts increases.

The CPU 110 of the controller 100 starts scrolling (step S4819).

The CPU 110 of the controller 100 determines whether operation of the SPIN button 330 is detected (step S4821).

When determining in the determination processing in step S4821 that operation of the SPIN button 330 is not detected (NO), the CPU 110 of the controller 100 executes the processing of step S4821 again.

When determining in the determination processing in step S4821 that operation of the SPIN button 330 is detected (YES), the CPU 110 of the controller 100 stops the scrolling (step S4823).

The CPU 110 of the controller 100 determines a SKILL game payout according to an instructed region (step S4825).

When determining a bonus game payout according to the instructed region, the CPU 110 of the controller 100 ends this subroutine.

### <Ratio Determination Table>

FIGS. 49A and 49B are ratio determination tables in which a ratio of each of gold, silver, and bronze is determined in order to determine payouts of gold, silver, and bronze. By differentiating a ratio according to a plurality of tables, it is possible to variously advance the game.

### <Region of Scrolling Display>

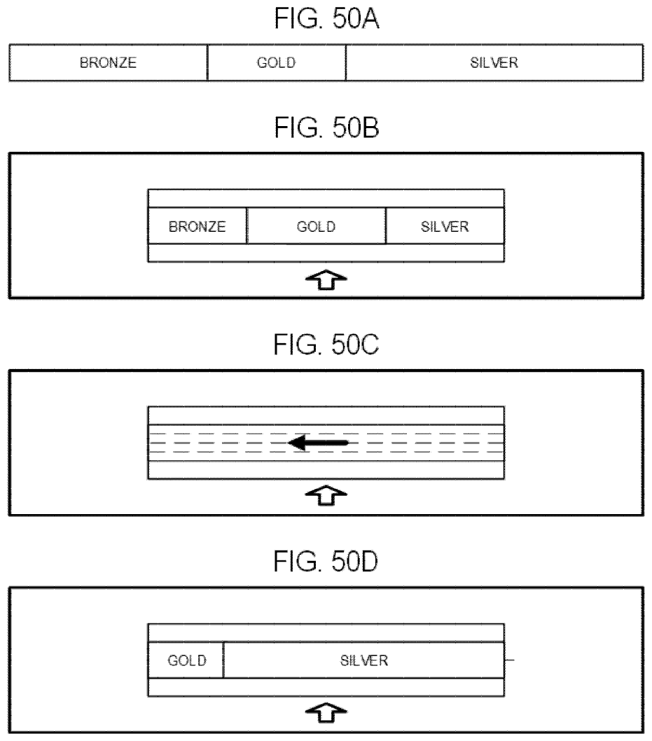

FIGS. 50A to 50D are image diagrams at the time when the regions of gold, silver, and bronze are scrolled.

FIG. 50A is a diagram illustrating the sizes of regions of gold, silver, and bronze in a skill game video reel. Here, the regions are displayed in order of gold, silver, and bronze. The sizes of the regions are silver>bronze>gold.

FIG. 50B is a diagram illustrating a display screen immediately before scrolling is started. An arrow is displayed in the center of a region for displaying scrolling. When the SPIN button 330 is operated, scrolling is stopped and a color region ahead of the arrow is determined.

FIG. 50C is a diagram illustrating the time when the scrolling is performed. For example, when a sum of payouts is extremely low, the scrolling may be performed at speed at which the player can hardly visually recognize the scrolling. Even when the sum of the payouts is extremely low, the scrolling may be performed at speed at which the player can visually recognize the scrolling.

Note that, on the display screen immediately before scrolling is started illustrated in FIG. 50B and on the display screen at the time when the scrolling illustrated in FIG. 50C is performed, it is preferable to perform display suggesting stopping with gold such as “Press the SPIN button to stop the gold in the position of the arrow!”.

FIG. 50D is a diagram illustrating the time when the player operates the SPIN button 330 to stop scrolling. Here, the scrolling is stopped in the silver region.

When the scrolling stops in the silver region, the sum of the payouts in the video slot game is multiplied by a payout of silver (For example, 1.4 times) to determine a bonus game payout in the number-th of game.

In this way, in the SKILL BONUS, a different payout is determined according to the operation skill of the player in the skill game. For this reason, since the player can obtain a high payout if the player has confidence in his/her skill, the player plays the game while trying to improve his/her skill.

### <<Freespin BONUS Processing>>

FIG. 51 is a flowchart illustrating Freespin BONUS processing. This processing is invoked and executed in step S3223 of the bonus game processing illustrated in FIG. 32.

First, the CPU 110 of the controller 100 executes unit game initialization processing (step S5111). For example, the CPU 110 of the controller 100 initializes a Freespin BONUS payout or the like.

The CPU 110 of the controller 100 determines, with lottery, whether to display a WILD symbol (step S5113).

The CPU 110 of the controller 100 determines whether to display the WILD symbol (step S5115).

When determining in the determination processing in step S5115 to display the WILD symbol (YES), the CPU HO of the controller 100 determines a stop position for the WILD symbol (step S5117).

Subsequently, the CPU 110 of the controller 100 determines a display form of the WILD symbol (step S5118). The display form of the WILD symbol includes a block-like single form and a plurality of continuous forms. For example, when the WILD symbol is displayed in a region in 5 rows and 5 columns, it is possible to select whether to display the WILD symbol as twenty-five WILD symbols or to display the WILD symbol as a block-like single block in the entire 5 rows and 5 columns. Note that, when the WILD symbol is displayed in the block-like form, the WILD symbol may be displayed not only in the single form but also in a plurality of block-like forms. For example, when the WILD symbol is displayed in the region in 5 rows and 5 columns, the WILD symbol may be displayed as a single block-like WILD symbol in the entire 5 rows and 5 columns or may be displayed as a block-like WILD symbol in 5 rows and 2 columns and a block-like WILD symbol in 5 rows and 3 columns.

When determining the stop position for the WILD symbol, the CPU 110 of the controller 100 determines display timing for the WILD symbol (step S5119).

When determining in the determination processing in step S5115 not to display the WILD symbol (NO) or executing the processing in step S5119, the CPU 110 of the controller 100 executes the symbol table determination processing (step S5121).

Subsequently, the CPU 110 of the controller 100 executes lottery processing (step S5123).

Subsequently, the CPU 110 of the controller 100 executes scroll display control processing (step S5125).

In the scroll display control processing, the CPU 110 of the controller 100 controls display start positions of continuous PIC-A and the like.

Subsequently, the CPU 110 of the controller 100 adds the slot game payout of each of pay lines to the Freespin BONUS payout (step S5127).

Since the WILD symbol can be displayed in the payload line, when the WILD symbol is displayed, the CPU 110 of the controller 100 determines a winning combination established by replacing the WILD symbol with another symbol.

However, since there is only one payout in one pay line, the CPU 110 of the controller 100 determines a maximum payout in each pay line.

Subsequently, the CPU 110 of the controller 100 determines whether the end condition is satisfied (step S5129). For example, when the Freespin BONUS is configured by eight video slot games, eight times of execution of a video slot game is the end condition for the Freespin BONUS.

When determining in the determination processing in step S5129 that the end condition is not satisfied (NO), the CPU 110 of the controller 100 transitions to the processing in step S5113 and executes the next video slot game.

When determining in the determination processing in step S5129 that the end condition is satisfied (YES), the CPU 110 of the controller 100 ends this subroutine.

In the Freespin BONUS, a number obtained by multiplying the Freespin BONUS payout added in step S5127 by a BET ratio of the base game is the number of bonus credits.

### <Array Table of WILD Symbols in the Freespin BONUS>

FIG. 52 is a WILD symbol array table illustrating an array of WILD symbols in the Freespin BONUS.

As explained above, in the Freespin BONUS, WILD symbols are superimposed and displayed. The WILD symbol includes not only one symbol but also a block-like symbol. For example, WILD symbols configured in 2 rows and 2 columns, 3 rows and 3 columns, 4 rows and 4 columns, and 5 rows and 5 columns are displayed and establishment of a winning combination is determined.

In the WILD symbol array table, the WILD symbols are arranged not only alone (1×1) and in columns (1×2, 1×3, etc.) but also in blocks (5×5, 4×4, 3×3, 2×2).

For example, WILD symbols are arranged in a 4×4 block shape in 3 columns to 6 columns of the Reels 1 to 4, WILD symbols are arranged in a 2×2 block shape in 8 columns to 9 columns of the Reels 2 to 3, WILD symbols are arranged in a 3×3 block shape in 11 columns to 13 columns of the Reels 3 to 5, and WILD symbols are arranged in a 5×5 block shape in 16 columns to 20 columns of the Reels 1 to 5.

When determining a stop position for the WILD symbol in step S5117, the CPU 110 of the controller 100 determines a stop position in the WILD symbol array table with one lottery.

Specifically, the CPU 110 of the controller 100 determines a stop position in the WILD symbol array table displayed in the upper part of the Reel 1. For example, when determining to stop a blank of a seventieth column in the upper part of the Reel 1, the WILD symbols are displayed in the middle part of the Reel 1, the upper part of the Reel 3, and the middle part and the lower part of the Reel 4 and the Reel 5.

### <Numeric Table of the WILD Symbol Array Table>

FIG. 53 is a numeric table of the WILD symbol array table.

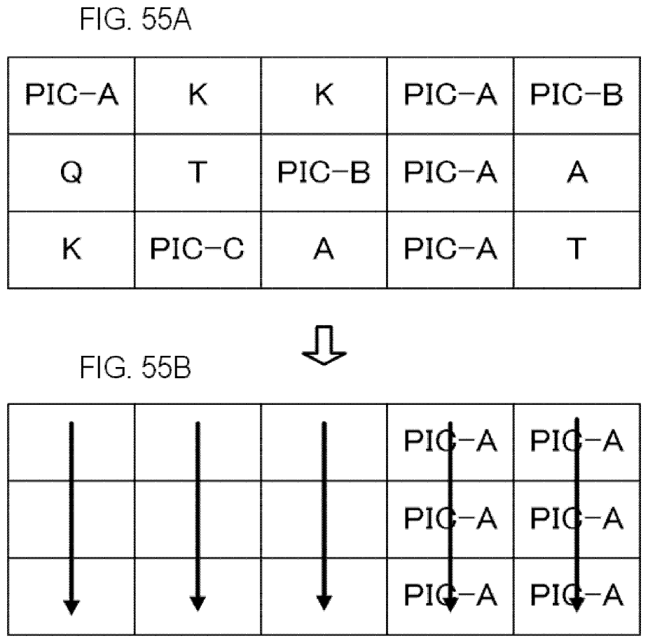

For example, when 0 is selected (a numeric is 3260), a blank of a zero-th column is displayed in the upper part of the Reel 1 in FIGS. 55A and 55B. At this time, four WILD symbols in total are displayed in the lower part of the Reel 1, the upper part of the Reel 2, the upper part of the Reel 4, and the middle part of the Reel 5.

For example, when 16 is selected (a numeric is 5), the WILD symbol in a sixteenth column is displayed the upper part of the Reel 1 in FIGS. 55A and 55B. At this time, WILD symbols are displayed in all of the upper part, the middle part, and the lower part of the Reels 1 to 5, and fifteen WILD symbols in total are displayed.

As explained above, the smaller the number of displayed WILD symbols is, the more likely the WILD symbols are selected, and the larger the number of displayed WILD symbols is, the less likely the WILD symbols are selected.

Note that, even when the number of displayed WILD symbols is the same, the easiness of selection may be different (that is, numerics are different) or the easiness of selection may be the same (that is, numerics are the same.).

### <Symbol Array Table in the Freespin BONUS>

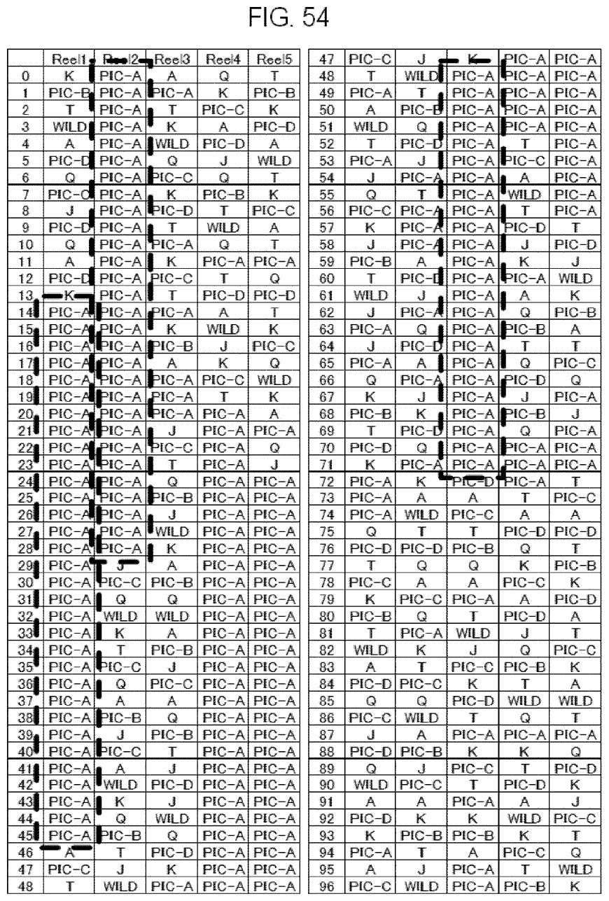

FIG. 54 is a part of a symbol array table illustrating an array of symbols in the Freespin BONUS.

In the Freespin BONUS, predetermined symbols (PIC-A, PIC-B, PIC-C, and PIC-D) are easily displayed and a payout tends to be high.

For example, PIC-As are arranged in a fourteenth column to a forty-fourth column in the Reel 1, in a zeroth column to a twenty-eighth column in the Reel 2, in a forty-eight column to a seventy-first column in the Reel 3, in a twentieth column to a fifty-first column in the Reel 4, and in a twenty-fourth to a fifty-sixth column in the Reel 5.

In another symbol array table, like the PIC-As, PIC-Bs (PIC-Cs and PIC-Ds) are arranged in a fourteenth column to a forty-fourth column in the Reel 1, in a zeroth column to a twenty-eighth column in the Reel 2, in a forty-eight column to a seventy-first column in the Reel 3, in a twentieth column to a fifty-first column in the Reel 4, and in a twenty-fourth to a fifty-sixth column in the Reel 5.

Since the payouts are PIC-A>PIC-B>PIC-C=PIC-D as illustrated in FIG. 3, the easiness of selection of the symbol array table in the Freespin BONUS may be as follows: a symbol array table in which the PIC-Cs are continuously arranged=a symbol array table in which PIC-Ds are continuously arranged>a symbol array table in which PIC-Bs are continuously arranged>a symbol array table in which PIC-As are continuously arranged.

### <Start Position of Scroll Display>

FIGS. 55A and 55B are image diagrams illustrating screen display at the time when the player is caused to expect to receive a high payout displayed on the lower display 210.

An upper diagram illustrates the time when scrolling stops (after rearrangement). Here, a winning combination is not established.

A lower diagram illustrates the time when the next unit game is started. When scrolling is started, the scrolling is started from a position where PIC-As are continuous in the Reel 4 and the Reel 5. In other words, in the Reel1 to the Reel3, scrolling in the next unit game is started continuously from a position where the scrolling is stopped in the last unit game. In the Reel 4 and the Reel 5, scrolling is started by switching a start position of the scrolling in the next unit game from a position where the scrolling is stopped in the last unit game.

In this way, by starting the scrolling from continuously arranged symbols, it is possible to attract the attention of the player and suggest that there is a high possibility of a high payout.

Note that, after the scrolling is started, by continuously displaying, in a semitransparent manner, the continuously arranged symbols displayed when the scrolling is started, it may be suggested that the consecutively arranged symbols stop. That is, semitransparent display of the continuously arranged symbols may be displayed to be superimposed on the scroll display.

### <Stop Indication for the WILD Symbols>

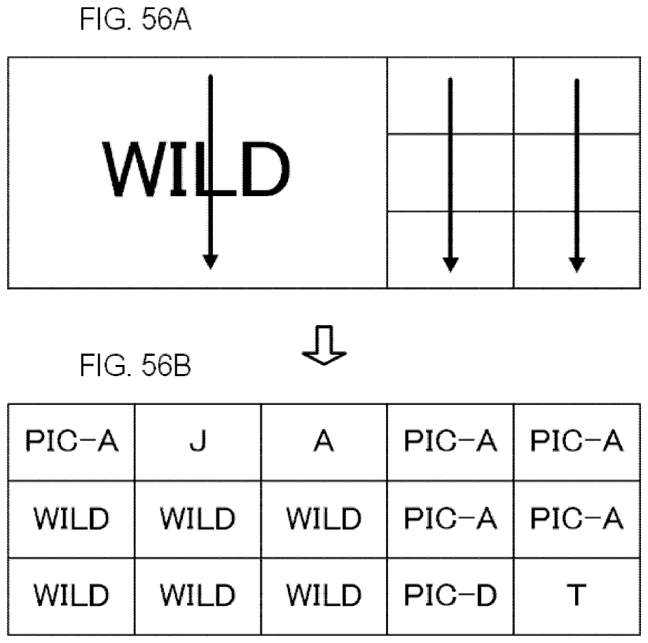

FIGS. 56A and 56B are image diagrams illustrating screen display at the time when the player is caused to expect that the WILD symbols are stopped in a block shape.

In FIG. 56A, one WILD symbol is displayed using the upper part, the middle part, and the lower part of the Reel 1 to the Reel 3 and scrolling is started.

In step S5117 in FIG. 51, the CPU 110 of the controller 100 determines a stop position of the WILD symbol and, when WILD symbols are displayed in a block shape as explained above, in step S5118 in FIG. 51, determines whether to display a WILD symbol larger than the size of one stop position (cell).

In FIG. 56B, the scrolling is stopped and WILD symbols are displayed in the middle part and the lower part of the Reel 1 to the Reel 3.

In this way, by displaying a large WILD symbol at the start time of the scrolling, it is possible to attract the attention of the player and suggest that there is a high possibility of a high payout.

### <<Help Display>>

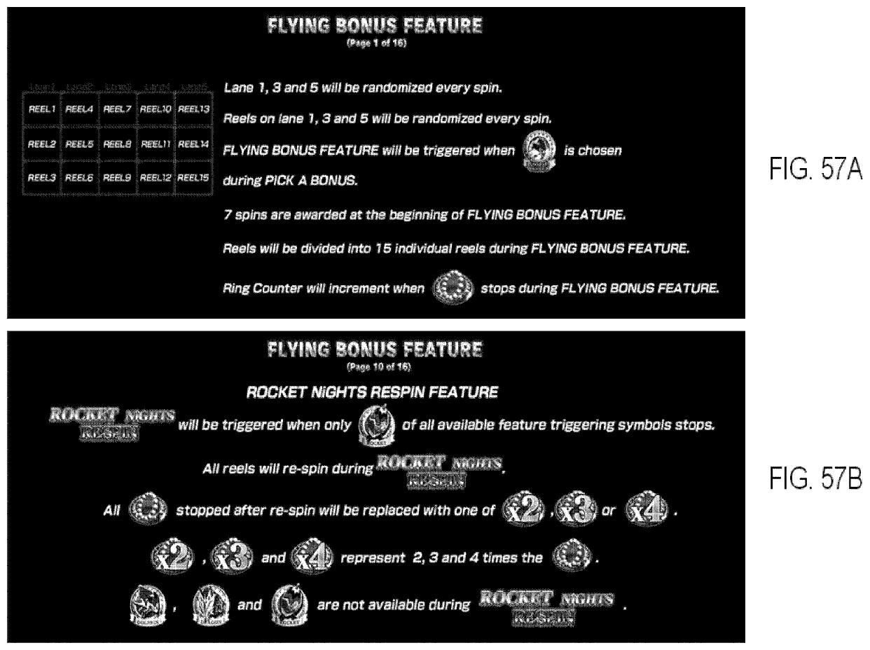

The BONUS game is greatly different from the base game in scrolling of a video reel and progress of the game. For this reason, separately from the normal help display (FIGS. 57A and 57B), help information is displayed even during the progress of the BONUS game. Since the help information is displayed during the progress of the BONUS game, necessary help information is divided and gradually displayed (FIGS. 47A to 47C). The help information is displayed not to overlap a scroll region of a symbol. That is, the help information is displayed not to hinder the progress of the game.

Character information displayed during progress of the SKILL BONUS is different from character information of the normal help display. The character information displayed during the progress of the SKILL BONUS may be the same as the character information of the normal help display.

FIGS. 57A and 57B are diagrams illustrating an example of help information displayed separately from the game. The help information is help information displayed when the player operates a HELP button (not illustrated) or the like. Only the help information is displayed on the entire surface of the lower display 210. The help information includes character information and image information such as a symbol. On the lower display 210, scrolling of the symbol and the like are not displayed and only the help information is displayed. While the help information is displayed, various games such as a video slot game and a roulette game do not proceed. When the player operates the HELP button (not illustrated) or the like again, the help information is erased from the lower display 210 and the screen returns to the game screen.

FIGS. 47A to 47C are diagrams illustrating examples of help information displayed as the SKILL BONUS slot game progresses. The help information relating to the SKILL BONUS slot game is displayed on the upper part of the lower display 210 other than the symbol display region 400. As the help information, irrespective of operation of the player, different kinds of help information are sequentially displayed as the game progresses like “SKILL GAME FEATURE will be triggered by 6 or more . . . ” (FIG. 47A), “PICK A BONUS will be triggered by 3 or more . . . during DREAM NIGHTS WHEEL FEATURE.” (FIG. 47B), and “MAXimum 12 pieces of . . . ” (FIG. 47C).

Although FIGS. 47A to 47C illustrate an example in which the help information is displayed in the upper part of the lower display 210, the help information may be displayed in the lower part of the lower display 210. The help information may be displayed on the upper display 220 instead of the lower display 210. The help information only has to be displayed in a position not interfering with the symbol display region 400 of the lower display 210.

The help information is not always displayed in the upper portion of the lower display 210. For a player skilled in the game, the help information may not be displayed by operating a predetermined button. The player may be allowed to select display or non-display of the help information.

### Scope of the Present Embodiment

As explained above, various features are described according to the present embodiment. However, the description and drawings forming a part of this disclosure should not be understood as limiting the present invention. In this way, it goes without saying that the various features include various embodiments and the like not described herein.

### REFERENCE SIGNS LIST

10 gaming machine
100 controller
210 lower display
320a, 320b, 320c, 320d, 320e BET button
330 SPIN button
400 symbol display region

1. A gaming machine comprising:
a display that displays a video reel having a plurality of symbols including a predetermined symbol and a plurality of cells, to each of which a prize is allocated; and
a controller that
executes a base game in which a bet is necessary and the plurality of symbols are rearranged after scrolling of the video reel,
when the predetermined symbol is rearranged in the base game, displays content of a prize of a cell in which the content of the prize is not displayed,
when contents of prizes of all of the plurality of cells are displayed, selects one cell from the plurality of cells by lottery, and,
when content of a prize allocated to the one cell is a transition to a bonus game more advantageous than the base game, transitions the base game to the bonus game.

2. The gaming machine according to claim 1, wherein the controller allocates, according to a symbol rearranged in the base game, content of a prize to each of the plurality of cells by lottery.

3. The gaming machine according to claim 1, further comprising
a memory in which contents of the plurality of prizes are readably stored in advance, wherein
the controller reads out the contents of the plurality of prizes from the memory, selects one prize from the plurality of prizes by lottery, and allocates the one prize to each of the plurality of cells.

4. The gaming machine according to claim 1, wherein,
when a cell in which content of a prize is not displayed is present among the plurality of cells, the controller allocates, according to operation by a player, contents different from the contents of the plurality of prizes to all un-displayed cells, and
selects one cell from the plurality of cells by lottery.

5. The gaming machine according to claim 1, wherein,
when a number of the rearranged predetermined symbols is larger than a number of un-displayed cells,
the controller
displays the contents of all the prizes of the plurality of cells, selects one cell from the plurality of cells by lottery, and,
according to a difference between the number of rearranged predetermined symbols and the number of un-displayed cells, displays contents of prizes of the un-displayed cells in the subsequent base game.

6. The gaming machine according to claim 1, further comprising:
a bet receiving device that receives a bet for starting the base game, one number of BETs among a plurality of numbers of BETs being selected in the bet receiving device; and
a memory that stores, for each of the plurality of bets, content of a prize allocated to each of the plurality of cells, wherein,
when an un-displayed cell present in the plurality of cells when the predetermined symbol is rearranged in the base game, the controller displays content of a prize corresponding to a number of BETs at a start of the base game in the un-displayed cell.

7. The gaming machine according to claim 6, wherein, when a first number of BETs is changed to a second number of BETs in the bet receiving device, the controller switches the content of the prize to a content of a prize corresponding to the second number of BETs and displays the content of the prize in the un-displayed cell.
